(19) United States
(12) Patent Application Publication
(10) Pub. No.: US 2023/0050690 A1
(43) Pub. Date: Feb. 16, 2023

(54) NANOPOROUS MEMBRANES AND METHODS OF MAKING AND USE THEREOF

(71) Applicant: VANDERBILT UNIVERSITY, Nashville, TN (US)

(72) Inventors: Piran R. Kidambi, Nashville, TN (US); Peifu Cheng, Nashville, TN (US)

(21) Appl. No.: 17/786,735

(22) PCT Filed: Dec. 18, 2020
(86) PCT No.: PCT/US2020/065829

§ 371 Date: Jun. 17, 2022

Related U.S. Application Data
(60) Provisional application No. 62/951,755, filed on Dec. 20, 2019.

(51) Int. Cl. B01D 67/00; C01B 32/194; C08G 77/04; C08K 3/04; B01D 61/02; B01D 69/02; B01D 71/56; B01D 71/02; C02F 1/44

(52) U.S. Cl. CPC B01D 67/0079; C01B 32/194; C08G 77/045; C08K 3/042; B01D 61/027; B01D 69/02; B01D 71/56; B01D 71/0211; C02F 1/442; C08K 2201/011; C01B 2204/04; C01P 2006/16; B01D 2325/04; B01D 2325/02831; B01D 2325/02832; C02F 2101/30

(57) ABSTRACT

Disclosed herein are nanoporous membranes for separating a target substance from a non-target substance in a fluid medium and methods of making and use thereof. The nanoporous membranes comprise a 2D material permeated by a first and second population of pores; wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; and wherein substantially all of the second population of pores are substantially blocked by a polymer via size-selective interfacial polymerization; such that the nanoporous membrane allows for transport of the target substance through the nanoporous membrane via the first population of pores.

### CROSS-REFERENCE TO RELATED APPLICATIONS

This application claims the benefit of priority to U.S. Provisional Application No. 62/951,755 filed Dec. 20, 2019, which is hereby incorporated herein by reference in its entirety.

### BACKGROUND

In the past few decades, water scarcity has emerged as a severe global problem impacting the lives of ˜1.2 billion people (˜⅕th of the world's population). Even though water covers ˜71% of the earth's surface, the majority of the earth's water (˜96%) is in the form of salt water held in oceans and fresh water found in glaciers, groundwater; lakes and rivers account for only ˜2.5%. These fresh water resources are un-evenly distributed across the world, resulting in arid regions experiencing a chronic shortfall of fresh water. Additionally, the ground water in many regions of the world is brackish or contaminated, rendering it somewhat less useable. In this context, desalination and water purification has generated tremendous interest to help alleviate water scarcity by increasing the amount of water available without affecting the natural ecosystem and hydrological cycle. An ideal desalination membrane should exhibit minimum thickness to maximize water permeance and narrow pore size distribution for efficient ionic/molecular separations. Two-dimensional materials, such as graphene, with uniform distribution of high-density of sub-nanometer pores are attractive materials offering ultrafast water permeance and high solute rejection. However, scalable production of such materials with control over sub-nanometer pores remains challenging. The compositions, devices, and methods described herein address these and other needs.

### SUMMARY

In accordance with the purposes of the disclosed compositions, devices, and methods, as embodied and broadly described herein, the disclosed subject matter relates to nanoporous membranes and methods of making and use thereof. The nanoporous membranes described herein can, for example, show 1-2 orders of magnitude higher water flux compared to state-of-the-art commercial membranes.

For example, disclosed herein are a nanoporous membrane for separating a target substance from a non-target substance in a fluid medium, the nanoporous membrane comprising: a two-dimensional (2D) material permeated by a plurality of pores; wherein the plurality of pores comprises a first population of pores having an average pore diameter and a second population of pores having an average pore diameter; wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; and wherein substantially all of the second population of pores are substantially blocked by a polymer derived from a first monomer and a second monomer via size-selective interfacial polymerization; wherein the first monomer has an average size that is greater than the average pore diameter of the second population of pores; and wherein the second monomer has an average size that is greater than the average pore diameter of the first population of pores and less than or equal to the average pore diameter of the second population of pores; such that the first monomer and the second monomer are size-excluded from the first population of pores during the size-selective interfacial polymerization; such that the nanoporous membrane allows for transport of the target substance through the nanoporous membrane via the first population of pores

Also disclosed herein are methods of making a nanoporous membrane for separating a target substance from a non-target substance in a fluid medium, the method comprising: etching a two-dimensional material such that the two-dimensional material is permeated by a plurality of pores, wherein the plurality of pores comprises a first population of pores having an average pore diameter and a second population of pores having an average pore diameter, wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; wherein the two-dimensional material has a top surface and a bottom surface with an average thickness therebetween; wherein the plurality of pores traverse the average thickness of the two-dimensional material from the top surface to the bottom surface; and contacting the top surface of the two-dimensional with a first monomer and the bottom surface of the two-dimensional material with a second monomer; wherein the first monomer has an average size that is greater than the average pore diameter of the second population of pores; wherein the second monomer has an average size that is greater than the average pore diameter of the first population of pores and less than or equal to the average pore diameter of the second population of pores; such that interfacial polymerization occurs between the first monomer and the second monomer within the second population of pores; thereby substantially blocking substantially all of the second population of pores with a polymer derived from the first monomer and the second monomer via interfacial polymerization; such that the nanoporous membrane allows for transport of the target substance through the nanoporous membrane via the first population of pores.

Additional advantages of the disclosed devices and methods will be set forth in part in the description which follows, and in part will be obvious from the description. The advantages of the disclosed devices will be realized and attained by means of the elements and combinations particularly pointed out in the appended claims. It is to be understood that both the foregoing general description and the following detailed description are exemplary and explanatory only and are not restrictive of the disclosed devices and methods, as claimed.

The details of one or more embodiments of the invention are set forth in the accompanying drawings and the description below. Other features, objects, and advantages of the invention will be apparent from the description and drawings, and from the claims.

### DESCRIPTION OF FIGURES

The accompanying figures, which are incorporated in and constitute a part of this specification, illustrate several aspects of the disclosure, and together with the description, serve to explain the principles of the disclosure.

FIG. 1. Schematic of the fabrication process of graphene nanoporous atomically thin membranes. Nanoporous graphene (NG) synthesized via CVD at 900° C. on Cu foil is pressed against polycarbonate track etched (PCTE) support followed by etching of Cu. The polycarbonate track etched support provides adequate mechanical support and the well-defined, isolated cylindrical (˜200 nm diameter) pore geometry allows for precise transport measurements without cross-talk from overlapping pores (O'Hern S C et al. ACS Nano 2012, 6(11), 10130-10138; O'Hern S C et al. Nano Lett. 2014, 14(3), 1234-1241; O'Hern S C et al. Nano Lett. 2015, 15(5), 3254-3260; Kidambi P R et al. Adv. Mater. 2017, 29(19), 1605896). Subsequently, UV/ozone etching is used to introduce new defects but also enlarges existing intrinsic defects in the graphene lattice. Finally, facile and scalable interfacial polymerization with polyhedral oligomeric silsesquioxane (POSS) (cage size ˜0.5 nm) in the aqueous phase and trimesoyl chloride (TMC) in hexane (organic phase) is used to seal tears and large nanopores in the graphene membrane via the formation of polyhedral oligomeric silsesquioxane-polyamide (POSS-PA) plugs/seals.

FIG. 2. Optical image of polycarbonate track etched (PCTE) supports, nanoporous graphene on polycarbonate track etched membrane (P+NG), nanoporous graphene on polycarbonate track etched membrane after UV-ozone treatment (P+NG+U), and nanoporous graphene on polycarbonate track etched membrane after UV-ozone treatment and interfacial polymerization (P+NG+U+IP). The black square in the image is graphene. The color of membrane changes into light yellow after UV-ozone treatment. The red dashed circle presents the interfacial polymerization area on membrane.

FIG. 3. SEM image of graphene transferred on polycarbonate track etched support. The dark circles indicate polycarbonate track etched pores covered with suspended graphene.

FIG. 4. SEM image of graphene transferred on polycarbonate track etched support. The dark circles indicate polycarbonate track etched pores covered with suspended graphene. Tears inevitably introduced during the mechanical pressing stage are indicated. Wrinkles in graphene are also indicated.

FIG. 5. Schematic of the mechanism for sealing tears and large nanopores (>0.5 nm) without blocking small nanopores (<0.5 nm) by interfacial polymerization. polyhedral oligomeric silsesquioxane and trimesoyl chloride are only expected to react and polymerize at large tears and/or large defects, forming polyhedral oligomeric silsesquioxane-polyamide plugs/seals (Dalwani M et al. J. Mater. Chem. 2012, 22(30), 14835-14838; Duan J et al. J. Membr. Sci. 2015, 473, 157-164). Because the dimension of polyhedral oligomeric silsesquioxane is ˜0.5-1.8 nm (˜0.5 nm cage size), the interfacial polymerization process does not block small nanopores <0.5 nm.

FIG. 6. Schematic of the setup used for sealing tears in the graphene membrane using interfacial polymerization (IP).

FIG. 7. Assessment of sub-nanometer pores in the graphene lattice after UV/ozone etching and interfacial polymerization. Raman spectra for 900° C. CVD graphene (NG) transferred to 300 nm SiO₂/Si wafer exposed to UV/ozone etching for different times (e.g., from 5 minutes, U5, to 30 minutes, U30). Also see Supporting Information note 1.

FIG. 8. Intensity ratio of D/G peak changes with increasing UV-ozone time.

FIG. 9. The average inter-defect distance (L_{D}, red markers) computed from the ratio of intensity of D and G peaks (I_{D}/I_{G}). Curve is computed using I_{D}/I_{G}, r_{A}=3.3 nm (the radius of area surrounding the defect) and r_{S}=1 nm (the radius of structural disorder) as described in Supporting Information note 1 (Cancado L G et al. Nano Lett. 2011, 11(8), 3190-3196; Lucchese M M et al. Carbon 2010, 48(5), 1592-1597). As-synthesized nanoporous graphene treated with UV/ozone for 0 to 10 min is in the low-defect-density regime, while longer UV/ozone exposure (more than 15 min) leads to a transition into the high-defect-density regime.

FIG. 10. FWHM of 2D peak increases with increasing UV/ozone time (Cancado L G et al. Nano Lett. 2011, 11(8), 3190-3196; Lucchese M M et al. Carbon 2010, 48(5), 1592-1597).

FIG. 11. MAADF-STEM images of low-temperature CVD graphene followed by UV-ozone treatment, confirming that sub-nanometer and nanometer pores in the range of 0.4-5 nm are generated in graphene.

FIG. 12. Diffusive flux normalized with respect to bare polycarbonate track etched support membrane for different nanoporous atomically thin membranes measured using four model solutes (KCl, ˜0.66 nm (left-most); NaCl, ˜0.66-0.716 nm (second from left); L-tryptophan, ˜0.7-0.9 nm (second from right); Vitamin B12, ˜1-1.5 nm (right-most)). Black lines and open squares are the results of a solute diffusion model, which fit the experimental measurements well.

FIG. 13. STEM images of as-synthesized nanoporous graphene after UV/ozone etching for 25 min indicates high-density sub-nanometer pores (arrows indicate representative nanopores in different size ranges).

FIG. 14. Measured pore size distribution corresponding to STEM images in FIG. 13. There is no well-accepted/unique convention for defining the diameter of graphene nanopore <1 nm, hence both the carbon electron radius (˜0.065 nm) and carbon van der Waals (VDW) radius (˜0.17 nm) were considered (O'Hern S C et al. Nano Lett. 2015, 15(5), 3254-3260) and another pore size distribution was computed (see FIG. 30) which also indicated a majority of <0.5 nm nanopores (Wang L et al. Nat. Nanotechnol. 2017, 12(6), 509-522; O'Hern S C et al. Nano Lett. 2015, 15(5), 3254-3260; Jang D et al. ACS Nano 2017, 11(10), 10042-10052).

FIG. 15. Atomic resolution STM images acquired on nanoporous graphene on Cu foil after UV/ozone etching for 25 min. Sub-nanometer defects and nanometer scale pores are indicated.

FIG. 16. Evaluating the performance of graphene nanoporous atomically thin membranes. Water flux across graphene nanoporous atomically thin membranes on polycarbonate track etched supports increases linearly with osmotic pressure. Further, the synthesized graphene nanoporous atomically thin membranes show an increase in water flux with increasing UV/ozone time from 0 to 20 min (NG+IP for 0 min UV/ozone time; NG+U5+IP to NG+U20+IP for 5 min to 20 UV/ozone time respectively). Dotted lines correspond to the water transport model. The water flux at the osmotic pressures of 4.2, 13.8, and 25.9 bar was measured during water transport experiments, while the water flux at the osmotic pressure of 20.3 bar was measured during solute transport experiments. Nanoporous graphene subjected to 20 min of UV/ozone etching (NG+U20+IP) exhibits the highest water flux, while NG+U25+IP membrane shows the second highest water flux.

FIG. 17. Experimentally measured solute rejection through nanoporous atomically thin membranes. Each set of bars represents four solutes: KCl, NaCl, L-Tr, and B12, left to right, respectively. Nanoporous graphene subjected to 20 min of UV/ozone etching (NG+U20+IP) exhibits the lowest solute rejection result. In contrast, NG+U25+IP membrane shows the highest solute rejection result. Black lines and open squares show the transport model for solute rejection.

FIG. 18. Water permeance and solute rejection through nanoporous atomically thin membranes. Each symbol represents a membrane following the same symbol scheme in FIG. 16. Note water permeance takes into account the 9.4% porosity of polycarbonate track etched supports (also see FIG. 35-FIG. 36). NG+U25+IP membrane has the second-highest water permeance (slightly lower than NG+U20+IP) but offers the highest solute rejection. L-Tr and B12 rejections of ˜100% for nanoporous atomically thin membranes with 0 and 25 min UV/ozone exposure results in some L-Tr overlapping with B12.

FIG. 19. Solute rejections of NG+U20+IP (right triangle) and NG+U25+IP (star) membranes with respect to solute diameters (hydrated ion diameters of KCl and NaCl, molecular diameter of L-Tr and B12). Dashed and solid curves represent transport model for solute rejection.

FIG. 20. Comparison of water-permeance and salt-rejection measured via forward osmosis for nanoporous atomically thin membranes in this work (NG+U25+IP membrane) with other large-area membranes synthesized from 2D materials in literature, for example, graphene oxide (GO) (Chen L et al. Nature 2017, 550(7676), 380-383), graphene oxide/graphene (GO/G) (Abraham J et al. Nat. Nanotechnol. 2017, 12(6), 546-550), commercially available cellulose triacetate (CTA) (Yang Y et al. Science 2019, 364(6445), 1057-1062), state-of-the-art advances in thin film composite (TFC) membranes (Ren J et al. Desalination 2014, 343, 187-193), reduced graphene oxide (rGO) (Liu H et al. Adv. Mater. 2015, 27(2), 249-254), Acetamide-functionalized MoS₂ (A-MoS₂) (Ries L et al. Nat. Mater. 2019, 18(10), 1112-1117), ethyl-2-ol-functionalized MoS₂ (E-MoS₂) (Ries L et al. Nat. Mater. 2019, 18(10), 1112-1117), dye-decorated MoS₂ (D-MoS₂) (Hirunpinyopas W et al. ACS Nano 2017, 11(11), 11082-11090), and graphene-nanomesh/single-walled carbon nanotube (GNM/SWNT) (Yang Y et al. Science 2019, 364(6445), 1057-1062) membranes. The very high rates of water vapor transport (˜250 L m⁻² h⁻¹ bar⁻¹) over ˜5 μm diameter graphene membranes were excluded, because they represent pervaporative water transport (Surwade S P et al. Nat. Nanotechnol. 2015, 10(5), 459-464). Open symbols represent KCl rejection while filled symbols represent NaCl rejection.

FIG. 21. Sketch of water permeance and solute rejection through an ideal membrane driven by osmotic pressure in the forward osmosis system.

FIG. 22: KCl concentration change (represented by black circles) on permeate side of a nanoporous graphene membrane on a polycarbonate track etched support treated with UV-ozone for 30 minutes followed by interfacial polymerization (P+NG+U30+IP) during the solute rejection measurement. KCl concentration slopes at the beginning and end (after 24 h) are represented by red and blue lines, respectively.

FIG. 23: KCl concentration slopes at the beginning (red line) and after 24 h (blue line) on the permeate side of a nanoporous graphene membrane on a polycarbonate track etched support treated with UV-ozone for 25 minutes followed by interfacial polymerization (P+NG+U25+IP) during the solute rejection measurement.

FIG. 24. STEM image of high-quality graphene after UV/ozone treatment for 25 min indicates sub-nanometer pores, albeit with a density (see FIG. 37-FIG. 38) lower than nanoporous graphene (see FIG. 13, FIG. 14).

FIG. 25. Raman spectra of high quality graphene (note absence of D peak) transferred to 300 nm SiO₂/Si wafer after different times of UV/ozone etching (0 minutes, top trace; 15 minutes, middle trace; 25 minutes, bottom trace).

FIG. 26. Diffusive flux normalized with respect to bare polycarbonate track etched supports for nanoporous atomically thin membranes with high quality graphene (G+U15+IP and G+U25+IP) and nanoporous graphene (NG+U10+IP, NG+U20+IP, and NG+U25+IP) with model solutes (KCl, NaCl, L-Tr, and B12, left to right in each set of columns).

FIG. 27. Water flux for high quality graphene nanoporous atomically thin membranes (G+U15+IP and G+U25+IP) compared with nanoporous graphene nanoporous atomically thin membranes (NG+U10+IP, NG+U20+IP, and NG+U25+IP). These comparisons indicate that although nanoporous atomically thin membranes fabricated using high quality graphene (G) could indeed be useful for ionic and molecular separations, the lower defect density results in lower performance compared to nanoporous atomically thin membranes fabricated with nanoporous graphene (NG).

FIG. 28. Solute rejection for high quality graphene nanoporous atomically thin membranes (G+U15+IP and G+U25+IP) compared with nanoporous graphene nanoporous atomically thin membranes (NG+U10+IP, NG+U20+IP, and NG+U25+IP) for model solutes (KCl, NaCl, L-Tr, and B12, left to right in each set of columns). These comparisons indicate that although nanoporous atomically thin membranes fabricated using high quality graphene (G) could indeed be useful for ionic and molecular separations, the lower defect density results in lower performance compared to nanoporous atomically thin membranes fabricated with nanoporous graphene (NG).

FIG. 29. Experimental setup used to measure solute diffusion, water, and solute transport.

FIG. 30. Calculated pore size distributions of 900° C. CVD graphene after UV/ozone treatment for 25 min adjusted to the carbon electron radius and carbon van der Waals radius (O'Hern S C et al. Nano Lett. 2015, 15 (5), 3254-3260; Wang L et al. Nat. Nanotechnol. 2017, 12 (6), 509-522; Jang D et al. ACS Nano 2017, 11 (10), 10042-10052). The calculated pore diameter was obtained by adding carbon electron diameter (˜0.13 nm) to the measured pore diameter, and then subtracting carbon van der Waals diameter (˜0.34 nm). The comparison between measured (FIG. 14) and calculated pore size distributions (FIG. 30) is consistent with the prior reports (O'Hern S C et al. Nano Lett. 2015, 15 (5), 3254-3260; Wang L et al. Nat. Nanotechnol. 2017, 12 (6), 509-522; Jang D et al. ACS Nano 2017, 11 (10), 10042-10052). The fraction of pore area over the total area was ˜8.4%.

FIG. 31. Solute diffusion comparison between two NG+U5+IP membranes for model solutes (KCl, NaCl, L-Tr, and B12, left to right in each set of columns). The results show that the pore size distributions of different batches of nanoporous atomically thin membranes fabricated by the same protocol are consistent, indicating the whole process including graphene transfer, UV-ozone treatment and interfacial polymerization is reliable and reproducible.

FIG. 32. Solute diffusion comparison between two NG+U15+IP membranes for model solutes (KCl, NaCl, L-Tr, and B12, left to right in each set of columns). The results show that the pore size distributions of different batches of nanoporous atomically thin membranes fabricated by the same protocol are consistent, indicating the whole process including graphene transfer, UV-ozone treatment and interfacial polymerization is reliable and reproducible.

FIG. 33. Water flux through graphene membrane when draw solution is placed on the graphene side versus the polycarbonate track etched membrane side. The minimal difference in the measured water fluxes not only confirms the negligible transport of draw solution, but also indicates minimal effects from concentration polarization of the draw solution irrespective of which side it is placed on.

FIG. 34. Water level change on the feed side for PCTE+IP membrane during water flux measurement under 4.2 bar osmotic pressure. The water permeance of PCTE+IP membrane is ˜1.1 Lm⁻²h⁻¹bar⁻¹.

FIG. 35. Comparing of performance of nanoporous atomically thin membranes (NG+IP: up triangle; NG+U5+IP: down triangle; NG+U10+IP: diamond; NG+U15+IP: left triangle; NG+U20+IP: right triangle; NG+U25+IP: star; NG+U30+IP: hexagon) and commercial cellulose triacetate (CTA) membrane (square) during forward osmosis. All the water permeance data are directly measured values and have not been adjusted for support porosity ˜9.4% (also see FIG. 18).

FIG. 36. Solute rejection performance of nanoporous atomically thin membranes (NG+IP: up triangle; NG+U5+IP: down triangle; NG+U10+IP: diamond; NG+U15+IP: left triangle; NG+U20+IP: right triangle; NG+U25+IP: star; NG+U30+IP: hexagon). NG+U25+IP membrane also offers the highest solute rejection (also see FIG. 18).

FIG. 37. Measured pore size distribution of high quality CVD graphene (FIG. 24) after UV/ozone treatment for 25 min.

FIG. 38. Calculated pore size distributions of high quality CVD graphene after UV/ozone treatment for 25 min adjusted to the carbon electron radius and carbon van der Waals radius (O'Hern S C et al. Nano Lett. 2015, 15 (5), 3254-3260; Wang L et al. Nat. Nanotechnol. 2017, 12 (6), 509-522; Jang D et al. ACS Nano 2017, 11 (10), 10042-10052). The calculated pore diameter was obtained by adding carbon electron diameter (0.13 nm) to the measured pore diameter (FIG. 37), and then subtracting carbon van der Waals diameter (0.34 nm). The comparison between measured (FIG. 37) and calculated pore size distributions (FIG. 38) is consistent with the previously reported comparison (O'Hern S C et al. Nano Lett. 2015, 15 (5), 3254-3260; Wang L et al. Nat. Nanotechnol. 2017, 12 (6), 509-522; Jang D et al. ACS Nano 2017, 11 (10), 10042-10052). The overall nanopore density is ˜2.7×10¹² cm², while the effective pore densities after excluding nanopores >0.5 nm and >1.8 nm are ˜1.5×10¹² cm⁻² and ˜2.5×10¹² cm², respectively.

FIG. 39. Sketch of membrane cross section showing path through graphene then polycarbonate track etched membrane pore or through polyhedral oligomeric silsesquioxane-polyamide plug.

FIG. 40. Equivalent resistance network including leakage through polyhedral oligomeric silsesquioxane-polyamide plug or unsealed defects and transport through graphene pores.

FIG. 41. Sketch of a generic log-normal pore size distribution defined by Equations S-1 to S-3.

FIG. 42. Illustration of effective pore size reduction due to finite solute molecule size.

FIG. 43. Sketch of concentration profile across the membrane (bottom) shown with respect to the membrane cross section (top). Not to scale FIG. 44. Illustration of separation across selective pores in an atomically thin membrane.

FIG. 45. Complementary in-situ probing during graphene chemical vapor deposition (CVD) on Cu.

FIG. 46. Acid etch test to characterize and enhance the barrier properties of single layer graphene for membrane and barrier applications.

FIG. 47. Schematic overview of the different processes for nanoporous atomically thin membrane (NATM) fabrication using monolayer graphene grown via CVD on Cu foil.

FIG. 48. Scanning transmission electron microscopy (STEM) image showing sub-nanometer pores/defects introduced by oxygen plasma etch of the hexagonal graphene lattice.

FIG. 49. Schematic diagram of the experimental set-up to test diffusion of molecules across the fabricated nanoporous atomically thin membranes.

FIG. 50. Size-selective dialysis based separation of KCl (˜0.66 nm), L-Tryptophan (˜0.7-0.9 nm), Vitamin B12 (˜1-1.5 nm) and Lysozyme (˜3.8-4 nm) using nanoporous atomically thin membranes. Inset shows centimeter scale graphene nanoporous atomically thin membrane (dark square) on polycarbonate track etched support.

FIG. 51. Selective nanoscale mass transport across atomically thin single crystalline graphene (SCG) membranes.

FIG. 52. Facile bottom-up formation of nanopores in monolayer graphene via reduction in CVD process temperature. With decreasing temperature Raman spectra shows increase in defect density.

FIG. 53. Facile bottom-up formation of nanopores in monolayer graphene via reduction in CVD process temperature. With decreasing temperature, selective transport of KCl (˜0.66 nm)>L-Tryptophan (0.7-0.9 nm)>Allura Red Dye (˜1 nm)>Vitamin B12 (˜1-1.5 nm) is observed.

FIG. 54. TEM images of suspended monolayer graphene confirms the formation of nanopores via lowering CVD process temperature to ˜900° C.

FIG. 55. STM image of monolayer graphene on Cu confirms the formation of nanopores via lowering CVD process temperature to ˜900° C.

FIG. 56. STM image of monolayer graphene on Cu confirms the formation of nanopores via lowering CVD process temperature to ˜900° C.

FIG. 57. STM image of monolayer graphene on Cu confirms the formation of nanopores via lowering CVD process temperature to ˜900° C.

FIG. 58. Scalable route for nanoporous atomically thin membrane synthesis by roll-to-roll chemical vapor deposition of graphene using a custom built split zone CVD reactor.

FIG. 59. Scalable route for nanoporous atomically thin membrane synthesis by roll-to-roll chemical vapor deposition of graphene using a custom built split zone CVD reactor and hierarchical poly-ether sulfone support casting.

FIG. 60. AFM images of nanopores (red patches) formed in micron size suspended graphene membranes upon very long exposure to UV light in the presence of ozone. This was a control measurement to confirm UV ozone etches graphene.

FIG. 61. Raman spectra for graphene exposed to UV light in the presence of ozone shows an increase in D peak ˜1350 cm⁻¹ intensity with increasing time indicating the formation of defects in the graphene lattice.

FIG. 62. Photograph of the UV-ozone etching system.

FIG. 63. Size selective sealing of large nanopores formed in graphene by UV induced oxidative etching or oxygen plasma etching. Octa-ammonium polyhedral oligomeric silsesquioxane (POSS, image from Hybrid Plastics) in the aqueous phase and trimesoyl chloride (TMC, image from Sigma Aldrich) in the organic phase are used to seal only nanopores larger than polyhedral oligomeric silsesquioxane and damage/tears in graphene, since smaller nanopores do not allow for transport of polyhedral oligomeric silsesquioxane across graphene.

FIG. 64. Diffusion cell used for diffusion and forward osmosis experiments. The metered column is used to measure the volume flowed, whereas a conductivity/UV-Vis probe measures the solute concentration on the permeate side.

FIG. 65. Single pore water vapor permeability shows that carbon nanotubes (CNTs) ˜3.3 nm in diameter allow for much higher water vapor transport compared to ˜3 nm pores in Anodic Aluminum Oxide (AAO) as well as other conventional polymers.

FIG. 66. Moisture vapor transport rates (MVTR) for CNT membranes (red bars) with ˜5% porosity is significantly higher that state-of-the-art over-garment fabric developed by the Army Research Office (ePTFE-Natick) and commercial fabrics such as Gore-Tex Pro Shell.

FIG. 67. Water vapor transport rates of commercial fabrics and graphene membranes with ˜7.6 nm pores.

FIG. 68. Preliminary results indicate the feasibility of size-selective sealing of large nanopores that results in solute rejection >96% for KCl ˜0.66 nm, >99% for L-Tr ˜0.7-0.9 nm, >99% for Vitamin B-12˜1-1.5 nm, while still maintaining high water flux.

FIG. 69. Facile lamination of graphene on Cu foil to commercially available air purification filters (HEPA filter) allows for in-expensive high porosity supports for scalable manufacturing of nanoporous atomically thin membranes. Raman spectra confirms graphene transfer.

FIG. 70. ˜5 nm diameter SiO₂ nanoparticles mixed with 8% poly-methyl methacrylate (PMMA) solution in anisole solvent and spin coat it on Cu foil used for graphene growth.

FIG. 71. Casting of hierarchically porous PES supports on the optimized nanoporous graphene for scalable nanoporous atomically thin membrane synthesis.

FIG. 72. Photograph of a centimeter scale single layer graphene membrane.

FIG. 73. Photograph of a DS cell with luggin capillaries for testing proton transport properties.

FIG. 74. The nanoporous membrane shows enhanced H⁺ electrically driven transport, while significantly blocking K⁺ transport in the liquid phase.

### DETAILED DESCRIPTION

The compositions, devices, and methods described herein may be understood more readily by reference to the following detailed description of specific aspects of the disclosed subject matter and the Examples included therein.

Before the present compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Disclosed herein are nanoporous membranes for separating a target substance from a non-target substance in a fluid medium. As used herein, a “fluid” includes a liquid, a gas, a supercritical fluid, or a combination thereof. The nanoporous membranes disclosed herein comprise a two-dimensional (2D) material permeated by a plurality of pores, for example, such that each of the plurality of pores traverses the average thickness of the two-dimensional material.

The two-dimensional material can, for example, comprise graphene, hexagonal boron nitride (h-BN), a transition metal dichalcogenide, a covalent organic framework, a metal organic framework, or a combination thereof. In some examples, the two-dimensional material can comprise graphene, hexagonal boron nitride (h-BN), or a combination thereof. In some examples, the two-dimensional material comprises graphene. In some examples, the two-dimensional material comprises monolayer graphene.

The two-dimensional material can, for example, have an average thickness of 1 nanometer (nm) or less (e.g. 0.95 nm or less, 0.9 nm or less, 0.85 nm or less, 0.8 nm or less, 0.75 nm or less, 0.7 nm or less, 0.65 nm or less, 0.6 nm or less, 0.55 nm or less, 0.5 nm or less, 0.45 nm or less, 0.4 nm or less, or 0.35 nm or less). In some examples, the two-dimensional material can have an average thickness of 0.3 nm or more (e.g., 0.35 nm or more, 0.4 nm or more, 0.45 nm or more, 0.5 nm or more, 0.55 nm or more, 0.6 nm or more, 0.65 nm or more, 0.7 nm or more, 0.75 nm or more, 0.8 nm or more, 0.85 nm or more, or 0.9 nm or more). The average thickness of the two-dimensional material can range from any of the minimum values described above to any of the maximum values described above. For example, the two-dimensional material can have an average thickness of from 0.3 nm to 1 nm (e.g., from 0.3 nm to 0.75 nm, from 0.75 nm to 1 nm, from 0.3 nm to 0.5 nm, from 0.5 nm to 0.7 nm, from 0.7 nm to 1 nm, from 0.3 nm to 0.8 nm, from 0.4 nm to 1 nm, from 0.4 nm to 0.8 nm, from 0.3 nm to 0.6 nm, or from 0.3 nm to 0.4 nm).

The two-dimensional material can have any suitable lateral dimension, for example the desired lateral dimension can be selected in view of the desired use of the nanoporous membrane. In some examples, the two-dimensional material can have a lateral dimension of 0.1 centimeter (cm) or more (e.g., 0.2 cm or more, 0.3 cm or more, 0.4 cm or more, 0.5 cm or more, 0.6 cm or more, 0.7 cm or more, 0.8 cm or more, 0.9 cm or more, 1 cm or more, 1.25 cm or more, 1.5 cm or more, 1.75 cm or more, 2 cm or more, 2.5 cm or more, 3 cm or more, 3.5 cm or more, 4 cm or more, 4.5 cm or more, 5 cm or more, 6 cm or more, 7 cm or more, 8 cm or more, 9 cm or more, 10 cm or more, 15 cm or more, 20 cm or more, 25 cm or more, 30 cm or more, 35 cm or more, 40 cm or more, 45 cm or more, 50 cm or more, 60 cm or more, 70 cm or more, 80 cm or more, 90 cm or more, 1 meter (m) or more, 1.1 m or more, 1.2 m or more, 1.3 m or more, 1.4 m or more, 1.5 m or more, 1.6 m or more, 1.7 m or more, 1.8 m or more, 1.9 m or more, 2 m or more, 2.25 m or more, 2.5 m or more, 2.75 m or more, 3 m or more, 3.25 m or more, 3.5 m or more, 4 m or more, 4.5 m or more, 5 m or more, 6 m or more, 7 m or more, 8 m or more, or 9 m or more). In some examples, the two-dimensional material can have a lateral dimension of 10 meters (m) or less (e.g., 9 m or less, 8 m or less, 7 m or less, 6 m or less, 5 m or less, 4.5 m or less, 4 m or less, 3.5 m or less, 3 m or less, 3.25 m or less, 3 m or less, 2.75 m or less, 2.5 m or less, 2.25 m or less, 2 m or less, 1.9 m or less, 1.8 m or less, 1.7 m or less, 1.6 m or less, 1.5 m or less, 1.4 m or less, 1.3 m or less, 1.2 m or less, 1.1 m or less, 1 m or less, 90 cm or less, 80 cm or less, 70 cm or less, 60 cm or less, 50 cm or less, 45 cm or less, 40 cm or less, 35 cm or less, 30 cm or less, 25 cm or less, 20 cm or less, 15 cm or less, 10 cm or less, 9 cm or less, 8 cm or less, 7 cm or less, 6 cm or less, 5 cm or less, 4.5 cm or less, 4 cm or less, 3.5 cm or less, 3 cm or less, 2.5 cm or less, 2 cm or less, 1.75 cm or less, 1.5 cm or less, 1.25 cm or less, 1 cm or less, 0.9 cm or less, 0.8 cm or less, 0.7 cm or less, 0.6 cm or less, 0.5 cm or less, 0.4 cm or less, 0.3 cm or less, or 0.2 cm or less). The lateral dimension of the two-dimensional material can range from any of the minimum values described above to any of the maximum values described above. For example, the two-dimensional material can have a lateral dimension of from 0.1 cm to 10 m (e.g., from 0.1 cm to 1 cm, from 1 cm to 10 cm, from 10 cm to 1 m, from 1 m to 10 m, from 0.1 cm 1 m, from 1 m to 10 m, from 1 cm to 10 m, from 0.1 cm to 5 m, from 1 cm to 5 m, from 0.1 cm to 50 cm, or from 0.1 cm to 10 cm).

The nanoporous membranes disclosed herein comprise a two-dimensional (2D) material permeated by a plurality of pores, wherein the plurality of pores comprise a first population of pores having an average pore diameter and a second population of pores having an average pore diameter; wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; and wherein substantially all of the second population of pores are substantially blocked by a polymer derived from a first monomer and a second monomer via interfacial polymerization; wherein the first monomer has an average size that is greater than the average pore diameter of the second population of pores; wherein the second monomer has an average size that is greater than the average pore diameter of the first population of pores and less than or equal to the average pore diameter of the second population of pores; such that the nanoporous membrane allows for transport of the target substance through the nanoporous membrane via the first population of pores. In some examples, the two-dimensional material further comprises a defect that permeates the two-dimensional material, wherein the defect has an average size greater than or equal to the average pore diameter of the second population of pores, and wherein the defect is substantially blocked by the polymer derived from interfacial polymerization.

The average pore diameter of the first population of pores can, for example, be 0.3 nm or more (e.g., 0.35 nm or more, 0.4 nm or more, 0.45 nm or more, 0.5 nm or more, 0.55 nm or more, 0.6 nm or more, 0.65 nm or more, 0.7 nm or more, 0.75 nm or more, 0.8 nm or more, 0.85 nm or more, 0.9 nm or more, 0.95 nm or more, 1 nm or more, 1.25 nm or more, 1.5 nm or more, 1.75 nm or more, 2 nm or more, 2.5 nm or more, 3 nm or more, 3.5 nm or more, or 4 nm or more). In some examples, the average pore diameter of the first population of pores can be 5 nm or less (e.g., 4.5 nm or less, 4 nm or less, 3.5 nm or less, 3 nm or less, 2.5 nm or less, 2 nm or less, 1.75 nm or less, 1.5 nm or less, 1.25 nm or less, 1 nm or less, 0.95 nm or less, 0.9 nm or less, 0.85 nm or less, 0.8 nm or less, 0.75 nm or less, 0.7 nm or less, 0.65 nm or less, 0.6 nm or less, 0.55 nm or less, 0.5 nm or less, 0.45 nm or less, or 0.4 nm or less). The average pore diameter of the first population of pores can range from any of the minimum values described above to any of the maximum values described above. For example, the average pore diameter of the first population of pores can be from 0.3 nm to 5 nm (e.g., from 0.3 nm to 2.5 nm, from 2.5 nm to 5 nm, from 0.3 nm to 1.5 nm, from 1.5 nm to 3 nm, from 3 nm to 5 nm, from 0.3 nm to 4 nm, from 0.3 nm to 2 nm, from 0.3 nm to 1 nm, from 0.3 nm to 0.9 nm, from 0.3 nm to 0.75 nm, from 0.3 nm to 0.65 nm, or from 0.3 nm to 0.5 nm).

In some examples, substantially all of the second population of pores are substantially blocked by a polymer derived from a first monomer and a second monomer via size selective interfacial polymerization, e.g. wherein the first population of pores and the second population on pores are both present during the interfacial polymerization and wherein the first monomer has an average size that is greater than the average pore diameter of the second population of pores; wherein the second monomer has an average size that is greater than the average pore diameter of the first population of pores and less than or equal to the average pore diameter of the second population of pores (e.g., such that the first monomer and second monomer are both size excluded from the first population of pores), such that interfacial polymerization occurs between the first monomer and the second monomer within the second population of pores, thereby substantially blocking the second population of pores, while the first population of pores remain unblocked.

The first monomer and the second monomer can comprise any suitable monomers for interfacial polymerization, such as those known in the art. For example, the first monomer and the second monomer can be selected such that interfacial polymerization occurs between the first monomer and the second monomer within the second population of pores and/or within the defects. In some examples, the first monomer and the second monomer can be selected such that they are size excluded from the first population of pores. In some examples, the second monomer can comprise a molecule with a well-defined, central, cage-like structure.

In some examples, the first monomer comprises trimesoyl chloride (TMC; 1,3,5-benzenetricarbonyl chloride) and the second monomer comprises a polyhedral oligomeric silsesquioxane (POSS) (e.g., octa-ammonium polyhedral oligomeric silsesquioxane, octa-aminophenyl a polyhedral oligomeric silsesquioxane, aminopropylisobutyl a polyhedral oligomeric silsesquioxane), beta cyclodextrin, bovine serum albumin, piperazine, a polyoxyalkylenepolyamine (e.g., Jeffamine), or a combination thereof.

In some examples, the first monomer comprises trimesoyl chloride (TMC) and the second monomer comprises a polyhedral oligomeric silsesquioxane (POSS) (e.g., octa-ammonium polyhedral oligomeric silsesquioxane, octa-aminophenyl a polyhedral oligomeric silsesquioxane, aminopropylisobutyl a polyhedral oligomeric silsesquioxane). In some examples, the first monomer comprises trimesoyl chloride (TMC) and the second monomer comprises octa-ammonium polyhedral oligomeric silsesquioxane.

In some examples, the first monomer can comprise an acid chloride and the second monomer can comprise a polyamine. Examples of suitable acid chlorides include, but are not limited to: trimesoyl chloride; terephthaloyl chloride; isophthaloyl chloride; tetracyl chloride; cyclohexane-1,3,5-tricarbonyl chloride; benzene-1,3,5-trisulphonyl chloride; benzene-1,4-disulphonyl chloride; adipoyl chloride; sebacoyl chloride; derivatives thereof; and combinations thereof. Examples of suitable polyamines include, but are not limited to: phenylene diamine, diphenylene diamine, piperazine, hexamethylene diamine (HMDA), poly(etherene imine), derivatives thereof, and combinations thereof.

The polymer can comprise any suitable polymer derived from interfacial polymerization, such as those known in the art. The polymer can comprise any suitable polymer derived from interfacial polymerization, such as those described, for example, in Raaijmakers et al. Progress in Polymer Science, 2016, 63, 86-142, which is incorporated herein for its description of interfacial polymerization. The polymer can, for example, comprise a polyamide, a polyurethane, a polyurea, a polyester, a polyamine, a polyamide, a polyaniline, a polypyrrole, a polyphyrin, a polycarbazole, a polyindole, a polythiophene, a polyimide, a polycarbonate, a polysiloxane, a polyhedral oligomeric silsesquioxane based polymer, derivatives thereof, or a combination thereof.

In some examples, the polymer can comprise a polyamide such as an aromatic polyamide, an aliphatic polyamide, a poly(piperazine-amide), a poly(sulfon-amide), or a combination thereof. In some examples, the polymer can comprise a polyamide derived from an acid chloride and a polyamine. Examples of suitable acid chlorides include, but are not limited to, trimesoyl chloride; terephthaloyl chloride; isophthaloyl chloride; tetracyl chloride; cyclohexane-1,3,5-tricarbonyl chloride; benzene-1,3,5-trisulphonyl chloride; benzene-1,4-disulphonyl chloride; adipoyl chloride; derivatives thereof; and combinations thereof. Examples of suitable polyamines include, but are not limited to, (di)phenylene diamine; piperazine; hexamethylene diamine (HMDA); poly(etherene imine); derivatives thereof; and combinations thereof.

In some examples, the polymer can comprise a poly(bio-amide) derived from an acid chloride (e.g., trimesoyl chloride, terephthaloyl chloride, sebacoyl chloride, etc.) and bovine serum albumin, fibrinogen, pepsin, derivatives thereof, or combinations thereof.

In some examples, the polymer can comprise a polyurethane, a polyurea, or a combination thereof derived from an isocyanate (e.g. a diisocyanate) and an alcohol (e.g., a polyol), an amine, or a combination thereof. Examples of suitable isocyanates include, but are not limited to, diphenylmethane diisocyanate; toluene diisocyanate; hexamethylene diisocyanate; isophorone diisocyanate; triisocyanates (e.g., Desmodur L-75; Sumidur N-3300; Takenate D-110N); 5-isocyanato-1-(isocyanatomethyl)-1,3,3-trimethyl-cyclohexane (IPDI); 1-isocyanato-4-[(4-isocyanatophenyl) methyl] benzene (MDI); 1,6-diisocyanatohexane; polyhexamethylene diisocyanate; derivatives thereof; and combinations thereof. Examples of suitable alcohols include, but are not limited to, ethane-1,2-diol; 1,6-hexanediol; polyethylene glycol; 1,3-dihydroxyacetone; L-lactic acid; L-lysine; 1,4-butanediol; polyvinyl alcohol; 2-amino-2-(hydroxymethyl)-1,3-propanediol; tris(2-hydroxyethyl)amine; 2-(hydroxymethyl)-2-ethylpropane-1,3-diol; derivatives thereof; and combinations thereof. Examples of suitable amines include, but are not limited to, 1,6-diaminohexane; urea; L-alaninamide hydrochloride; diethylene triamine; L-lysine; polyamidoamine; 2-amino-2-(hydroxymethyl)-1,3-propanediol; tris(2-hydroxyethyl)amine; derivatives thereof; and combinations thereof.

In some examples, the polymer can comprise a polyester derived from an acid halide (e.g., trimesoyl chloride, isophthaloyl chloride) and an alcohol (e.g., a polyol). Examples of suitable alcohols include, but are not limited to, bisphenol A; triethanolamine; beta-cyclodextrin; N-methyl-diethanolamine; hyperbranched polyester; diphenolic acid; tannic acid; derivatives thereof; and combinations thereof.

In some examples, the polymer can comprise a polyester derived from a carboxylic acid and an epoxy. Examples of suitable carboxylic acids include, but are not limited to, potassium decanedioate; potassium 1,3,5-benzene tricaboxylate; diphenolic acid; derivatives thereof; and combinations thereof.

In some examples, the polymer can comprise a polyamine derived from a diamine and a di- or tri-chloride functionalized triazine. Examples of suitable diamines include, but are not limited to, poly(ethylene imine); diethylene triamine; phenylene diamine; piperazine; melamine; bis(4-amino cyclohexyl)methane; hexamethylenediamine; polyvinylamine; derivatives thereof; or combinations thereof. Examples of suitable di- or tri-chloride functionalized triazines include, but are not limited to, cyanuric chloride; 2-dialkoxyphosphinyl-4,6-dichloro-s-triazine; derivatives thereof; and combinations thereof.

In some examples, the polymer can comprise a polyimide derived from an anhydride and an amine. Examples of suitable anhydrides include, but are not limited to, 2,5-bis(methoxy carbonyl)terephthaloyl chloride; 1,2,4,5′-benzene tetraacyl chloride; pyromellitic dianhydride; 3,3′,4,4′-biphenyl tetracarboxylic dianhydride; 4,4′-oxydiphthalic anhydride; 4,4′-(4,4′-isopropylidene diphenyl)bis(phthalic anhydride); 4,4-(hexafluoro iso propylidene) diphthalic anhydride; derivatives thereof; and combinations thereof. Examples of suitable amines include, but are not limited to, phenylene diamine; ethylene diamine; hexamethylene diamine; 4,4′-methylene dianiline; octa-ammonium POSS; derivatives thereof; and combinations thereof.

In some examples, the polymer can comprise a polyaniline derived via the oxidation of aniline by an oxidizing agent followed by the reaction of the oxidized aniline with another aniline. In some examples, the polymer can comprise a polypyrrole derived via the oxidation of pyrrole by an oxidizing agent followed by the reaction of the oxidized pyrrole with another pyrrole. In some examples, the polymer can comprise a polyphyrin derived via the oxidation of a porphyrin by an oxidizing agent followed by the reaction of the oxidized porphyrin with another porphyrin. In some examples, the polymer can comprise a polycarbazole derived via the oxidation of a carbazole by an oxidizing agent followed by the reaction of the oxidized carbazole with another carbazole. In some examples, the polymer can comprise a polyindole derived via the oxidation of an indole by an oxidizing agent followed by the reaction of the oxidized indole with another indole. In some examples, the polymer can comprise a polythiophene derived via the oxidation of a thiophene by an oxidizing agent followed by the reaction of the oxidized thiophene with another thiophene. Examples of suitable oxidizing agents include, but are not limited to, ammonium peroxydisulfate; ferric chloride; Fe(NO₃)₃; copper acetate; silver nitrate; mercury acetate; HAuCl₄; derivatives thereof; and combinations thereof.

In some examples, the polymer is derived from: hexamethylenediamine (HMDA) and adipoyl chloride (APC); trimesoyl chloride (TMC) and a polyhedral oligomeric silsesquioxane (POSS); trimesoyl chloride (TMC) and beta cyclodextrin; trimesoyl chloride (TMC) and bovine serum albumin; or a combination thereof. In some examples, the polymer is derived from: hexamethylenediamine (HMDA) and adipoyl chloride (APC). In some examples, the polymer is derived from trimesoyl chloride (TMC) and a polyhedral oligomeric silsesquioxane (POSS).

In some examples, the polymer can comprise polyhedral oligomeric silsesquioxane-polyamide (POSS-PA); nylon 6,6; or a combination thereof.

In some examples, the nanoporous membrane forms a free-standing membrane. In some examples, the nanoporous membrane is supported by a substrate. Examples of suitable substrates include, but are not limited to, polymers (e.g., porous polymers), glass fibers, glass, quartz, silicon, anodic alumina, a ceramic, a fabric, and combinations thereof. In some examples, the substrate comprises a polymer, such as polycarbonate.

In some examples, the target substance and the fluid medium together comprise a moisture-containing fluid (e.g., a water-containing fluid). For example, the moisture-containing fluid can comprise liquid water or an aqueous solution. In some examples, the moisture-containing fluid comprises a moisture-containing gas, such as moisture-containing air or water vapor.

In some examples, the target substance comprises water. In some examples, the non-target substance can comprise a salt, an organic molecule, a biological agent (e.g., a bacterium, virus, protozoan, parasite, fungus, biological warfare agent, or combination thereof), or a combination thereof. In some examples, the non-target substance can comprise a warfare agent, such as a chemical or biological warfare agent.

In some examples, the non-target substance can comprise a biomolecule, a macromolecule, a pathogen (e.g., bacteria, virus, fungi, parasite, protozoa, etc.), or a combination thereof. As used herein, a biomolecule can comprise, for example, a nucleotide, an enzyme, an amino acid, a protein (e.g., a glycoprotein, a lipoprotein, or a recombinant protein), a polysaccharide, a lipid, a nucleic acid, a vitamin, a hormone, a prohormone, a peptide (natural, modified, or chemically synthesized), a polypeptide, polynucleotide (e.g., DNA or RNA, an oligonucleotide, an aptamer, or a DNAzyme), or a combination thereof.

In some examples, the target substance comprises a pathogen, such as bacteria, virus, fungi, parasite, protozoa, or a combination thereof.

Examples of viruses include both DNA viruses and RNA viruses. Exemplary viruses can belong to the following non-exclusive list of families Adenoviridae, Arenaviridae, Astroviridae, Baculoviridae, Barnaviridae, Betaherpesvirinae, Birnaviridae, Bromoviridae, Bunyaviridae, Caliciviridae, Chordopoxvirinae, Circoviridae, Comoviridae, Coronaviridae, Cystoviridae, Corticoviridae, Entomopoxvirinae, Filoviridae, Flaviviridae, Fuselloviridae, Geminiviridae, Hepadnaviridae, Herpesviridae, Gammaherpesvirinae, Inoviridae, Iridoviridae, Leviviridae, Lipothrixviridae, Microviridae, Myoviridae, Nodaviridae, Orthomyxoviridae, Papovaviridae, Paramyxoviridae, Paramyxovirinae, Partitiviridae, Parvoviridae, Phycodnaviridae, Picornaviridae, Plasmaviridae, Pneumovirinae, Podoviridae, Polydnaviridae, Potyviridae, Poxviridae, Reoviridae, Retroviridae, Rhabdoviridae, Sequiviridae, Siphoviridae, Tectiviridae, Tetraviridae, Togaviridae, Tombusviridae, and Totiviridae.

Specific examples of viruses include, but are not limited to, Mastadenovirus, Adenovirus, Human adenovirus 2, Aviadenovirus, African swine fever virus, arenavirus, Lymphocytic choriomeningitis virus, Ippy virus, Lassa virus, Arterivirus, Human astrovirus 1, Nucleopolyhedrovirus, Autographa californica nucleopolyhedrovirus, Granulovirus, Plodia interpunctella granulovirus, Badnavirus, Commelina yellow mottle virus, Rice tungro bacilliform, Barnavirus, Mushroom bacilliform virus, Aquabirnavirus, Infectious pancreatic necrosis virus, Avibirnavirus, Infectious bursal disease virus, Entomobirnavirus, Drosophila X virus, Alfamovirus, Alfalfa mosaic virus, Ilarvirus, Ilarvirus Subgroups 1-10, Tobacco streak virus, Bromovirus, Brome mosaic virus, Cucumovirus, Cucumber mosaic virus, Bhanja virus Group, Kaisodi virus, Mapputta virus, Okola virus, Resistencia virus, Upolu virus, Yogue virus, Bunyavirus, Anopheles A virus, Anopheles B virus, Bakau virus, Bunyamwera virus, Bwamba virus, C virus, California encephalitis virus, Capim virus, Gamboa virus, Guama virus, Koongol virus, Minatitlan virus, Nyando virus, Olifantsvlei virus, Patois virus, Simbu virus, Tete virus, Turlock virus, Hantavirus, Hantaan virus, Nairovirus, Crimean-Congo hemorrhagic fever virus, Dera Ghazi Khan virus, Hughes virus, Nairobi sheep disease virus, Qalyub virus, Sakhalin virus, Thiafora virus, Crimean-congo hemorrhagic fever virus, Phlebovirus, Sandfly fever virus, Bujaru complex, Candiru complex, Chilibre complex, Frijoles complex, Punta Toro complex, Rift Valley fever complex, Salehabad complex, Sandfly fever Sicilian virus, Uukuniemi virus, Uukuniemi virus, Tospovirus, Tomato spotted wilt virus, Calicivirus, Vesicular exanthema of swine virus, Capillovirus, Apple stem grooving virus, Carlavirus, Carnation latent virus, Caulimovirus, Cauliflower mosaic virus, Circovirus, Chicken anemia virus, Closterovirus, Beet yellows virus, Comovirus, Cowpea mosaic virus, Fabavirus, Broad bean wilt virus 1, Nepovirus, Tobacco ringspot virus, Coronavirus, Avian infectious bronchitis virus, Bovine coronavirus, Canine coronavirus, Feline infectious peritonitis virus, Human coronavirus 299E, Human coronavirus OC43, Murine hepatitis virus, Porcine epidemic diarrhea virus, Porcine hemagglutinating encephalomyelitis virus, Porcine transmissible gastroenteritis virus, Rat coronavirus, Turkey coronavirus, Rabbit coronavirus, Torovirus, Berne virus, Breda virus, Corticovirus, Alteromonas phage PM2, Pseudomonas Phage phi6, Deltavirus, Hepatitis delta virus, Hepatitis D virus, Hepatitis E virus, Dianthovirus, Carnation ringspot virus, Red clover necrotic mosaic virus, Sweet clover necrotic mosaic virus, Enamovirus, Pea enation mosaic virus, Filovirus, Marburg virus, Ebola virus, Ebola virus Zaire, Flavivirus, Yellow fever virus, Tick-borne encephalitis virus, Rio Bravo Group, Japanese encephalitis, Tyuleniy Group, Ntaya Group, Uganda S Group, Dengue Group, Modoc Group, Pestivirus, Bovine diarrhea virus, Hepatitis C virus, Furovirus, Soil-borne wheat mosaic virus, Beet necrotic yellow vein virus, Fusellovirus, Sulfobolus virus 1, Subgroup I, II, and III geminivirus, Maize streak virus, Beet curly top virus, Bean golden mosaic virus, Orthohepadnavirus, Hepatitis B virus, Avihepadnavirus, Alphaherpesvirinae, Simplexvirus, Human herpesvirus 1, Herpes Simplex virus-1, Herpes Simplex virus-2, Varicellovirus, Varicella-Zoster virus, Epstein-Barr virus, Human herpesvirus 3, Cytomegalovirus, Human herpesvirus 5, Muromegalovirus, Mouse cytomegalovirus 1, Roseolovirus, Human herpesvirus 6, Lymphocryptovirus, Human herpesvirus 4, Rhadinovirus, Ateline herpesvirus 2, Hordeivirus, Barley stripe mosaic virus, Hypoviridae, Hypovirus, Cryphonectria hypovirus 1-EP713, Idaeovirus, Raspberry bushy dwarf virus, Inovirus, Coliphage fd, Plectrovirus, Acholeplasma phage L51, Iridovirus, Chilo iridescent virus, Chloriridovirus, Mosquito iridescent virus, Ranavirus, Frog virus 3, Lymphocystivirus, Lymphocystis disease virus flounder isolate, Goldfish virus 1, Levivirus, Enterobacteria phage MS2, Allolevirus, Enterobacteria phage Qbeta, Lipothrixvirus, Thermoproteus virus 1, Luteovirus, Barley yellow dwarf virus, Machlomovirus, Maize chlorotic mottle virus, Marafivirus, Maize rayado fino virus, Microvirus, Coliphage phiX174, Spiromicrovirus, Spiroplasma phage 4, Bdellomicrovirus, Bdellovibrio phage MAC 1, Chlamydiamicrovirus, Chlamydia phage 1, T4-like phages, coliphage T4, Necrovirus, Tobacco necrosis virus, Nodavirus, Nodamura virus, Influenza virus A, B and C, Thogoto virus, Polyomavirus, Murine polyomavirus, Papillomavirus, Rabbit (Shope) Papillomavirus, Paramyxovirus, Human parainfluenza virus 1, Morbillivirus, Measles virus, Rubulavirus, Mumps virus, Pneumovirus, Human respiratory syncytial virus, Partitivirus, Gaeumannomyces graminis virus 019/6-A, Chrysovirus, Penicillium chrysogenum virus, Alphacryptovirus, White clover cryptic viruses 1 and 2, Betacryptovirus, Parvovirinae, Parvovirus, Minute mice virus, Erythrovirus, B19 virus, Dependovirus, Adeno-associated virus 1, Densovirinae, Densovirus, Junonia coenia densovirus, Iteravirus, Bombyx mori virus, Contravirus, Aedes aegypti densovirus, Phycodnavirus, 1-Paramecium bursaria Chlorella NC64A virus group, Paramecium bursaria chlorella virus 1, 2-Paramecium bursaria Chlorella Pbi virus, 3-Hydra viridis Chlorella virus, Enterovirus, Poliovirus, Human poliovirus 1, Rhinovirus, Human rhinovirus 1A, Hepatovirus, Human hepatitis A virus, Cardiovirus, Encephalomyocarditis virus, Aphthovirus, Foot-and-mouth disease virus, Plasmavirus, Acholeplasma phage L2, Podovirus, Coliphage T7, Ichnovirus, Campoletis sonorensis virus, Bracovirus, Cotesia melanoscela virus, Potexvirus, Potato virus X, Potyvirus, Potato virus Y, Rymovirus, Ryegrass mosaic virus, Bymovirus, Barley yellow mosaic virus, Orthopoxvirus, Vaccinia virus, Parapoxvirus, Orf virus, Avipoxvirus, Fowlpox virus, Capripoxvirus, Sheep pox virus, Leporipoxvirus, Myxoma virus, Suipoxvirus, Swinepox virus, Molluscipoxvirus, Molluscum contagiosum virus, Yatapoxvirus, Yaba monkey tumor virus, Entomopoxviruses A, B, and C, Melolontha melolontha entomopoxvirus, Amsacta moorei entomopoxvirus, Chironomus luridus entomopoxvirus, Orthoreovirus, Mammalian orthoreoviruses, reovirus 3, Avian orthoreoviruses, Orbivirus, African horse sickness viruses 1, Bluetongue viruses 1, Changuinola virus, Corriparta virus, Epizootic hemarrhogic disease virus 1, Equine encephalosis virus, Eubenangee virus group, Lebombo virus, Orungo virus, Palyam virus, Umatilla virus, Wallal virus, Warrego virus, Kemerovo virus, Rotavirus, Groups A-F rotaviruses, Simian rotavirus SA11, Coltivirus, Colorado tick fever virus, Aquareovirus, Groups A-E aquareoviruses, Golden shiner virus, Cypovirus, Cypovirus types 1-12, Bombyx mori cypovirus 1, Fijivirus, Fijivirus groups 1-3, Fiji disease virus, Fijivirus groups 2-3, Phytoreovirus, Wound tumor virus, Oryzavirus, Rice ragged stunt, Mammalian type B retroviruses, Mouse mammary tumor virus, Mammalian type C retroviruses, Murine Leukemia Virus, Reptilian type C oncovirus, Viper retrovirus, Reticuloendotheliosis virus, Avian type C retroviruses, Avian leukosis virus, Type D Retroviruses, Mason-Pfizer monkey virus, BLV-HTLV retroviruses, Bovine leukemia virus, Lentivirus, Bovine lentivirus, Bovine immunodeficiency virus, Equine lentivirus, Equine infectious anemia virus, Feline lentivirus, Feline immunodeficiency virus, Canine immunodeficiency virus Ovine/caprine lentivirus, Caprine arthritis encephalitis virus, Visna/maedi virus, Primate lentivirus group, Human immunodeficiency virus 1, Human immunodeficiency virus 2, Human immunodeficiency virus 3, Simian immunodeficiency virus, Spumavirus, Human spuma virus, Vesiculovirus, Vesicular stomatitis virus, Vesicular stomatitis Indiana virus, Lyssavirus, Rabies virus, Ephemerovirus, Bovine ephemeral fever virus, Cytorhabdovirus, Lettuce necrotic yellows virus, Nucleorhabdovirus, Potato yellow dwarf virus, Rhizidiovirus, Rhizidiomyces virus, Sequivirus, Parsnip yellow fleck virus, Waikavirus, Rice tungro spherical virus, Lambda-like phages, Coliphage lambda, Sobemovirus, Southern bean mosaic virus, Tectivirus, Enterobacteria phage PRD1, Tenuivirus, Rice stripe virus, Nudaurelia capensis beta-like viruses, Nudaurelia beta virus, Nudaurelia capensis omega-like viruses, Nudaurelia omega virus, Tobamovirus, Tobacco mosaic virus (vulgare strain; ssp. NC82 strain), Tobravirus, Tobacco rattle virus, Alphavirus, Sindbis virus, Rubivirus, Rubella virus, Tombusvirus, Tomato bushy stunt, virus, Carmovirus, Carnation mottle virus, Turnip crinkle virus, Totivirus, Saccharomyces cerevisiae virus, Giardiavirus, Giardia lamblia virus, Leishmaniavirus, Leishmania brasiliensis virus 1-1, Trichovirus, Apple chlorotic leaf spot virus, Tymovirus, Turnip yellow mosaic virus, Umbravirus, Carrot mottle virus, Variola virus, Coxsackie virus, Dengue virus, Rous sarcoma virus, Zika virus, Lassa fever virus, Eastern Equine Encephalitis virus, Venezuelan equine encephalitis virus, Western equine encephalitis virus, St. Louis Encephalitis virus, Murray Valley fever virus, West Nile virus, Human T-cell Leukemia virus type-1, echovirus, norovirus, andfeline calicivirus (FCV).

In some examples, the virus can comprise an influenza virus, a coronavirus, or a combination thereof. Examples of influenza viruses include, but are not limited to, Influenza virus A (including the H1N1, H2N2, H3N2, H5N1, H7N7, H1N2, H9N2, H7N2, H7N3, H10N7, H7N9, and H6N1 serotypes), Influenza virus B, Influenza virus C, and Influenza virus D. Examples of coronaviruses include, but are not limited to, avian coronavirus (IBV), porcine epidemic diarrhea virus (PEDV), porcine respiratory coronavirus (PRCV), transmissible gastroenteritis virus (TGEV), feline coronavirus (FCoV), feline infectious peritonitis virus (FIPV), feline enteric coronavirus (FECV), canine coronavirus (CCoV), rabbit coronavirus (RaCoV), mouse hepatitis virus (MHV), rat coronavirus (RCoV), sialodacryadenitis virus of rats (SDAV), bovine coronavirus (BCoV), bovine enterovirus (BEV), porcine coronavirus HKU15 (PorCoV HKU15), Porcine epidemic diarrhea virus (PEDV), porcine hemagglutinating encephalomyelitis virus (HEV), turkey bluecomb coronavirus (TCoV), human coronavirus (HCoV)-229E, HCoV-OC43, HCoV-HKU1, HCoV-NL63, Severe Acute Respiratory Syndrome (SARS)-Coronavirus (CoV)(SARS-CoV), Severe Acute Respiratory Syndrome (SARS)-Coronavirus (CoV)-2 (SARS-CoV-2), and middle east respiratory syndrome (MERS) coronavirus (CoV) (MERS-CoV). In some examples, the virus can comprise Severe Acute Respiratory Syndrome (SARS)-Coronavirus (CoV)-2 (SARS-CoV-2).

Specific examples of bacteria include, but are not limited to, Mycobacterium tuberculosis, Mycobacterium bovis, Mycobacterium bovis strain BCG, BCG substrains, Mycobacterium avium, Mycobacterium intracellular, Mycobacterium africanum, Mycobacterium kansasii, Mycobacterium marinum, Mycobacterium ulcerans, Mycobacterium avium subspecies paratuberculosis, Nocardia asteroides, other Nocardia species, Legionella pneumophila, other Legionella species, Acetinobacter baumanii, Salmonella typhi, Salmonella enterica, Salmonella Typhimurium, other Salmonella species, Shigella boydii, Shigella dysenteriae, Shigella sonnei, Shigella flexneri, other Shigella species, Yersinia pestis, Pasteurella haemolytica, Pasteurella multocida, other Pasteurella species, Actinobacillus pleuropneumoniae, Listeria monocytogenes, Listeria ivanovii, Brucella abortus, Brucella suis, Brucella melitensis, other Brucella species, Cowdria ruminantium, Borrelia burgdorferi, Bordetella avium, Bordetella pertussis, Bordetella bronchiseptica, Bordetella trematum, Bordetella hinzii, Bordetella pteri, Bordetella parapertussis, Bordetella ansorpii, other Bordetella species, Burkholderia mallei, Burkholderia psuedomallei, Burkholderia cepacian, Chlamydia pneumoniae, Chlamydia trachomatis, Chlamydia psittaci, Coxiella burnetii, rickettsia rickettsia, rickettsia prowazekii, rickettsia typhi, other Rickettsial species, Ehrlichia species, Staphylococcus aureus, Staphylococcus epidermidis, Streptococcus pneumoniae, Streptococcus pyogenes, Streptococcus agalactiae, Streptococcus uberis, Escherichia coli, Vibrio cholerae, Vibrio parahaemolyticus, Campylobacter species, Neiserria meningitidis, Neiserria gonorrhea, Pseudomonas aeruginosa, other Pseudomonas species, Haemophilus influenzae, Haemophilus ducreyi, other Hemophilus species, Clostridium tetani, Clostridium difficile, Clostridium botulinum, Clostridium perfringens, other Clostridium species, Yersinia enterolitica, Yersinia pestis, other Yersinia species, Mycoplasma species, Bacillus anthracis, Bacillus abortus, other Bacillus species, Corynebacterium diptheriae, Corynebacterium bovis, Francisella tularensis, Chlamydophila psittaci, Campylocavter jejuni, Enterobacter aerogenes, Klebsiella pneumoniae, Klebsiella oxytoca, Proteus spp., Serratia marcescens, Trueperella pyogenes, and Vibria vulnificus.

Specific examples of fungi include, but are not limited to, Candida albicans, Cryptococcus neoformans, Histoplama capsulatum, Aspergillus niger, Aspergillus oryzae, Aspergillus fumigatus, Coccidiodes immitis, Paracoccidioides brasiliensis, Blastomyces dermitidis, Pneumocystis carinii, Penicillium marneffi, Alternaria alternate, coccidioides immitits, Fusarium oxysporum, Geotrichum candidum, and Histoplasma capsulatum.

Specific examples of parasites include, but are not limited to, Toxoplasma gondii, Plasmodium falciparum, Plasmodium vivax, Plasmodium malariae, other Plasmodium species, Entamoeba histolytica, Naegleria fowleri, Rhinosporidium seeberi, Giardia lamblia, Enterobius vermicularis, Enterobius gregorii, Ascaris lumbricoides, Ancylostoma duodenale, Necator americanus, Cryptosporidium spp., Trypanosoma brucei, Trypanosoma cruzi, Leishmania major, other Leishmania species, Diphyllobothrium latum, Hymenolepis nana, Hymenolepis diminuta, Echinococcus granulosus, Echinococcus multilocularis, Echinococcus vogeli, Echinococcus oligarthrus, Diphyllobothrium latum, Clonorchis sinensis; Clonorchis viverrini, Fasciola hepatica, Fasciola gigantica, Dicrocoelium dendriticum, Fasciolopsis buski, Metagonimus yokogawai, Opisthorchis viverrini, Opisthorchis felineus, Clonorchis sinensis, Trichomonas vaginalis, Acanthamoeba species, Schistosoma intercalatum, Schistosoma haematobium, Schistosoma japonicum, Schistosoma mansoni, other Schistosoma species, Trichobilharzia regenti, Trichinella spiralis, Trichinella britovi, Trichinella nelsoni, Trichinella nativa, and Entamoeba histolytica.

In some examples, the non-target substance can comprise a chemical or biological warfare agent. Examples of chemical warfare agents include, but are not limited to, nerve agents (e.g., sarin, soman, cyclosarin, tabun, Ethyl ({2-[bis(propan-2-yl)amino]ethyl}sulfanyl)(methyl)phosphinate (VX), O-pinacolylmethylphosphonofluoridate), vesicating or blistering agents (e.g., mustards, lewisite), respiratory agents (e.g., chlorine, phosgene, diphosgene), cyanides, antimiscarinic agents (e.g., anticholinergic compounds), opioid agents, lachrymatory agents (e.g., a-cholorotoluene, benzyl bromide, boromoacetone (BA), boromobenzylcyanide (CA), capsaicin (OC), chloracetophenone (MACE), chlormethyl choloroformate, dibenoxazepine (CR), ethyl iodoacetate, ortho-chlorobenzlidene malonitrile (CS), trichloromethyl chloroformate, xylyl bromide), and vomiting agents (e.g., adamsite (DM), diphenylchloroarsine (DA), diphenylcanoarsine (DC)). Biological warfare agents include, but are not limited to bacteria (e.g., Bacillus anthracis, Bacillus abortus, Brucella suis, Vibrio cholerae, Corynebacterium diptheriae, Shigella dysenteriae, Escherichia coli, Burkholderia mallei, Listeria monocytogenes, Burkholderia pseudomallei, Yersinia pestis, Francisella tularensis, Chlamydophila psittaci, Coxiella burnetii, Rickettsia rickettsia, Rickettsia prowazekii, Rickettsia typhi), viruses (e.g., Eastern equine encephalitis virus, Venezuelan equine encephalitis virus, Western equine encephalitis virus, Japanese encephalitis virus, Rift Valley fever virus, Variola virus, Yellow Fever virus, Ebola virus, Marburg virus), protozoa, parasites, fungi (Coccidioides immitis), pathogens, toxins, and biotoxins (Abrin, Botulinum toxin, Ricin, Saxitoxin, Staphylococcal enterotoxin B, tetrodotoxin, trichothecene mycotoxins).

In some examples, the normalized diffusive flux across the nanoporous membrane can be 3% or more (e.g., 3.5% or more, 4% or more, 4.5% or more, 5% or more, 5.5% or more, 6% or more, 6.5% or more, 7% or more, 7.5% or more, 8% or more, 8.5% or more, or 9% or more). In some examples, the normalized diffusive flux across the nanoporous membrane can be 10% or less (e.g., 9.5% or less, 9% or less, 8.5% or less, 8% or less, 7.5% or less, 7% or less, 6.5% or less, 6% or less, 5.5% or less, 5% or less, 4.5% or less, or 4% or less). The normalized diffusive flux across the nanoporous membrane can range from any of the minimum values described above to any of the maximum values described above. For example, the normalized diffusive flux across the nanoporous membrane can be from 3% to 10% (e.g., from 3% to 6.5%, from 6.5% to 10%, from 3% to 5%, from 5% to 7%, from 7% to 10%, from 4% to 10%, from 3% to 9%, from 5% to 10%, or from 4% to 9%).

In some examples, the water flux across the nanoporous membrane can be 0.5×10⁻⁵ m³ m⁻² s⁻¹ or more (e.g., 0.6×10⁻⁵ m³ m⁻² s⁻¹ or more, 0.7×10⁻⁵ m³ m⁻² s⁻¹ or more, 0.8×10⁻⁵ m³ m⁻² s⁻¹ or more, 0.9×10⁻⁵ m³ m⁻² s⁻¹ or more, 1.0×10⁻⁵ m³ m⁻² s⁻¹ or more, 1.1×10⁻⁵ m³ m⁻² s⁻¹ or more, 1.2×10⁻⁵ m³ m⁻² s⁻¹ or more, 1.3×10⁻⁵ m³ m⁻² s⁻¹ or more, or 1.4×10⁻⁵ m³ m⁻² s⁻¹ or more) at an osmotic pressure of 14 bar or more (e.g., 15 bar or more, 16 bar or more, 17 bar or more, 18 bar or more, 19 bar or more, 20 bar or more, 21 bar or more, 22 bar or more, 23 bar or more, or 24 bar or more). In some examples, the water flux across the nanoporous membrane can be 0.5×10⁻⁵ m³ m⁻² s⁻¹ or more (e.g., 0.6×10⁻⁵ m³ m⁻² s⁻¹ or more, 0.7×10⁻⁵ m³ m⁻² s⁻¹ or more, 0.8×10⁻⁵ m³ m⁻² s⁻¹ or more, 0.9×10⁻⁵ m³ m⁻² s⁻¹ or more, 1.0×10⁻⁵ m³ m⁻² s⁻¹ or more, 1.1×10⁻⁵ m³ m⁻² s⁻¹ or more, 1.2×10⁻⁵ m³ m⁻² s⁻¹ or more, 1.3×10⁻⁵ m³ m⁻² s⁻¹ or more, or 1.4×10⁻⁵ m⁻² s⁻¹ or more) at an osmotic pressure of 25 bar or less (e.g., 24 bar or less, 23 bar or less, 22 bar or less, 21 bar or less, 20 bar or less, 19 bar or less, 18 bar or less, 17 bar or less, 16 bar or less, or 15 bar or less). In some examples, the water flux across the nanoporous membrane can be 1.5×10⁻⁵ m³m²s⁻¹ or less (1.4×10⁻⁵ m³ m² s⁻¹ or less, 1.3×10⁻⁵ m³ m² s⁻¹ or less, 1.2×10⁻⁵ m³m² s⁻¹ or less, 1.1×10⁻⁵ m³ m⁻² s⁻¹ or less, 1.0×10⁻⁵ m³ m⁻² s⁻¹ or less, 0.9×10⁻⁵ m³ m⁻² s⁻¹ or less, 0.8×10⁻⁵ m³ m⁻² s⁻¹ or less, 0.7×10⁻⁵ m³ m⁻² s⁻¹ or less, or 0.6×10⁻⁵ m³ m⁻² s⁻¹ or less) at an osmotic pressure of 14 bar or more (e.g., 15 bar or more, 16 bar or more, 17 bar or more, 18 bar or more, 19 bar or more, 20 bar or more, 21 bar or more, 22 bar or more, 23 bar or more, or 24 bar or more). In some examples, the water flux across the nanoporous membrane can be 1.5×10⁻⁵ m³ m² s⁻¹ or less (1.4×10⁻⁵ m³ m² s⁻¹ or less, 1.3×10⁻⁵ m³ m² s⁻¹ or less, 1.2×10⁻⁵ m³ m² s⁻¹ or less, 1.1×10⁻⁵ m³ m⁻² s⁻¹ or less, 1.0×10⁻⁵ m³ m⁻² s⁻¹ or less, 0.9×10⁻⁵ m³ m⁻² s⁻¹ or less, 0.8×10⁻⁵ m³ m⁻² s⁻¹ or less, 0.7×10⁻⁵ m³ m⁻² s⁻¹ or less, or 0.6×10⁻⁵ m³ m⁻² s⁻¹ or less) at an osmotic pressure of 25 bar or less (e.g., 24 bar or less, 23 bar or less, 22 bar or less, 21 bar or less, 20 bar or less, 19 bar or less, 18 bar or less, 17 bar or less, 16 bar or less, or 15 bar or less). The water flux across the nanoporous membrane at the osmotic pressure can range from any of the minimum values described above to any of the maximum values described above. For examples, the water flux across the nanoporous membrane can be from 0.5×10⁻⁵ m³ m⁻² s⁻¹ to 1.5×10⁻⁵ m³ m⁻² s⁻¹ (e.g., from 0.5×10⁻⁵ m³ m⁻² s⁻¹ to 1×10⁻⁵ m³ m⁻² s⁻¹, from 1×10⁻⁵ m³ m⁻² s⁻¹ to 1.5×10⁻⁵ m³ m⁻² s⁻¹, from 0.5×10⁻⁵ m³ m⁻² s⁻¹ to 0.75×10⁻⁵ m³ m⁻² s⁻¹, from 0.75×10⁻⁵ m³ m⁻² s⁻¹ to 1×10⁻⁵ m³ m⁻² s⁻¹, from 1×10⁻⁵ m³ m⁻² s⁻¹ to 1.25×10⁻⁵ m³ m⁻² s⁻¹, from 1.25×10⁻⁵ m³ m² s⁻¹ to 1.5×10⁻⁵ m³ m² s⁻¹, from 0.6×10⁻⁵ m³ m² s⁻¹ to 1.5×10⁻⁵ m³ m² s⁻¹, from 0.5×10⁻⁵ m³ m² s⁻¹ to 1.4×10⁻⁵ m³ m² s⁻¹, or from 0.6×10⁻⁵ m³ m²s⁻¹ to 1.4×10⁻⁵ m³ m² s⁻¹) at an osmotic pressure of from 14 bar to 25 bar (e.g., from 14 bar to 20 bar, from 20 bar to 25 bar, from 14 bar to 17 bar, from 17 bar to 20 bar, from 20 bar to 23 bar, from 23 bar to 25 bar, from 15 bar to 25 bar, from 14 bar to 24 bar, or from 15 bar to 24 bar).

In some examples, the nanoporous membrane exhibits a moisture vapor transport rate (MVTR) of 10 g m⁻² d⁻¹ or more (e.g., 15 g m⁻² d⁻¹ or more, 20 g m⁻² d⁻¹ or more, 25 g m⁻² d⁻¹ or more, 30 g m⁻² d⁻¹ or more, 35 g m⁻² d⁻¹ or more, 40 g m⁻² d⁻¹ or more, 45 g m⁻² d⁻¹ or more, 50 g m⁻² d⁻¹ or more, 60 g m⁻² d⁻¹ or more, 70 g m⁻² d⁻¹ or more, 80 g m⁻² d⁻¹ or more, 90 g m⁻² d⁻¹ or more, 100 g m⁻² d⁻¹ or more, 125 g m⁻² d⁻¹ or more, 150 g m⁻² d⁻¹ or more, 175 g m⁻² d⁻¹ or more, 200 g m⁻² d⁻¹ or more, 225 g m⁻² d⁻¹ or more, 250 g m⁻² d⁻¹ or more, 300 g m⁻² d⁻¹ or more, 350 g m⁻² d⁻¹ or more, 400 g m⁻² d⁻¹ or more, 450 g m⁻² d⁻¹ or more, 500 g m⁻² d⁻¹ or more, 600 g m⁻² d⁻¹ or more, 700 g m⁻² d⁻¹ or more, 800 g m⁻² d⁻¹ or more, 900 g m⁻² d⁻¹ or more, 1000 g m⁻² d⁻¹ or more, 1100 g m⁻² d⁻¹ or more, 1200 g m⁻² d⁻¹ or more, 1300 g m⁻² d⁻¹ or more, 1400 g m⁻² d⁻¹ or more, 1500 g m⁻² d⁻¹ or more, 1600 g m⁻² d⁻¹ or more, 1700 g m⁻² d⁻¹ or more, 1800 g m⁻² d⁻¹ or more, 1900 g m⁻² d⁻¹ or more, 2000 g m⁻² d⁻¹ or more, 2100 g m⁻² d⁻¹ or more, 2200 g m⁻² d⁻¹ or more, 2300 g m⁻² d⁻¹ or more, 2400 g m⁻² d⁻¹ or more, 2500 g m⁻² d⁻¹ or more, 3000 g m⁻² d⁻¹ or more, 3500 g m⁻² d⁻¹ or more, 4000 g m⁻² d⁻¹ or more, 4500 g m⁻² d⁻¹ or more, 5000 g m⁻² d⁻¹ or more, 6000 g m⁻² d⁻¹ or more, 7000 g m⁻² d⁻¹ or more, 8000 g m⁻² d⁻¹ or more, 9000 g m⁻² d⁻¹ or more, or 10,000 g m⁻² d⁻¹ or more).

In some examples, the nanoporous membrane exhibits a rejection of 90% or more (e.g., 91% or more, 92% or more, 93% or more, 94% or more, 95% or more, 96% or more, 97% or more, 98% or more, or 99% or more). In some examples, the nanoporous membrane exhibits a rejection of 99% or more (e.g., 99.1% or more, 99.2% or more, 99.3% or more, 99.4% or more, 99.5% or more, 99.6% or more, 99.7% or more, 99.8% or more, or 99.9% or more). In some examples, the non-target substance comprises a salt and the nanoporous membrane exhibits a rejection of 95% or more (e.g., 97% or more, or 99% or more) for the salt. In some examples, the non-target substance comprises an organic molecule and the nanoporous membrane exhibits a rejection of 99% or more for the organic molecule. In some examples, the non-target substance comprises a biological agent and the nanoporous membrane exhibits a rejection of 99% or more for the biological agent.

The nanoporous membrane can, for example, exhibits a water permeance of 3×10⁻⁷ m³ m⁻² s⁻¹ bar⁻¹ or more (e.g., 4×10⁻⁷ m³ m⁻² s⁻¹ bar⁻¹ or more, 5×10⁻⁷ m³ m⁻² s⁻¹ bar⁻¹ or more, 6×10⁻⁷ m³ m⁻² s⁻¹ bar⁻¹ or more, 7×10⁻⁷ m³ m⁻² s⁻¹ bar⁻¹ or more, 8×10⁻⁷ m³ m⁻² s⁻¹ bar⁻¹ or more, 9×10⁻⁷ m³ m⁻² s⁻¹ bar⁻¹ or more, 10×10⁻⁷ m³ m⁻² s⁻¹ bar⁻¹ or more, 11×10⁻⁷ m³ m⁻² s⁻¹ bar⁻¹ or more, 12×10⁻⁷ m³ m⁻² s⁻¹ bar⁻¹ or more, 13×10⁻⁷ m³ m⁻² s⁻¹ bar⁻¹ or more, 14×10⁻⁷ m³ m⁻² s⁻¹ bar⁻¹ or more, or 15×10⁻⁷ m³ m⁻² s⁻¹ bar⁻¹ or more). In some examples, the nanoporous membrane exhibits a rejection of 95% or more for the non-target substance and a water permeance of 9×10⁻⁷ m³ m⁻² s⁻¹ bar⁻¹ or more.

Also disclosed herein are methods of making the nanoporous membranes disclosed herein. For example, also disclosed herein are methods of making a nanoporous membrane for separating a target substance from a non-target substance in a fluid medium, the methods comprising: making a two-dimensional material permeated by a plurality of pores, wherein the plurality of pores comprises a first population of pores having an average pore diameter and a second population of pores having an average pore diameter, wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; wherein the two-dimensional material has a top surface and a bottom surface with an average thickness therebetween; wherein the plurality of pores traverses the average thickness of the two-dimensional material from the top surface to the bottom surface; and contacting the top surface of the two-dimensional with a first monomer and the bottom surface of the two-dimensional material with a second monomer; wherein the first monomer has an average size that is greater than the average pore diameter of the second population of pores; wherein the second monomer has an average size that is greater than the average pore diameter of the first population of pores and less than or equal to the average pore diameter of the second population of pores; such that interfacial polymerization occurs between the first monomer and the second monomer within the second population of pores; thereby substantially blocking substantially all of the second population of pores with a polymer derived from the first monomer and the second monomer via interfacial polymerization; such that the nanoporous membrane allows for transport of the target substance through the nanoporous membrane via the first population of pores. Making the two-dimensional material permeated by a plurality of pores can, for example, comprise direct growth of the plurality of pores during synthesis of the two-dimensional material; etching the two-dimensional material; or a combination thereof.

For example, also disclosed herein are methods of making a nanoporous membrane for separating a target substance from a non-target substance in a fluid medium, the methods comprising: etching a two-dimensional material such that the two-dimensional material is permeated by a plurality of pores, wherein the plurality of pores comprises a first population of pores having an average pore diameter and a second population of pores having an average pore diameter, wherein the average pore diameter of the first population of pores is greater than or equal to the van der Waals diameter of water and less than the average size of the non-target substance in the fluid medium; wherein the average pore diameter of the second population of pores is greater than or equal to the average size of the non-target substance in the fluid medium; wherein the two-dimensional material has a top surface and a bottom surface with an average thickness therebetween; wherein the plurality of pores traverses the average thickness of the two-dimensional material from the top surface to the bottom surface; and contacting the top surface of the two-dimensional with a first monomer and the bottom surface of the two-dimensional material with a second monomer; wherein the first monomer has an average size that is greater than the average pore diameter of the second population of pores; wherein the second monomer has an average size that is greater than the average pore diameter of the first population of pores and less than or equal to the average pore diameter of the second population of pores; such that interfacial polymerization occurs between the first monomer and the second monomer within the second population of pores; thereby substantially blocking substantially all of the second population of pores with a polymer derived from the first monomer and the second monomer via interfacial polymerization; such that the nanoporous membrane allows for transport of the target substance through the nanoporous membrane via the first population of pores.

In some examples, the interfacial polymerization is size selective interfacial polymerization, e.g. wherein the first population of pores and the second population on pores are both present during the interfacial polymerization and wherein the first monomer has an average size that is greater than the average pore diameter of the second population of pores; wherein the second monomer has an average size that is greater than the average pore diameter of the first population of pores and less than or equal to the average pore diameter of the second population of pores (e.g., such that the first monomer and second monomer are both size excluded from the first population of pores), such that interfacial polymerization occurs between the first monomer and the second monomer within the second population of pores, thereby substantially blocking the second population of pores, while the first population of pores remain unblocked.

In some examples, the methods further comprise making the two-dimensional material. For example, the two-dimensional material can comprise graphene and the method can comprise making the graphene using a chemical vapor deposition (CVD) process, e.g. wherein the CVD process is performed at a low pressure and a temperature of from 300-1000° C.

For example, the CVD process can be performed at a temperature of 300° C. or more (e.g., 350° C. or more, 400° C. or more, 450° C. or more, 500° C. or more, 550° C. or more, 600° C. or more, 650° C. or more, 700° C. or more, 750° C. or more, 800° C. or more, 850° C. or more, 900° C. or more, or 950° C. or more). In some examples, the CVD process can be performed at a temperature of 1000° C. or less (e.g., 950° C. or less, 850° C. or less, 800° C. or less, 750° C. or less, 700° C. or less, 650° C. or less, 600° C. or less, 550° C. or less, 500° C. or less, 450° C. or less, or 400° C. or less). The temperature at which the CVD process is performed can range from any of the minimum values described above to any of the maximum values described above, For example the CVD process can be performed at a temperature of from 300° C. to 1000° C. (e.g., from 300° C. to 650° C., from 650° C. to 1000° C., from 300° C. to 450° C. from 450° C. to 600° C., from 600° C. to 750° C., from 750° C. to 900° C., from 900° C. to 1000° C., from 350° C. to 1000° C., from 300° C. to 950° C., from 350° C. to 950° C., or from 800° C. to 1000° C.).

In some examples, the CVD process can comprise reacting and/or decomposing a precursor, e.g. in the presence of H₂, to form the graphene. The precursor can, for example, comprise a carbon source (e.g., a carbonaceous precursor). Examples of suitable precursors include, but are not limited to, CH₄, C₆H₆, C₂H₂, C₂H₄, C₃H₈, and combinations thereof.

In some examples, the method further comprises an in-situ oxide nanoparticle template processes to form at least a portion of the plurality of pores and/or to form a plurality of precursor pores or defects. In some examples, the method comprises making the two-dimensional material using a roll-to-roll method. For example, the roll-to-roll method can make the two-dimensional material at a speed of 1 cm/min or more (e.g., 2 cm/min or more, 3 cm/min or more, 4 cm/min or more, 5 cm/min or more, or 6 cm/min or more). In some examples, the methods can further comprise transferring the two-dimensional material to a support before etching. For example, the method can comprise making the two-dimensional material using a roll-to-roll method combined with a hierarchical polymer support casting method.

Etching the two-dimensional material can, for example, comprise exposing the two-dimensional material to an etching process for 1 second or more (e.g., 5 seconds or more, 10 seconds or more, 15 seconds or more, 20 seconds or more, 25 seconds or more, 30 seconds or more, 40 seconds or more, 50 seconds or more, 1 minute or more, 2 minutes or more, 3 minutes or more, 4 minutes or more, 5 minutes or more, 10 minutes or more, 15 minutes or more, 20 minutes or more, 25 minutes or more, 30 minutes or more, 40 minutes or more, 50 minutes or more, 1 hour or more, 1.5 hours or more, 2 hours or more, 2.5 hours or more, 3 hours or more, 3.5 hours or more, 4 hours or more, 4.5 hours or more, or 5 hours or more). In some examples, the two-dimensional material can be etched for 6 hours or less (e.g., 5.5 hours or less, 5 hours or less, 4.5 hours or less, 4 hours or less, 3.5 hours or less, 3 hours or less, 2.5 hours or less, 2 hours or less, 1.5 hours or less, 1 hour or less, 50 minutes or less, 40 minutes or less, 30 minutes or less, 25 minutes or less, 20 minutes or less, 15 minutes or less, 10 minutes or less, 5 minutes or less, 4 minutes or less, 3 minutes or less, 2 minutes or less, 1 minute or less, 50 seconds or less, 40 seconds or less, 30 seconds or less, 25 seconds or less, 20 seconds or less, 15 seconds or less, 10 seconds or less, or 5 seconds or less). The amount of time that the tow-dimensional material is etched can range from any of the minimum values described above to any of the maximum values described above. For example, the two-dimensional material can be etched for from 1 second to 6 hours (e.g., from 1 second to 1 minute, from 1 minute to 1 hour, from 1 hour to 6 hours, from 1 second to 1 hour, or from 5 minutes to 30 minutes). The duration of the etching of the two-dimensional material can, for example, be selected in view of the identity of the two-dimensional material, the thickness of the two-dimensional material, the desired average pore size of the first population of pores, the desired average pore size of the second population of pores, the number of pores within the first population of pores, the number of pores within the second population of pores, the type of etching performed, or a combination thereof.

In some examples, etching the two-dimensional material can comprise UV-ozone induced etching; plasma bombardment (e.g., oxygen plasma, Ar plasma, air plasma); ion beam bombardment; etching via energetic ions; etching via nanoparticles; or a combination thereof.

In some examples, etching the two-dimensional material can comprise UV-ozone induced etching. In some examples, the two-dimensional material can be UV-ozone etched for 5 minutes to 30 minutes. In some examples, the concentration of ozone used in the UV-ozone etching can be 1% or more (e.g., 5% or more, 10% or more, 15% or more, 20% or more, 25% or more, 30% or more, 35% or more, 40% or more, 45% or more, 50% or more, 55% or more, 60% or more, 65% or more, 70% or more, 75% or more, 80% or more, 85% or more, or 90% or more). In some examples, the concentration of ozone used in the UV-ozone etching can be 100% or less (e.g., 95% or less, 90% or less, 85% or less, 80% or less, 75% or less, 70% or less, 65% or less, 60% or less, 55% or less, 50% or less, 45% or less, 40% or less, 35% or less, 30% or less, 25% or less, 20% or less, 15% or less, 10% or less, or 5% or less). In some examples, the duration of the UV-ozone etching, the concentration of the ozone used in the UV-ozone etching, the intensity of the UV light used in the UV-ozone etching, or a combination thereof can, for example, be selected in view of the identity of the two-dimensional material, the thickness of the two-dimensional material, the desired average pore size of the first population of pores, the desired average pore size of the second population of pores, the number of pores within the first population of pores, the number of pores within the second population of pores, or a combination thereof.

The methods described herein can selectively seal specific nanopore sizes by selecting different monomer species for interfacial polymerization. For example, the first monomer and the second monomer can be selected to selectively seal the second population of pores and/or the defects. In some examples, the identity of the first monomer, the identity of the second monomer, the time duration of the interfacial polymerization, the concentration of the first monomer, the concentration of the second monomer, or a combination thereof can, for example, be selected in view of the thickness of the two-dimensional material, the average pore size of the first population of pores, the average pore size of the second population of pores, the number of pores within the first population of pores, the number of pores within the second population of pores, or a combination thereof.

Also disclosed herein are nanoporous membranes made by the methods described herein.

Also disclosed herein are methods of use of the nanoporous membranes described herein. For example, the nanoporous membranes described herein can be used in a separation to separate the target substance from the non-target substance in the fluid medium.

In some examples, the method can comprise using the nanoporous membrane for water purification, gas purification, environmental remediation, or a combination thereof. In some examples, the method can comprise using the nanoporous membrane for water desalination.

In some examples, the method can comprise using the nanoporous membrane for water purification, e.g., wherein the target substance comprises water and the non-target substance comprises an organic molecule, an inorganic contaminant (e.g., a salt, heavy metal, etc.), a biological agent, or a combination thereof.

For example, the method can comprise purifying a contaminated aqueous solution by contacting the contaminated aqueous solution with the nanoporous membrane to separate the non-target substance (e.g., contaminants) from the target substance (e.g., water). For example, the contaminated aqueous solution can comprise hard water, hard brine, sea water, brackish water, fresh water, flowback or produced water, wastewater (e.g., reclaimed, recycled, fracking wastewater, etc.), river water, lake or pond water, aquifer water, brine (e.g. reservoir or synthetic brine), slickwater, or a combination thereof.

In some examples, the separation can comprise a pressure driven separation. In some examples, the pressure driven separation can be performed at a pressure of 1 bar or more (e.g., 2 bar or more, 3 bar or more, 4 bar or more, 5 bar or more, 10 bar or more, 15 bar or more, 20 bar or more, 25 bar or more, 30 bar or more, 35 bar or more, 40 bar or more, 45 bar or more, 50 bar or more, 60 bar or more, 70 bar or more, or 80 bar or more). In some examples, the pressure driven separation can be performed at a pressure of 100 bar or less (e.g., 90 bar or less, 80 bar or less, 70 bar or less, 60 bar or less, 50 bar or less, 45 bar or less, 40 bar or less, 35 bar or less, 30 bar or less, 25 bar or less, 20 bar or less, 15 bar or less, 10 bar or less, or 5 bar or less). The pressure at which the pressure driven separation is performed can range from any of the minimum values described above to any of the maximum values described above. For example, the pressure driven separation can be performed at a pressure of from 1 bar to 100 bar (e.g., from 1 bar to 50 bar, from 50 bar to 100 bar, from 1 bar to 20 bar, from 20 bar to 40 bar, from 40 bar to 60 bar, from 60 bar to 80 bar, from 80 bar to 100 bar, from 10 bar to 100 bar, from 1 bar to 90 bar, from 10 bar to 90 bar, from 1 bar to 80 bar, from 1 bar to 60 bar, from 1 bar to 30 bar, or from 10 bar to 30 bar).

The nanoporous membranes described herein can be used, for example, in a variety of respiration and filter applications, for example for military and/or industrial uses, e.g. wherein the nanoporous membrane filters out a pathogen (e.g., bacteria, virus, fungi, parasite, protozoa, etc.), an organic molecule, a chemical or biological warfare agent, or a combination thereof. In some examples, the nanoporous membranes can be used in gas mask filters, respirators, collective filters, etc. The nanoporous membranes can also be used in other personal protection devices, e.g., with a fabric. For example, a fabric comprising the nanoporous membranes disclosed herein can be formed into protective clothing, e.g., coats, pants, suits, gloves, foot coverings, head coverings, face shields, breathing scarfs. The personal protective devices, such as respirators, filters, protective clothing, etc. are suitable for use by a subject in need of protection, such as a human, a service animal, a working animal (e.g., a law-enforcement animal, a cadaver animal, a search-and-rescue animal, a military animal, a detection animal, etc.), and the like. Suitable fabrics that can be combined with the disclosed nanoporous membranes include, but are not limited to, cotton, polyester, nylon, rayon, wool, silk, and the like.

The nanoporous membranes described herein can be used, for example, as a proton exchange membrane, as an ion exchange membrane, as a hydrogen separation membrane, or a combination thereof. In some examples, the nanoporous membranes can be used as proton transport membranes, e.g., wherein the target substance comprises protons (e.g., He).

In some examples, the nanoporous membranes described herein can be used in a fuel cell, an electrolytic cell, a proton exchange electrolyzer, or a battery. In some examples, the method comprises using the nanoporous membranes as the proton exchange membrane in a proton exchange membrane fuel cell (PEMFC). In some examples, the method comprises using the nanoporous membranes as the separator in a battery.

Also disclosed herein are articles of manufacture comprising the nanoporous membranes described herein. For example, also disclosed herein are filters comprising any of the nanoporous membranes described herein. Also disclosed herein are respirators comprising the filters described herein. Also disclosed herein are gas masks comprising the filters described herein. Also disclosed herein are personal protection devices comprising any of the nanoporous membranes described herein. For example, the personal protection devices can further comprise a material, such as a fabric. The personal protection device can, for example, comprise a mask, a respiratory system, an over-garment, a glove, a boot, or a combination thereof. In some examples, the personal protection device can provide protection from exposure to harmful chemical and/or biological agents and exhibits increased breathability. The personal protection device can, for example, be utilized by a subject in need of protection, such as a human, a service animal, a working animal (e.g., a law-enforcement animal, a cadaver animal, a search-and-rescue animal, a military animal, a detection animal, etc.), and the like.

The nanoporous membranes, filters, respirators, gas masks, and/or personal protection devices described herein can, for example, be used for military, homeland security, first responder, civilian, and/or industrial applications.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Facile Size-Selective Defect Sealing in Large-Area Atomically Thin Graphene Membranes for Sub-Nanometer Scale Separations

ABSTRACT: Atomically thin graphene with a high-density of precise sub-nanometer pores represents an ideal membrane for ionic and molecular separations. However, a single large-nanopore can severely compromise membrane performance and differential etching between pre-existing defects/grain boundaries in graphene and pristine regions presents fundamental limitations. Herein, it is show, for the first time that size-selective interfacial polymerization after high-density nanopore formation in graphene not only seals larger defects (>0.5 nm) and macroscopic tears but also successfully preserves the smaller sub-nanometer pores. Low-temperature growth followed by mild UV/ozone oxidation allows for facile and scalable formation of high-density (4-5.5×10¹² cm⁻²) useful sub-nanometer pores in the graphene lattice. Scalable synthesis of fully functional centimeter-scale nanoporous atomically thin membranes (NATMs) with water (˜0.28 nm) permeance ˜23× higher than commercially available membranes and excellent rejection to salt ions (˜0.66 nm, >97% rejection) as well as small organic molecules (˜0.7-1.5 nm, ˜100% rejection) under forward osmosis is demonstrated.

Introduction. Sub-nanometer scale separations are widely used across a range of chemical, biomedical, and industrial applications, for example, ionic and molecular separations via dialysis, nanofiltration, desalination, chemical and pharmaceutical purification, and beyond. Atomically thin 2D materials, such as graphene, with atomic thinness, high mechanical strength (Cohen-Tanugi D et al. Nano Lett. 2014, 14(11), 6171-6178; Wang L et al. Nano Lett. 2017, 17(5), 3081-3088), and chemical robustness (Prozorovska L et al. Adv. Mater. 2018, 30(52), 1801179; Wang L et al. Nat. Nanotechnol. 2017, 12(6), 509-522), represent ideal membrane materials to revolutionize sub-nanometer scale separations. Although pristine graphene is impermeable even to helium atoms (Bunch J S et al. Nano Lett. 2008, 8(8), 2458-2462), the introduction of precise high-density sub-nanometer pores in the graphene lattice can enable the formation of nanoporous atomically thin membranes (NATMs) with very high solvent flux (Celebi K et al. Science 2014, 344(6181), 289-292) (due to atomic thinness) while efficiently rejecting ions and solute molecules via molecular sieving (Prozorovska L et al. Adv. Mater. 2018, 30(52), 1801179; Wang L et al. Nat. Nanotechnol. 2017, 12(6), 509-522; Yang Y et al. Science 2019, 364(6445), 1057-1062). However, even a single large defect in the graphene lattice over centimeter-scale areas can severely compromise nanoporous atomically thin membrane performance via non-selective leakage (Prozorovska L et al. Adv. Mater. 2018, 30(52), 1801179; Wang L et al. Nat. Nanotechnol. 2017, 12(6), 509-522; Yang Y et al. Science 2019, 364(6445), 1057-1062). Forming precise sub-nanometer pores over large areas with a high density remains nontrivial and extremely challenging due to differential etching between pre-existing defects/grain boundaries and pristine regions (Prozorovska L et al. Adv. Mater. 2018, 30(52), 1801179; Wang L et al. Nat. Nanotechnol. 2017, 12(6), 509-522; Yang Y et al. Science 2019, 364(6445), 1057-1062).

Some studies have demonstrated graphene nanoporous atomically thin membranes for ionic/molecular transport (O'Hern S C et al. ACS Nano 2012, 6(11), 10130-10138; O'Hern S C et al. Nano Lett. 2014, 14(3), 1234-1241; Kidambi P R et al. Adv. Mater. 2017, 29(33), 1700277; Kidambi P R et al. Adv. Mater. 2018, 30(49), 1804977), gas separation (Huang S et al. Nat. Commun. 2018, 9(1), 2632; He G et al. Energy Environ. Sci. 2019, 12, 3305-3312; Boutilier M S H et al. ACS Nano 2017, 11(6), 5726-5736), nanofiltration (Yang Y et al. Science 2019, 364(6445), 1057-1062; O'Hern S C et al. Nano Lett. 2015, 15(5), 3254-3260; Jang D et al. ACS Nano 2017, 11(10), 10042-10052), and desalination (Yang Y et al. Science 2019, 364(6445), 1057-1062; Jang D et al. ACS Nano 2017, 11(10), 10042-10052). For example, Surwade et al. used oxygen plasma to introduce nanopores (˜10¹² cm⁻²) in ˜5 μm diameter monolayer graphene membranes and reported salt rejection during pervaporation of water (˜1×10⁶ gm⁻² s⁻¹, only one side of graphene was wetted) at 40° C. (Surwade S P et al. Nat. Nanotechnol. 2015, 10(5), 459-464; US 2016/0207798). Celebi et al. also reported water vapor transport through ˜7.6-50 nm pores in graphene membranes but noted that capillarity prevented water transport when only one side of the membrane was wetted (Celebi K et al. Science 2014, 344(6181), 289-292). O'Hern et al. transferred centimeter-scale graphene onto polycarbonate track etched (PCTE) supports and used a two-step procedure to seal nanoscale defects (via ALD of HfO₂) as well as large tears (via interfacial polymerization) (O'Hern S C et al. Nano Lett. 2015, 15(5), 3254-3260). Subsequently, Ga ion bombardment to nucleate defects/nanopores followed by pore enlargement via oxidative etching allowed for nanofiltration of salts and small molecules (O'Hern S C et al. Nano Lett. 2015, 15(5), 3254-3260; Jang D et al. ACS Nano 2017, 11(10), 10042-10052). However, nanopore creation via ion/electron bombardments in a microscope limits scalability. Recently, Yang et al. used a carbon-nanotube mesh to support monolayer CVD graphene and further deposited a mesoporous silica layer on the other side of graphene and used it as a mask to etch sub-nanometer pores via oxygen plasma (Yang Y et al. Science 2019, 364(6445), 1057-1062). Their membranes showed high water transport (>20 L m⁻² h⁻¹ bar⁻¹), while blocking solute ions and the carbon-nanotube mesh provided adequate mechanical strength (Yang Y et al. Science 2019, 364(6445), 1057-1062). However, the multistep processing and the use of a mesoporous SiO₂ mask and carbon nanotube mesh support only allow for limited scalability. Hence, the formation of high density, precise, sub-nanometer pores (0.28-0.66 nm) over large areas using facile and scalable processes remains an unresolved problem that fundamentally limits nanoporous atomically thin membranes (Prozorovska L et al. Adv. Mater. 2018, 30(52), 1801179; Wang L et al. Nat. Nanotechnol. 2017, 12(6), 509-522; Yang Y et al. Science 2019, 364(6445), 1057-1062).

Here, scalable fabrication of fully functional graphene nanoporous atomically thin membranes for ionic and molecular separations via size-selective interfacial polymerization after facile formation of high-density (4-5.5×10¹² cm⁻²) nanopores via low-temperature chemical vapor deposition (CVD) growth followed by mild UV/ozone oxidation is reported.

Experimental Section

Graphene Growth. Graphene growth on Cu foil (purity 99.9%, thickness 18 m, JX Holding HA) was performed using Low-Pressure Chemical Vapor Deposition (LPCVD) as described in detail elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378). Briefly, the Cu foil was cleaned via sonication in 15% nitric acid, followed by rinsing in DI water to remove surface contaminants and dried in laboratory nitrogen. Next, it was loaded into in a hot-walled tube furnace and annealed at 1050° C. for 60 min under 60 sccm H₂ (˜1.14 Torr) and cooled to graphene growth temperature. Nanoporous graphene (NG) growth temperature was ˜900° C. and high quality graphene (G) growth temperature was ˜1050° C. Graphene growth was initiated by adding 3.5 sccm of CH₄ (˜2.7 Torr) for 30 min and 7 sccm CH₄ (˜3.6 Torr) for 30 min to the 60 sccm H₂. Post growth the foil was quench-cooled in the growth atmosphere.

Graphene Transfer

Transfer to PCTE Supports: Graphene transfer to polycarbonate track etched (PCTE) supports (˜10% porosity, 10 μm thick, free of PVP coating, hydrophobic, 200 nm cylindrical pores, Sterlitech Inc.) was performed as described elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378). A short pre-etch in ammonium persulfate solution (0.1 M) for 30 min was used to remove graphene on the bottom side of the Cu foil followed by rinsing in DI water for 10 min. Next, graphene on the top side of the Cu foil was pressed against the polycarbonate track etched membrane and the Cu foil was etched in 0.1 M ammonium persulfate solution. Finally, the polycarbonate track etched membrane+graphene was rinsed with DI water to remove residual ammonium persulfate, followed by rinsing in ethanol and dried.

Transfer to TEM Grids: Graphene transfer to TEM grids (Ted Pella Inc. 658-200-AU with 1.2 μm holes) was performed based on the method reported elsewhere with some modifications (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378; Au-Hauwiller M R et al. JoVE 2018, No. 135, e57665; Regan W et al. Appl. Phys. Lett. 2010, 96 (11), 113102; Park J et al. Science 2015, 349 (6245), 290; O'Hern S C et al. Nano Lett. 2015, 15 (5), 3254-3260; O'Hern S C et al. Nano Lett. 2014, 14 (3), 1234-1241). First, graphene on the bottom side of Cu foil was removed as described above. Next, the TEM grid was placed onto the graphene on Cu foil such that the Quantifoil carbon film was contacting graphene. Isopropyl alcohol (IPA, 10 μL) was then added onto the stack and the interface between graphene and the grid was allowed to wet. The stack was dried for 2 h and annealed at 80° C. on a hotplate for 30 min. Finally, the Cu foil was etched in an ammonium persulfate solution (0.1 M). The TEM grids were rinsed thoroughly in DI water baths followed by IPA and then dried in air.

Transfer to silicon wafer for Raman spectroscopy: Graphene transfer to 300 nm/SiO₂ wafers was performed via drop casting ˜2% polymethyl methacrylate (PMMA) in anisole on to graphene on Cu foil (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378). The Cu foil was subsequently etched as describe above and the PMMA-graphene stack was rinsed in water before being transferred to wafers (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378). After drying, the PMMA was dissolved in acetone followed by cleaning in IPA.

UV/ozone Treatment. UV/ozone etching was performed in a UV/ozone cleaner (Jelight Model 30) for 5-30 min to introduce defects and enlarge pores in graphene.

Interfacial Polymerization (IP). Interfacial polymerization was performed as described in detail elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378; Zhang Y et al. Lab 5 Chip 2015, 15 (2), 575-580; Dalwani M et al. J. Mater. Chem. 2012, 22 (30), 14835-14838). Initially, the UV/ozone treated polycarbonate track etched membrane+graphene stack was annealed on a hot plate at 100-105° C. for 12 hours. Interfacial polymerization was performed in a Franz cell (PermeGear, Inc.) with a 0.9 cm diameter orifice using 0.4 g of octa-ammonium-polyhedral-oligomeric-silsesquioxane (POSS, Hybrid Plastics, AM0285) in 20 mL DI water (pH 10.7 by adding 0.1 M NaOH) and 0.035 g of trimesoyl-chloride (TMC, Alfa Aesar, 4422-95-1) in 10 mL hexane for 60 mins. Specifically, nanoporous graphene (NG) on a polycarbonate track etched membrane after UV/ozone etching was sandwiched between two monomers a) polyhedral oligomeric silsesquioxane in an aqueous solution and b) trimesoyl chloride in hexane. Polyhedral oligomeric silsesquioxane and trimesoyl chloride are only expected to contact each other and polymerize at large tears and/or large defects, forming polyhedral-oligomeric-silsesquioxane-polyamide (POSS-PA) plugs/seals (Dalwani M et al. J. Mater. Chem. 2012, 22 (30), 14835-14838; Duan J et al. J. Memb. Sci. 2015, 473, 157-164). Post interfacial polymerization, the membranes were rinsed with hexane on the trimesoyl chloride side, unclamped, and rinsed in ethanol. The graphene region subjected to size-selective defect sealing via interfacial polymerization can be identified by the circular clamp edge (dashed line in last panel of FIG. 2).

Characterization. SEM images of graphene on polycarbonate track etched membranes were obtained using a Zeiss Merlin Scanning Electron Microscope with Gemini II Column operated at 2-5 kV.

Raman spectra were recorded with a Thermo Scientific DXR Confocal Raman microscope with a 532 nm laser source.

STEM images were acquired using the Nion UltraSTEM 100 aberration-corrected scanning transmission electron microscope, operated at 60 kV at the Center for Nanophase Materials Sciences at Oak Ridge National Laboratory. The STEM samples were annealed at 160° C. in vacuum for 12 hours before imaging (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378).

The area (A) of every imaged nanopore was determined from the micrographs and converted into an effective diameter by (Cohen-Tanugi D et al. Nano Lett. 2012, 12 (7), 3602-3608):

dₚₒᵣₑ=\sqrt{4A/π}

The pore density was estimated by dividing the total number of pores imaged by the total area of all images acquired.

STM images were acquired using the Omicron variable temperature scanning tunneling microscope (VT-STM) at room temperature in the Center for Nanophase Materials Sciences at Oak Ridge National Laboratory. The samples were annealed in vacuum at 420° C. for 3 h prior to imaging (Kidambi P R et al. Adv. Mater. 2018, 30 (49), 1804977).

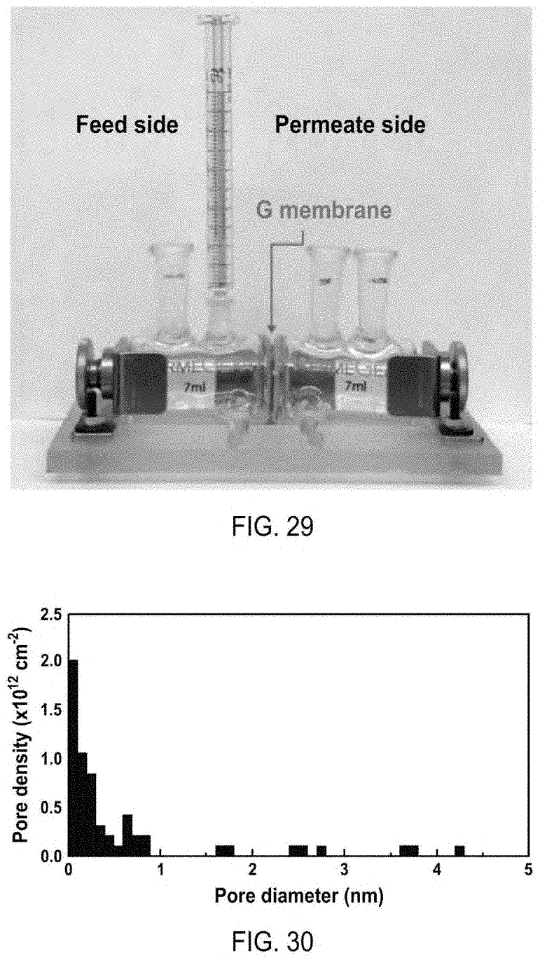

Experimental Setup for Transport Measurements. Water and solute transport measurements were performed as described in detail elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378; O'Hern S C et al. Nano Lett. 2015, 15 (5), 3254-3260; O'Hern S C et al. Nano Lett. 2014, 14 (3), 1234-1241; O'Hern S C et al. ACS Nano 2012, 6 (11), 10130-10138). Briefly, a customized 7 mL side-by-side glass diffusion cell (PermeGear, Inc., 5 mm orifice) was used for transport measurements (FIG. 29). A 250 μL gastight syringe (Hamilton 1725 Luer Tip) was inserted into the short open port of left diffusion cell, sealed with epoxy and dried for 24 h to obtain leak-free connection. The membrane was installed between two diffusion cells with graphene side facing towards syringe side, followed by clamping the whole system. Before each measurement, the system was washed with ethanol three times and then with DI water five times. During the measurement, the liquid in both cells were vigorously stirred with magnetic Teflon coated stir bars to minimize concentration polarization.

Solute Diffusion Measurements. The diffusion-driven solute transport measurements across different membranes were performed as reported in detail elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378; O'Hern S C et al. Nano Lett. 2015, 15 (5), 3254-3260; O'Hern S C et al. Nano Lett. 2014, 14 (3), 1234-1241; O'Hern S C et al. ACS Nano 2012, 6 (11), 10130-10138). For measuring diffusion-driven transport of KCl (Fisher Chemical, 7447-40-7) and NaCl (Fisher Chemical, 7647-14-5), 0.5 M of salt solution in DI water was filled into the left cell (feed side) and DI water was filled into the right cell (permeate side). A Mettler Toledo SevenCompact S230 conductivity meter immersed in the permeate side was used measure the conductivity rise every 15 s for 15 min. For measuring diffusion-driven transport of L-tryptophan (VWR, 73-22-3) and Vitamin B12 (Sigma-Aldrich, 68-19-9), 1 mM of organic molecule solution in 0.5 M KCl was filled into the left cell and 0.5 M KCl solution was filled into the right cell. A fiber optic dip probe attached to an Agilent Cary 60 UV-vis Spectrophotometer was immersed in the permeate side to measure the change of absorbance spectrum in the range of 190 nm to 1100 nm every 15 s for 40 min. UV-vis intensity differences between 710 nm for DI water (reference wavelength) and L-tryptophan (279 nm) and Vitamin B12 (360 nm), respectively, were used to compute solute concentrations from UV-vis spectra. The solutes were introduced on the graphene side with stirring to ensure minimal concentration polarization. The flow rate of each solute was measured via the slope of concentration change in the permeate side, and the normalized flux was obtained by calculating the slope ratio of fabricated membrane over polycarbonate track etched support membrane.

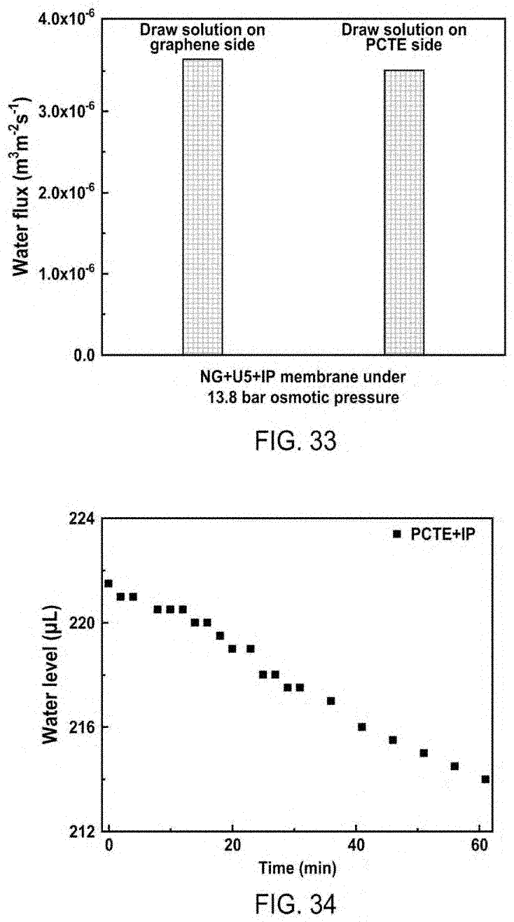

Water Transport Measurements. The osmotic pressure-driven water transport measurements were performed with DI water as the feed solution and glycerol ethoxylate (Sigma-Aldrich, 31694-55-0, average molecular weight Mn ˜1,000) as the draw solution as described in detail elsewhere (Kidambi P R et al. Nanoscale 2017, 9 (24), 8496-8507; Kidambi P R et al. Adv. Mater. 2018, 30 (49), 1804977; Kidambi P R et al. Adv. Mater. 2017, 29 (33), 1700277; Kidambi P R et al. ACS Appl. Mater. Interfaces 2018, 10 (12), 10369-10378; O'Hern S C et al. Nano Lett. 2015, 15 (5), 3254-3260; O'Hern S C et al. Nano Lett. 2014, 14 (3), 1234-1241; O'Hern S C et al. ACS Nano 2012, 6 (11), 10130-10138). The feed side was filled with 8 mL of DI water and then sealed by a rubber plug (the water level in the syringe rises); while the permeate side was filled with 8 mL of 10-30 wt % glycerol ethoxylate solution, thereby creating ˜4-26 bar osmotic pressure difference across the nanoporous atomically thin membranes. Osmotic pressure-driven water transport from the feed side to the permeate side resulted in a drop of water meniscus level along the syringe. Generally, water was introduced on the graphene side with stirring to ensure minimal concentration polarization. Water was also introduced on the polycarbonate track etched support instead of graphene side to compare the water flux results (FIG. 33). Depending on which side the draw solution was placed, a rise/drop of water meniscus level along the graduated syringe was recorded with a digital camera.

Water flux was calculated by the following equation (O'Hern S C et al. Nano Lett. 2015, 15 (5), 3254-3260):

$${j}_{water} = \frac{Δ V}{( A \times γ \times Δ t )}$$

where ΔV is the change of volume along the graduated syringe, A is the orifice area of the side-by-side glass diffusion cell, y is the polycarbonate track etch porosity (9.4%), and Δt is the measurement time (O'Hern S C et al. Nano Lett. 2015, 15 (5), 3254-3260).

The expected osmotic pressure from glycerol ethoxylate solution was calculated using the following relation (O'Hern S C et al. Nano Lett. 2015, 15 (5), 3254-3260):

log ΔΠ=4.87+0.8×(wt %)^{0.34}

where ΔΠ is the osmotic pressure with the units of dyne/cm². Water permeance was obtained by dividing representative water flux by corresponding osmotic pressures.

Solute Transport Measurements. Osmotic pressure-driven salt transport measurements were carried out with salt solution on the feed side and glycerol ethoxylate solution on permeate side as described in detail elsewhere (O'Hern S C et al. Nano Lett. 2015, 15 (5), 3254-3260). The feed side was filled with 8 mL of KCl or NaCl solution (16.6 mM) and then sealed with a rubber plug, while the permeate side was filled with 7.8 mL of 26.47 wt % glycerol ethoxylate solution. Specifically, the solutes were introduced on the graphene side with stirring to ensure minimal concentration polarization. The electrode of a Mettler Toledo SevenCompact S230 conductivity meter was immersed in the permeate side and the conductivity rise was measured every 15 s. Osmotic pressure-driven organic molecule transport was performed with organic molecule solution (1.3 mM L-tryptophan or Vitamin B12 solution, 8 mL) on the feed side and glycerol ethoxylate solution (26.47 wt %, 8 mL) on the permeate side. The measuring procedure for the organic molecule transport was the same as for the salt transport measurements. A fiber optic dip probe attached to an Agilent Cary 60 UV-vis Spectrophotometer was immersed in the permeate side to measure the change of absorbance spectrum in the range of 190 nm to 1100 nm every 15 s.

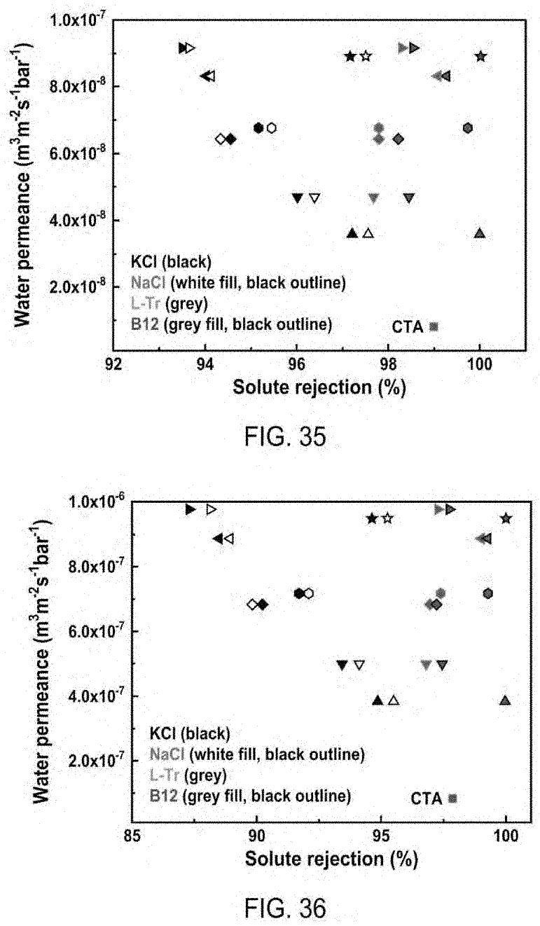

The solute transport experiments were performed for 24 h, and the solute rejection was calculated by the following equation (Yang Y et al. Science 2019, 364 (6445), 1057-1062):

$${S}_{rejection} = ( 1 - \frac{{C}_{p}}{{C}_{f}} ) \times 100 \%$$

where S_{rejection} is the solute rejection, Cₚ is the solute concentration on permeate side after 24 h, C_{f} is the initial solute concentration on feed side (Yang Y et al. Science 2019, 364 (6445), 1057-1062). Solute rejection was also calculated using the equation:

$${S}_{rejection} = ( 1 - \frac{{j}_{s olute} / {j}_{water}}{{C}_{f}} ) \times 100 \%$$

where jₛₒₗᵤₜₑ and j_{water} are solute flux and water flux, respectively (FIG. 35-FIG. 36) (O'Hern S C et al. Nano Lett. 2015, 15 (5), 3254-3260).

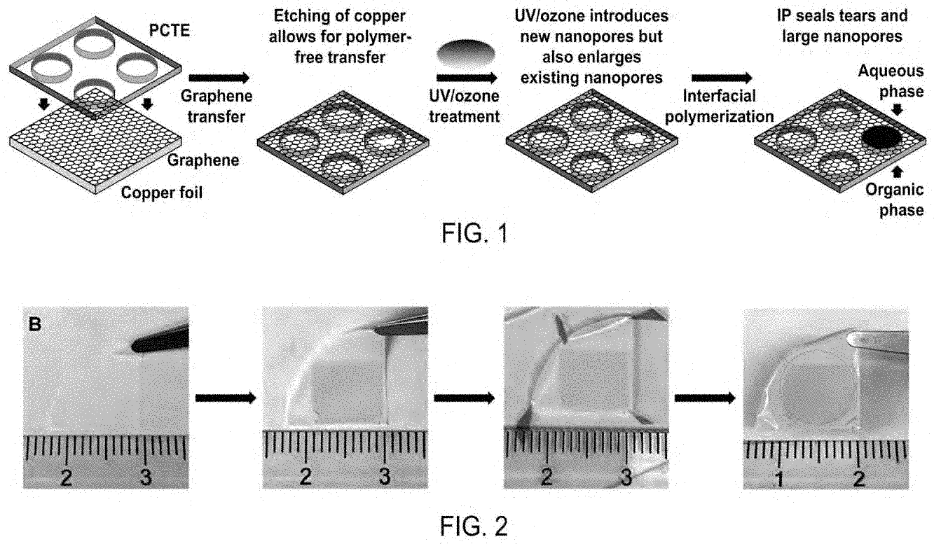

Results and Discussion. A schematic of the fabrication of graphene nanoporous atomically thin membranes for ionic and molecular separations via size-selective interfacial polymerization after formation of high-density (4-5.5×10¹² cm⁻²) nanopores via low-temperature chemical vapor deposition (CVD) growth followed by mild UV/ozone oxidation is shown in FIG. 1. CVD graphene grown at ˜900° C. was specifically chosen based on extensive prior work that evidenced the formation of sub-nanometer pores in the graphene lattice (Kidambi P R et al. Adv. Mater. 2018, 30(49), 1804977; Kidambi P R et al. J. Phys. Chem. C 2012, 116(42), 22492-22501; Kidambi P R et al. Nanoscale 2017, 9(24), 8496-8507). The CVD graphene was transferred onto polycarbonate track etched (PCTE) supports with ˜200 nm pores via a polymer-free transfer to ensure minimal surface contamination (O'Hern S C et al. ACS Nano 2012, 6(11), 10130-10138; O'Hern S C et al. Nano Lett. 2014, 14(3), 1234-1241; Kidambi P R et al. Adv. Mater. 2017, 29(33), 1700277; Kidambi P R et al. Adv. Mater. 2018, 30(49), 1804977; O'Hern S C et al. Nano Lett. 2015, 15(5), 3254-3260; Kidambi P R et al. Nanoscale 2017, 9(24), 8496-8507; Kidambi P R et al. Adv. Mater. 2017, 29(19), 1605896). Subsequently, mild etching conditions of UV/ozone exposure were used to enlarge existing defects in graphene as well as introduce additional nanopores in the graphene lattice (Wang L et al. Nat. Nanotechnol. 2015, 10(9), 785-790; Koenig S P et al. Nat. Nanotechnol. 2012, 7(11), 728-732). Finally, facile size-selective interfacial polymerization (IP) with octa-ammonium polyhedral-oligomeric-silsesquioxane (POSS, ˜0.5 nm cage size)30 and trimesoyl chloride (TMC) was used to selectively seal tears and large nanopores (>0.5 nm) in graphene (Kidambi P R et al. Adv. Mater. 2017, 29(33), 1700277; O'Hern S C et al. Nano Lett. 2015, 15(5), 3254-3260; Kidambi P R et al. ACS Appl. Mater. Interfaces 2018, 10(12), 10369-10378; Dalwani M et al. J. Mater. Chem. 2012, 22(30), 14835-14838; Zhang Y et al. Lab Chip 2015, 15(2), 575-580).

FIG. 2 shows the optical images of different membranes at each corresponding step. The color of original polycarbonate track etched support is white. After transferring monolayer graphene to polycarbonate track etched support, the membrane exhibits a dark square region corresponding to graphene. The whole membrane becomes light yellow when treated by UV-ozone, but the graphene region is still clear comparing with the lighter surrounding polycarbonate track etched area. The membrane region subjected to interfacial polymerization process can be identified by the circle clamp edge (represented by dashed line).

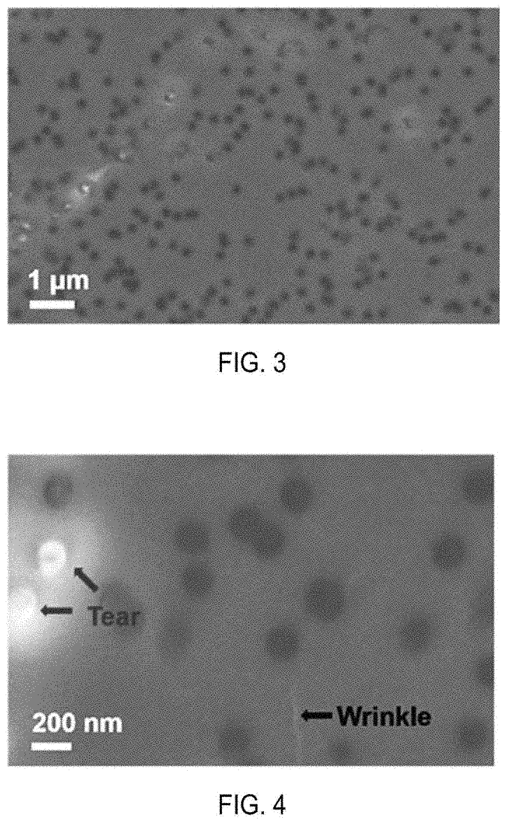

Scanning electron microscopy (SEM) images further confirm successful transfer of graphene onto polycarbonate track etched support (FIG. 3, FIG. 4). The ˜200 nm polycarbonate track etched support pores covered with suspended graphene appear darker due to graphene's electrical conductivity, while uncovered polycarbonate track etched pores (arrows) underneath tears inevitably introduced during transfer and handling appear bright due to polymer charging during SEM imaging (FIG. 3, FIG. 4) (Kidambi P R et al. Adv. Mater. 2017, 29(33), 1700277; Kidambi P R et al. Adv. Mater. 2018, 30(49), 1804977; O'Hern S C et al. Nano Lett. 2015, 15(5), 3254-3260; Kidambi P R et al. Nanoscale 2017, 9(24), 8496-8507; Kidambi P R et al. Adv. Mater. 2017, 29(19), 1605896).

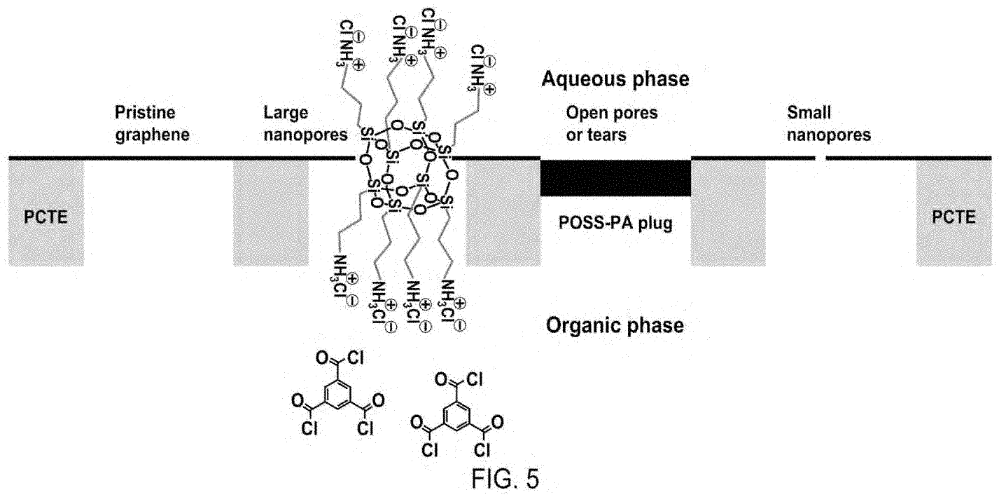

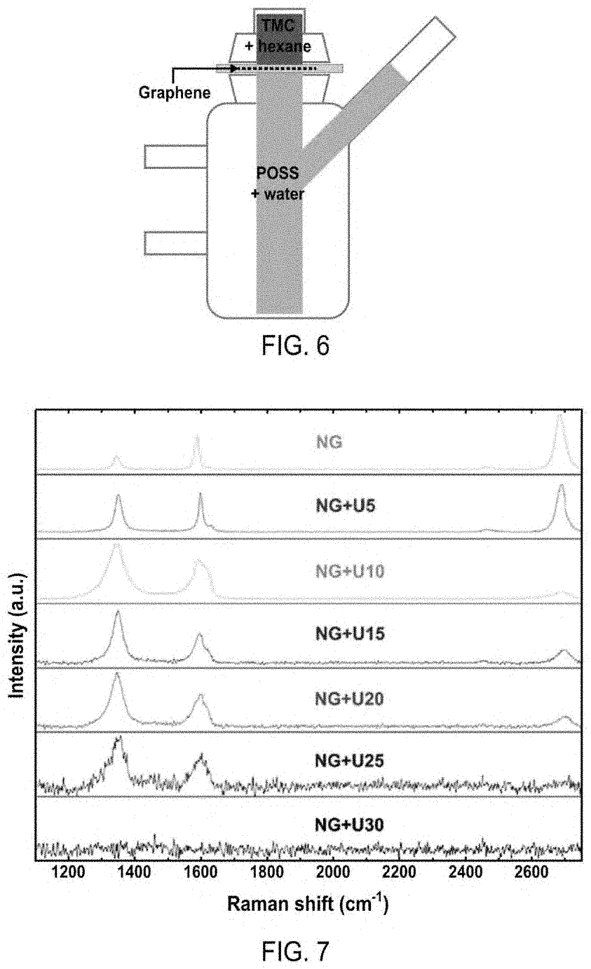

To seal such open polycarbonate track etched support pores/tears in graphene and nanopores >0.5 nm in graphene after transfer to polycarbonate track etched supports and UV/ozone etching, interfacial polymerization with polyhedral oligomeric silsesquioxane and trimesoyl chloride was performed (FIG. 5) (Dalwani M et al. J. Mater. Chem. 2012, 22(30), 14835-14838; Duan J et al. J. Membr. Sci. 2015, 473, 157-164). FIG. 6 shows the schematic of setup used for interfacial polymerization process: graphene transferred on a polycarbonate track etched support (graphene side facing down) was sandwiched between polyhedral oligomeric silsesquioxane solution in DI water (bottom cell) and trimesoyl chloride solution in hexane (top cell). Because trimesoyl chloride is soluble in hexane but decomposes in water, and polyhedral oligomeric silsesquioxane is soluble in water but insoluble in hexane (Dalwani M et al. J. Mater. Chem. 2012, 22(30), 14835-14838; Duan J et al. J. Membr. Sci. 2015, 473, 157-164), the polyhedral oligomeric silsesquioxane molecules have to diffuse into hexane to react with trimesoyl chloride (Dalwani M et al. J. Mater. Chem. 2012, 22(30), 14835-14838; Duan J et al. J. Membr. Sci. 2015, 473, 157-164), that is, the interface for polymerization is pinned within the organic phase (within the polycarbonate track etched support pores) (O'Hern S C et al. Nano Lett. 2015, 15(5), 3254-3260). Further, the transport of polyhedral oligomeric silsesquioxane (˜0.5-1.8 nm) is sterically hindered through nanopores <0.5 nm in graphene, because the shortest dimension of polyhedral oligomeric silsesquioxane is ˜0.5 nm (cage size, albeit the longest dimension of polyhedral oligomeric silsesquioxane is ˜1.8 nm) (Dalwani M et al. J. Mater. Chem. 2012, 22(30), 14835-14838; Duan J et al. J. Membr. Sci. 2015, 473, 157-164). Hence, it was hypothesized that (i) small nanopores in graphene (<0.5 nm) would remain intact, (ii) nanopores in the range of 0.5-1.8 nm would be partially sealed, and (iii) large nanopores (>1.8 nm), tears, and open pores would be completely sealed via polyhedral oligomeric silsesquioxane-polyamide (Dalwani M et al. J. Mater. Chem. 2012, 22(30), 14835-14838; Duan J et al. J. Membr. Sci. 2015, 473, 157-164). Considering the van der Waals diameter of water is ˜0.28 nm, and the hydrated diameters of K⁺, Cl⁻, and Na⁺ are ˜0.662 nm, ˜0.664 nm, and ˜0.716 nm, respectively (Wang L et al. Nat. Nanotechnol. 2017, 12(6), 509-522), the facile interfacial polymerization process with polyhedral oligomeric silsesquioxane (smallest dimension ˜0.5 nm) could allow for graphene nanoporous atomically thin membranes with high water permeability, while effectively rejecting larger ions and solutes.

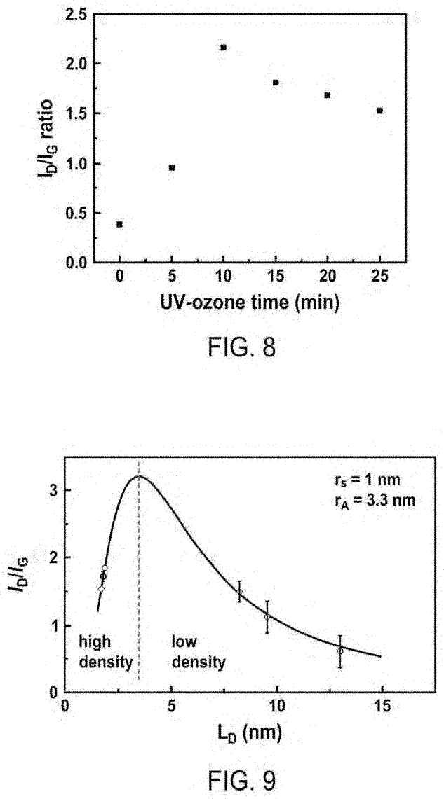

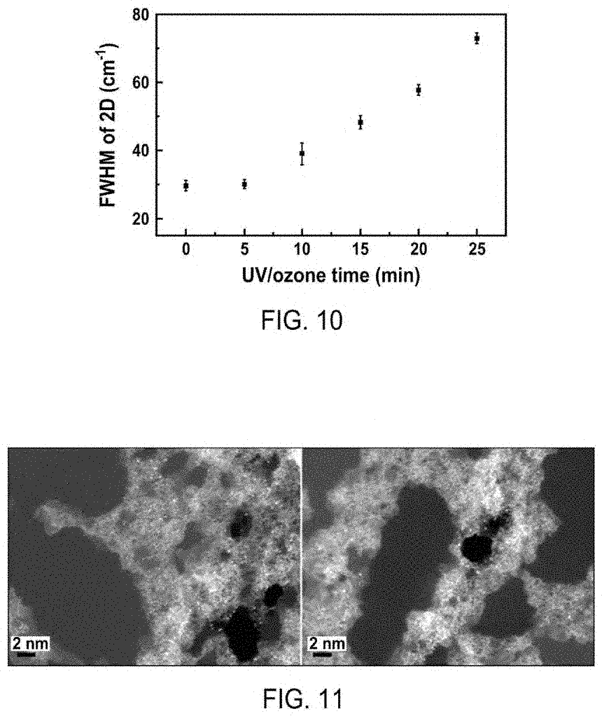

Raman spectroscopy (FIG. 7 and Supporting Information note 1) confirms the existence of defects in the as-synthesized nanoporous graphene (NG) lattice (Kidambi P R et al. Adv. Mater. 2018, 30(49), 1804977) as well as an increase in defects with increasing UV/ozone etch times (e.g., from 5 minutes, U5, to 30 minutes, U30), particularly for >15 min (FIG. 8) (Kidambi P R et al. Adv. Mater. 2017, 29(33), 1700277; Kidambi P R et al. J. Phys. Chem. C 2012, 116(42), 22492-22501; Kidambi P R et al. Nanoscale 2017, 9(24), 8496-8507; Kidambi P R et al. ACS Appl. Mater. Interfaces 2018, 10(12), 10369-10378; Ferrari A C et al. Nat. Nanotechnol. 2013, 8(4), 235-246; Kidambi P R et al. Nano Lett. 2013, 13(10), 4769-4778), as observed from the average inter-defect distance (L_{D}, see FIG. 9 and Supporting Information note 1) (Cancado L G et al. Nano Lett. 2011, 11(8), 3190-3196; Lucchese M M et al. Carbon 2010, 48(5), 1592-1597) and the full width at half-maximum (FWHM) of the 2D peak (FIG. 10) (Kidambi P R et al. Adv. Mater. 2017, 29(33), 1700277; Zhao J et al. Sci. Adv. 2019, 5(1), No. eaav1851).

To unambiguously verify the existence of nanometer and sub-nanometer pores in graphene after UV-ozone treatment, the graphene sample was transferred to a TEM grid using a procedure described elsewhere (O'Hern S C et al. Nano Letters 2015, 15(5), 3254-3260; O'Hern S C et al. Nano Letters 2014, 14, (3), 1234-1241; Au-Hauwiller M R et al. JoVE 2018, (135), e57665) and then the transferred graphene sample was treated by UV-ozone for 25 min. An Aberration-corrected scanning transmission electron microscope (STEM) was employed to reveal distinct nanopores and defects in the graphene lattice. As shown in FIG. 11, middle-angle annular dark field (MAADF) STEM images confirm that low-temperature CVD growth followed by UV-ozone treatment can generate sub-nanometer and nanometer pores in the range of 0.4-5 nm in graphene.

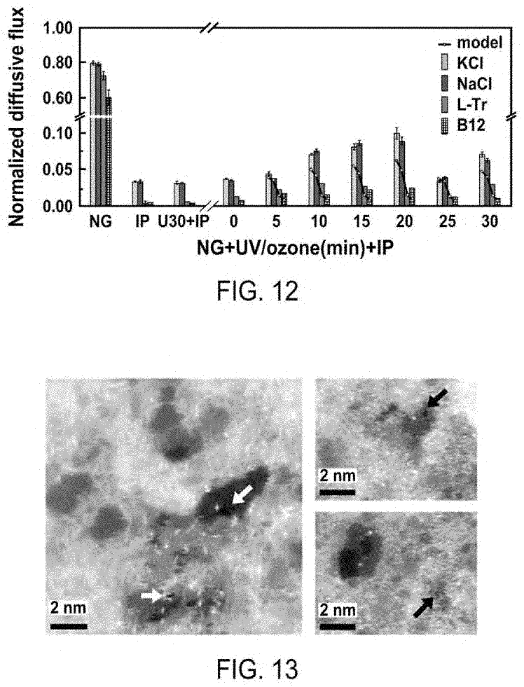

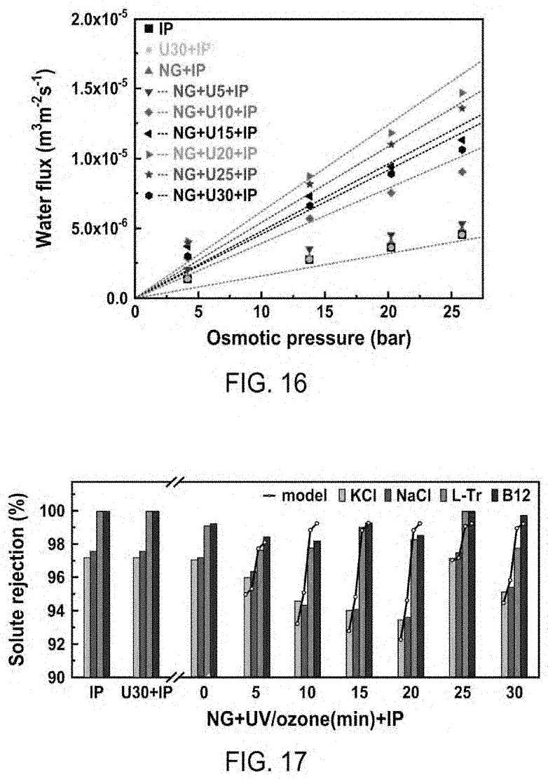

The performance of the nanoporous atomically thin membranes for ionic and molecular separation was initially evaluated via diffusion-driven-flow (FIG. 12) and osmotic pressure-driven-flow measurements (FIG. 16-FIG. 20) using a customized experimental setup (FIG. 29). Solutes and ions were specifically selected to confirm the formation of nanopores in the 0.28-0.66 nm size range in the nanoporous atomically thin membranes, that is, KCl (salt, hydrated diameter of K⁺˜0.662 and Cl⁻˜0.664 nm) (Wang L et al. Nat. Nanotechnol. 2017, 12(6), 509-522), NaCl (hydrated diameters of Na⁺˜0.716 and Cl⁻˜0.664 nm) (Wang L et al. Nat. Nanotechnol. 2017, 12(6), 509-522), L-tryptophan (L-Tr, amino acid, ˜0.7-0.9 nm, 204 Da), and Vitamin B12 (B12, vitamin, ˜1-1.5 nm, 1355 Da) (Wang L et al. Nat. Nanotechnol. 2017, 12(6), 509-522; Kidambi P R et al. Adv. Mater. 2017, 29(33), 1700277).

FIG. 21 shows a sketch of water permeance and solute rejection through an ideal membrane driven by osmotic pressure in the forward osmosis system.

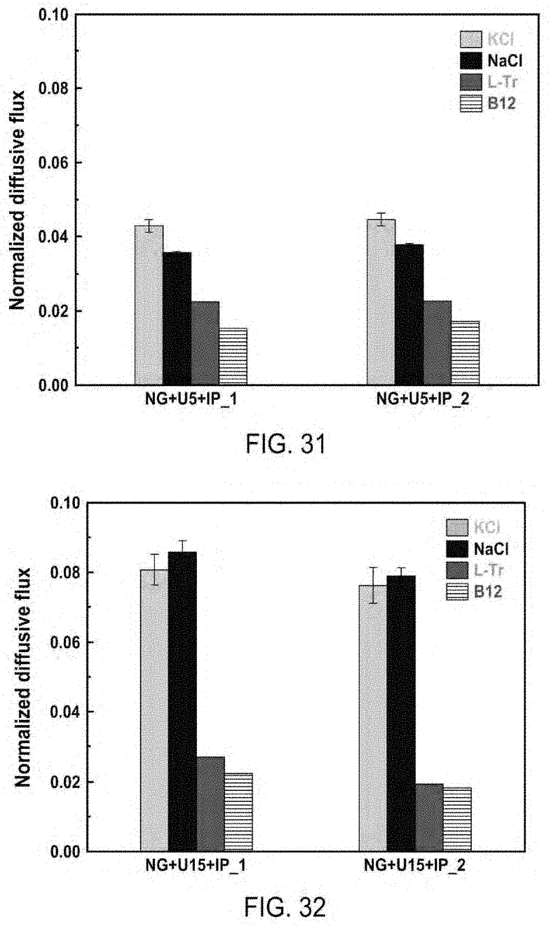

Diffusive transport through the nanoporous atomically thin membranes could arise from (i) selective transport through small nanopores in graphene, (ii) nonselective leakage through tears and large nanopores in graphene, and (iii) leakage across the polyhedral oligomeric silsesquioxane-polyamide plugs (Kidambi P R et al. Adv. Mater. 2017, 29(19), 1605896). The as-synthesized nanoporous graphene on polycarbonate track etched supports without interfacial polymerization (NG in FIG. 12) shows significant differences between normalized diffusive fluxes (normalized with respect to bare polycarbonate track etched supports, FIG. 12) of KCl (˜80%) and B12 (˜60%), indicating the presence of sub-nanometer defects in the graphene lattice (Kidambi P R et al. Adv. Mater. 2018, 30(49), 1804977; Kidambi P R et al. Nanoscale 2017, 9(24), 8496-8507), in addition to nonselective diffusive transport across large tears and open polycarbonate track etched pores. After interfacial polymerization, the as-synthesized nanoporous graphene membrane (NG+UV/ozone 0 min+IP in FIG. 12 or NG+IP) shows significantly reduced normalized diffusive fluxes for all species (˜3.5% for KCl and NaCl, <1% for L-Tr and B12), indicating interfacial polymerization with polyhedral oligomeric silsesquioxane-polyamide blocks most nanopores >0.66 nm along with any large tears and open polycarbonate track etched pores in the nanoporous atomically thin membranes. Control experiments with bare polycarbonate track etched supports after interfacial polymerization (IP in FIG. 12) and polycarbonate track etched supports after UV/ozone etching for 30 min (U30+IP in FIG. 12) after interfacial polymerization showed normalized diffusive fluxes of ˜3% for KCl and NaCl and negligible leakage for L-Tr and B12. These leakages can be attributed to transport through the polyhedral oligomeric silsesquioxane-polyamide plugs and the negligible impact of UV/ozone etching on polycarbonate track etched supports is noted. Upon increasing UV/ozone etching times up to 20 min, the normalized diffusive fluxes of KCl for nanoporous atomically thin membranes systematically increases from ˜3% to ˜10% but decrease to ˜3% for 25 min and ˜7% for 30 min. The normalized diffusive fluxes of NaCl show a similar trend. For L-Tr (˜0.7-0.9 nm) and B12 (˜1-1.5 nm) the normalized diffusive fluxes remain <3% for all the nanoporous atomically thin membranes, further indicating the polyhedral oligomeric silsesquioxane-polyamide interfacial polymerization process effectively blocks nanopores >0.66 nm, along with any tears or open polycarbonate track etched support pores. Diffusion-driven-flow experiments with nanoporous atomically thin membranes from different batches with similar processing (FIG. 31-FIG. 32) show fully consistent results, indicating the reliability and reproducibility of the entire process including graphene synthesis, transfer, UV/ozone etching, and interfacial polymerization.

The measured ion diffusion rates were fitted to an analytical diffusion model (see detailed description in Supporting Information note 2) in which transport is approximated as occurring through an array of independent, parallel pores in a thin membrane separating reservoirs at different concentrations. The pores are approximated as following a log-normal distribution with the mean, standard deviation, and pore density selected to match the model to the measurements. Leakage is accounted for by adding the transport rates measured on nonetched membranes in the model. The model is able to reasonably fit the diffusion measurements (FIG. 12), providing further evidence that sub-nanometer pores created through graphene synthesis and UV/ozone etching are governing the measured diffusion rates.

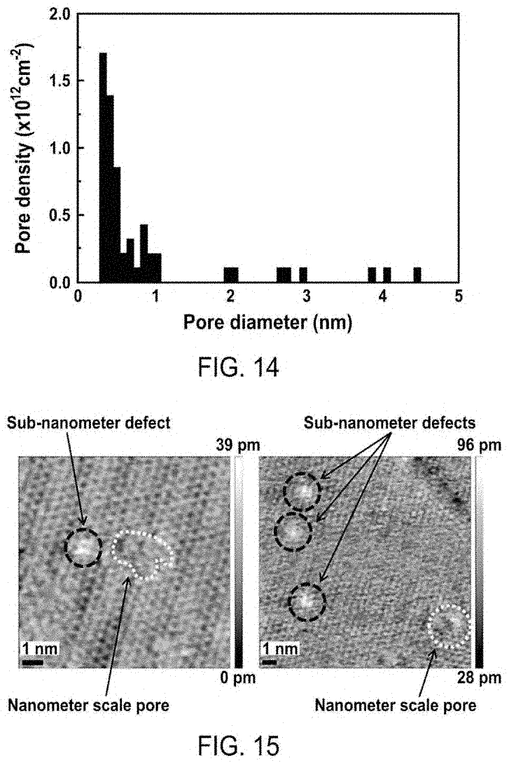

Atomic resolution scanning transmission electron microscopy (STEM, FIG. 13) confirms the existence of nanopores in the as-synthesized nanoporous graphene lattice after 25 min of UV/ozone etching. The nanopore size distribution indicates that the vast majority of nanopores are <0.5 nm, with some nanopores in the 0.5-1 nm range and few large nanopores >1 nm (FIG. 14 and FIG. 30) (Wang L et al. Nat. Nanotechnol. 2017, 12(6), 509-522; O'Hern S C et al. Nano Lett. 2015, 15(5), 3254-3260; Jang D et al. ACS Nano 2017, 11(10), 10042-10052; Cohen-Tanugi D et al. Nano Lett. 2012, 12(7), 3602-3608). The overall nanopore density is ˜6.3×10¹² cm⁻², while the effective pore densities after excluding nanopores >0.5 nm and >1.8 nm are ˜4×10¹² cm⁻² and ˜5.5×10¹² cm², respectively. These measured nanopore densities are in excellent agreement with the nanopore density of ˜8.1×10¹² cm⁻² obtained for 25 min UV/ozone etch time from the transport model fit (Table 1).

TABLE 1
Pore density values in graphene membranes with
different UV/ozone treatment times from model fit.

| Etch time [min] | ρₚₒᵣₑ, D > D_{w} [cm⁻²] |
|---|---|
| 5 | 0.0002× |
| 10 | 4.2 × 10¹² |
| 15 | 5.8 × 10¹² |
| 20 | 7.9 × 10¹² |
| 25 | 8.1 × 10¹² |
| 30 | 5.6 × 10¹² |

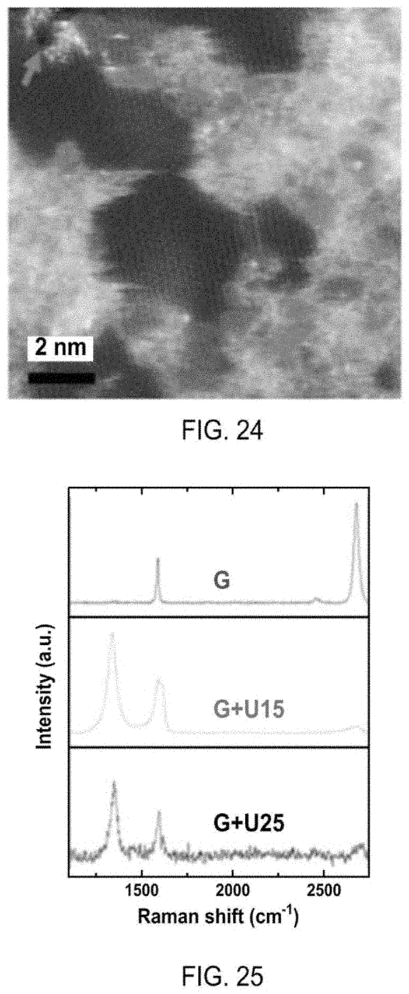

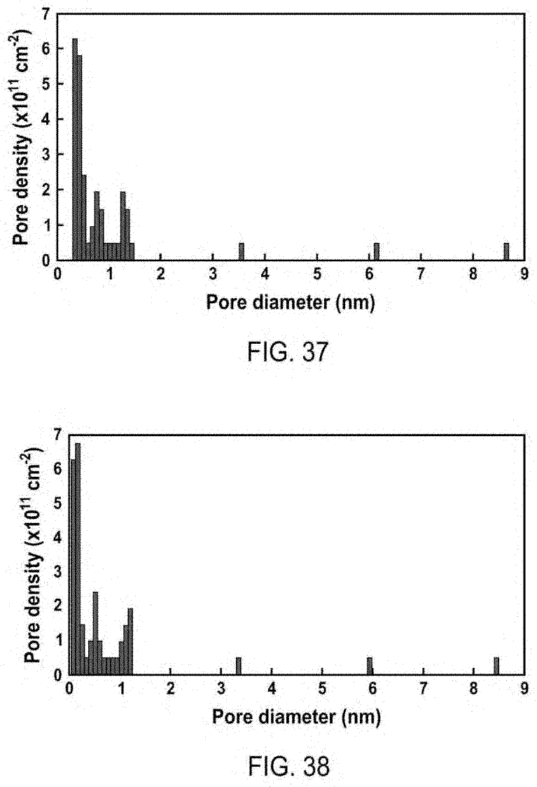

Interestingly, the nanopore densities for UV/ozone treated high quality graphene (FIG. 24 and FIG. 37-FIG. 38) were found to be lower than ˜2.7×10¹² cm⁻², indicating the efficacy of this approach at nucleating a high-density of nanopores via low-temperature CVD. Although a polymer-free procedure was used for transferring graphene to TEM grids for STEM imaging, unavoidable adventitious contaminants are typically seen to adhere on defects/nanopores in comparison to pristine regions (FIG. 13 and FIG. 24) (O'Hern S C et al. Nano Lett. 2014, 14(3), 1234-1241; Kidambi P R et al. Adv. Mater. 2017, 29(33), 1700277; Jang D et al. ACS Nano 2017, 11(10), 10042-10052). Annealing in H₂ to reduce contaminants was specifically avoided, since aggressive cleaning/etching/heating could alter the nanopore size distributions.

To further confirm the existence of sub-nanometer pores in graphene without transfer and minimal contamination, scanning tunneling microscopy (STM) images of nanoporous graphene on Cu foil after UV/ozone etching for 25 min were also acquired (FIG. 15). Sub-nanometer scale vacancy defects are indicated and larger nanometer-sized pores defects (˜0.4-1.5 nm) are also indicated (Ugeda M M et al. Phys. Rev. Lett. 2011, 107(11), 116803; Martinez-Galera A J et al. Nano Lett. 2011, 11(9), 3576-3580), confirming the presence of nanopores in the graphene lattice.

TABLE 2
Solutions in the feed and permeate side for solute diffusion,
water transport, and solute rejection experiments.

| Experiment | | |
|---|---|---|
| type | Feed side | Permeate side |
| Solute diffusion | KCl solution (0.5M) | DI Water |
| measurements | NaCl solution (0.5M) | DI Water |
| | L-Tr solution | DI Water |
| | (1 mM in 0.5M of | |
| | KCl) | |
| | B12 solution | DI Water |
| | (1 mM in 0.5M of | |
| | KCl) | |
| Water transport | DI Water | Glycerol ethoxylate |
| measurements | | solution (10 wt %) |
| | DI Water | Glycerol ethoxylate |
| | | solution (21.5 wt %) |
| | DI Water | Glycerol ethoxylate |
| | | solution (30 wt %) |
| Solute rejection | KCl solution | Glycerol ethoxylate |
| measurements | (16.6 mM) | solution (26.47 wt %) |
| | NaCl solution | Glycerol ethoxylate |
| | (16.6 mM) | solution (26.47 wt %) |
| | L-Tr solution | Glycerol ethoxylate |
| | (1.3 mM) | solution (26.47 wt %) |
| | B12 solution | Glycerol ethoxylate |
| | (1.3 mM) | solution (26.47 wt %) |

Osmotic pressure-driven flow experiments for the synthesized graphene nanoporous atomically thin membranes show an increase in water flux with increasing UV/ozone time from 0 to 20 min (NG+IP for 0 min UV/ozone time; NG+U5+IP to NG+U30+IP for 5 min to 30 UV/ozone time respectively in FIG. 16; Table 2) and a linear increase in water flux with osmotic pressure (0-25 bar). A marginal reduction in water flux is observed for the 25 min UV/ozone exposure, followed by a further decrease at 30 min. Control measurements with bare polycarbonate track etched supports (IP in FIG. 16 and FIG. 34) and polycarbonate track etched supports after 30 min UV/ozone exposure (U30+IP in FIG. 16) show significantly lower water flux indicating (a) the majority of the water transport is through nanopores in graphene and (b) the near identical water flux values measured for the controls indicate minimal effect of UV/ozone etching on polycarbonate track etched supports. Water transport across the nanoporous atomically thin membranes could arise from (i) nanopores <0.66 nm in graphene, which could allow water to permeate while blocking salt ions, and (ii) large nanopores (0.66-1.8 nm), which give rise to the transport of water, salt ions, and small organic molecules.

Hence, in addition to water transport, rejection of model solutes (KCl, NaCl, L-Tr, and B12) after 24 h of osmotic pressure-driven water permeation through the synthesized nanoporous atomically thin membranes was also measured (FIG. 17) (Yang Y et al. Science 2019, 364(6445), 1057-1062). The rejection of KCl and NaCl for the nanoporous atomically thin membranes gradually decreases with increasing UV/ozone exposure up to 20 min and then increases at 25 min (the highest salt rejection) before decreasing again at 30 min. The rejection of L-Tr and B12 in all nanoporous atomically thin membranes remains >97.5% and >98.5%, respectively. These minimal leakages of L-Tr (<2.5%) and B12 (<1.5%) in the nanoporous atomically thin membranes are attributed to a few unsealed large nanopores (0.66-1.8 nm). Control measurements with polycarbonate track etched supports (IP in FIG. 17) and polycarbonate track etched supports after 30 min UV/ozone exposure (U30+IP in FIG. 17) show solute rejection of KCl ˜97%, NaCl ˜97.5%, L-Tr ˜100%, and B12˜100%, indicating the efficacy of polyhedral oligomeric silsesquioxane-polyamide plugs/seals and represents the upper bound for salt rejection attainable (remaining is leakage through polyhedral oligomeric silsesquioxane-polyamide).

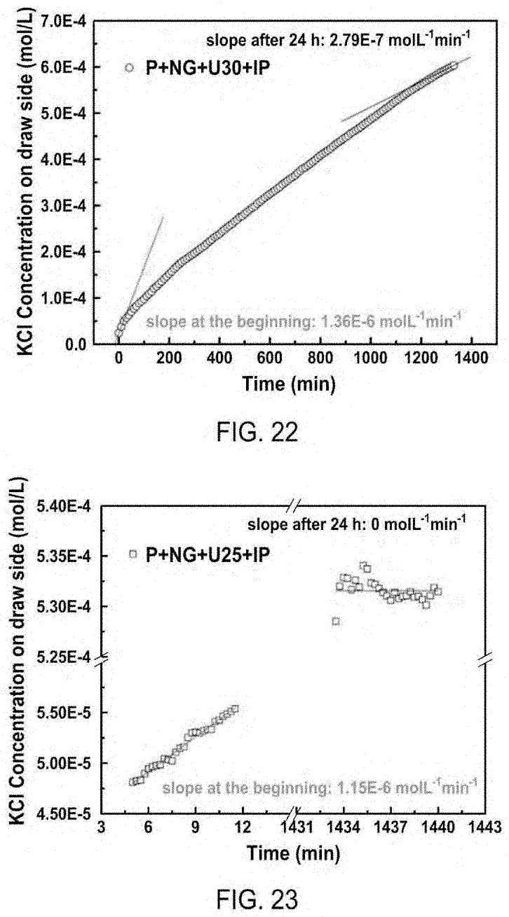

FIG. 22 shows the KCl concentration change (represented by black circles) on permeate side of a nanoporous graphene membrane on a polycarbonate track etched support treated with UV-ozone for 30 minutes followed by interfacial polymerization (P+NG+U30+IP) during the solute rejection measurement. KCl concentration slopes at the beginning and end (after 24 h) are represented by red and blue lines, respectively.

FIG. 23 shows KCl concentration slopes at the beginning (red line) and after 24 h (blue line) on the permeate side of a nanoporous graphene membrane on a polycarbonate track etched support treated with UV-ozone for 25 minutes followed by interfacial polymerization (P+NG+U25+IP) during the solute rejection measurement.

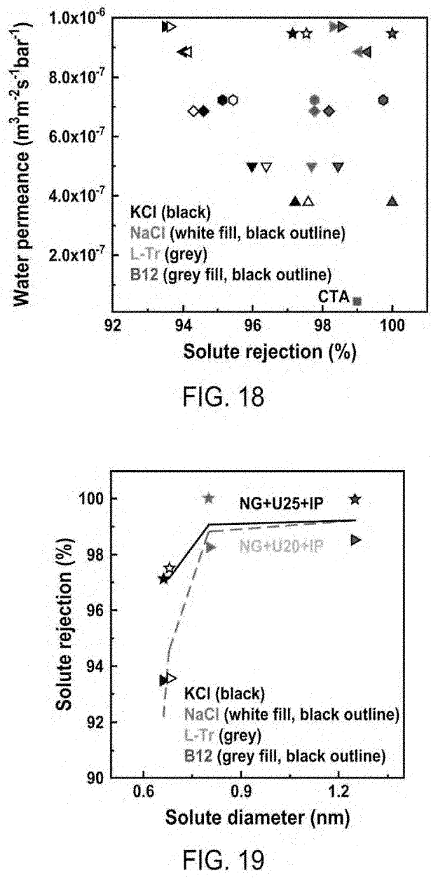

The permeance versus solute rejection (FIG. 18) allows for an unambiguous evaluation of the performance of the synthesized nanoporous atomically thin membranes and is a well-known trade-off in conventional nanofiltration, ionic and molecular separation, and desalination membranes (Wang L et al. Nat. Nanotechnol. 2017, 12(6), 509-522; Yang Y et al. Science 2019, 364(6445), 1057-1062). The nanoporous atomically thin membrane with 20 min UV/ozone exposure (right facing triangles) showed the highest water permeance (˜9.8×10⁻⁷ m³ m⁻² s⁻¹ bar⁻¹) and the lowest solute rejection (KCl ˜93%, NaCl ˜93%, L-Tr ˜98%, and B12˜98%). However, nanoporous atomically thin membrane with 25 min UV/ozone exposure (star symbols) showed very high water permeance (˜9.5×10⁻⁷ m³ m⁻² s⁻¹ bar⁻¹, only marginally lower than NG+UV/ozone 20 min) and the highest solute rejection (˜97% rejection of KCl and NaCl, 100% rejection of L-Tr and B12). These observations indicate the presence of nanopores >0.66 nm that were not fully sealed by polyhedral oligomeric silsesquioxane-polyamide in the nanoporous atomically thin membrane with 20 min UV/ozone etching. However, 25 min of UV/ozone enlarges the nanopores adequately to be effectively sealed by interfacial polymerization and results in marginally lower water flux (due to the loss of some nanopores via polyhedral oligomeric silsesquioxane-polyamide sealing) but results in much higher solute rejection. Overall, the solute rejections for nanoporous atomically thin membranes with 20 and 25 min of UV/ozone increases with solute diameters (FIG. 19). However, the nanoporous atomically thin membrane with 20 min UV/ozone exposure has the largest fraction of relatively large nanopores (0.66-1.8 nm), while nanoporous atomically thin membrane with 25 min UV/ozone exposure has the largest fraction of sub-nanometer pores (<0.66 nm).

The transport model was extended to predict rates of water transport by forward osmosis and osmotically driven salt ion convection-diffusion across the membrane. Water flow rates through graphene pores were calculated from the correlation developed by Suk and Aluru based on molecular dynamics simulation results (Suk M E et al. RSC Adv. 2013, 3(24), 9365-9372). Salt convection-diffusion was modeled using approximate analytical expressions for convective and diffusive transport across a pore in a thin membrane and through a cylindrical polycarbonate track etched membrane pore (see Supporting Information note 2). The transport model effectively captures the water flux (FIG. 16) and the dependence of ion rejection on diameter (FIG. 17, FIG. 19) for the different UV/ozone etch times. It is emphasized that the same model pore size distribution and density have been used in all model curves at a given etch time (FIG. 12, FIG. 16, FIG. 17, and FIG. 19). Just as the measured rates of diffusion, osmosis, and salt convection-diffusion all arise from the same pore size distribution and density in the membrane, the model is able to use a single pore size distribution and density to explain the measured flow rates from these three different transport modes. This further supports the conclusion that the sub-nanometer pores in the graphene lattice are responsible for the measured salt diffusion, water flow rate, and salt rejection trends. The model's success in quantitatively explaining the experimental measurements makes it a very useful design tool for predicting membrane performance gains as the pore size distribution and density are tuned.

Taken together, the results from Raman spectroscopy (FIG. 7), diffusion-driven solute transport (FIG. 12), osmotic pressure-driven transport (FIG. 16), solute rejection (FIG. 17), and water permeance versus solute rejection (FIG. 18) indicate that the defect/nanopore density and size distribution range in graphene nanoporous atomically thin membranes increases with UV/ozone exposure via the formation of new defects as well as the enlargement of existing defects, respectively. As more defects form in the graphene lattice with increasing etch times (increasing water flux), the merging of individual defects leads to the formation of larger nanopores. With longer UV/ozone etching times, the larger nanopores (˜0.5-1.8 nm) will eventually grow larger than >1.8 nm and will end up being sealed via interfacial polymerization. The results herein indicate the highest salt rejection (>97%) and very high water flux (˜9.5×10⁻⁷ m³ m⁻² s⁻¹ bar⁻¹) for UV/ozone etch time corresponding to 25 min on the as-synthesized nanoporous graphene after interfacial polymerization (polyhedral oligomeric silsesquioxane cage ˜0.5 nm and diagonal length ˜1.8 nm), indicating the largest fraction of <0.66 nm nanopores.

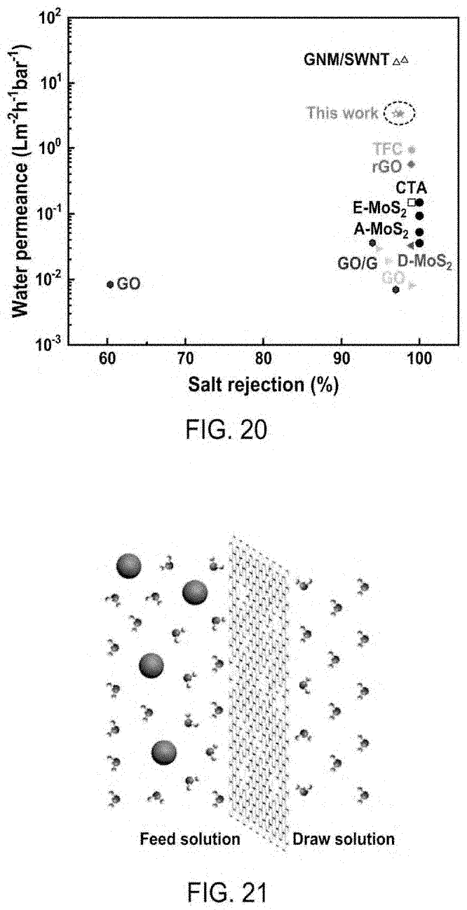

A detailed comparison of the water permeance and salt rejection (KCl and NaCl) of the nanoporous atomically thin membranes with 25 min UV/ozone etching with other ionic and molecular separation membranes reported in the literature is presented in FIG. 20, Table 3, and Table 4. The nanoporous atomically thin membranes described herein exhibit a higher water permeance than all membranes in the literature, except for graphene supported on single-walled carbon nanotubes (SWNTs) (Yang Y et al. Science 2019, 364(6445), 1057-1062). This can be attributed to the higher transport resistance for the ˜200 nm diameter polycarbonate track etched support pores compared to the porous single-walled carbon nanotube mesh (Yang Y et al. Science 2019, 364(6445), 1057-1062). Hence, the water permeance of nanoporous atomically thin membranes could potentially be further improved by replacing polycarbonate track etched supports with a lower resistance hierarchically porous support in future studies (Kidambi P R et al. Adv. Mater. 2018, 30(49), 1804977). Interestingly, when compared with the commercially available cellulose triacetate membrane (CTA) (Yang Y et al. Science 2019, 364(6445), 1057-1062) and state-of-the-art advances in thin film composite (TFC) membranes (Ren J et al. Desalination 2014, 343, 187-193), the water permeance of the nanoporous atomically thin membranes described herein under forward osmosis (˜3.5 L m⁻² h⁻¹ bar⁻¹) is already up to 23 times and 3.7 times higher, respectively, with comparable salt rejection (Cohen-Tanugi D et al. Energy Environ. Sci. 2014, 7(3), 1134-1141; Deshmukh A et al. J. Membr. Sci. 2015, 491, 159-167; Werber et al. Nat. Rev. Mater. 2016, 9(5), 16018).

TABLE 3
Water permeance and salt rejection comparison among different FO
membranes reported in the literature and this work.

| | | Water | | |
|---|---|---|---|---|
| | | permeance | Salt | |
| | Salt | (L m'² h'¹ | reject. | |
| Membrane | type | bar¹) | (%) | Reference |
| P + NG + U25 + IP | KCl | 3.41 | 97.2 | This work |
| P + NG + U25 + IP | NaCl | 3.41 | 97.5 | This work |
| Cellulose triacetate | KCl | 0.15 | 99 | Yang Y et al. Science 2019, 364, 1057 |
| (CTA) | | | | |
| GNM/SWNT | KCl | 20.6 | 97.1 | Yang Y et al. Science 2019, 364, 1057 |
| GNM/SWNT | NaCl | 22 | 98.1 | Yang Y et al. Science 2019, 364, 1057 |
| Acetamide- | NaCl | 0.036 | 99.8 | Ries L et al. Nat. Mater. 2019, 18, |
| functionalized MoS₂ | | | | 1112 |
| Acetamide- | NaCl | 0.052 | 99.9 | Ries L et al. Nat. Mater. 2019, 18, |
| functionalized MoS₂ | | | | 1112 |
| Ethyl-2-ol- | NaCl | 0.092 | 99.97 | Ries L et al. Nat. Mater. 2019, 18, |
| functionalized MoS₂ | | | | 1112 |
| Ethyl-2-ol- | NaCl | 0.146 | 99.98 | Ries L et al. Nat. Mater. 2019, 18, |
| functionalized MoS₂ | | | | 1112 |
| GO | NaCl | 0.019 | 96 | Chen L et al. Nature 2017, 550, 380 |
| GO | NaCl | 0.029 | 94.7 | Chen L et al. Nature 2017, 550, 380 |
| GO | NaCl | 0.008 | 99 | Chen L et al. Nature 2017, 550, 380 |
| GO | NaCl | 0.0084 | 60 | Abraham et al. Nat. Nanotech. 2017, |
| | | | | 12, 546 |
| GO/graphene | NaCl | 0.007 | 97 | Abraham et al. Nat. Nanotech. 2017, |
| | | | | 12 (6), 546-550 |
| GO/graphene | NaCl | 0.036 | 94 | Abraham et al. Nat. Nanotechnol. |
| | | | | 2017, 12, 546 |
| Dye decorated MoS₂ | NaCl | 0.033 | 99 | Hirunpinyopas W et al. ACS Nano |
| | | | | 2017, 11, 11082 |
| rGO | NaCl | 0.57 | 99 | Liu et al. Adv. Mater. 2015, 27, 249 |
| State-of-the-art | NaCl | 0.94 | 99 | Ren J et al. Desalination 2014, 343, |
| advances in Thin | | | | 187 |
| film composite | | | | |
| (TFC) membranes | | | | |

TABLE 4
Directly-measured water permeance and KCl rejection
comparison among this work and commercial CTA
membrane. All the water permeance data are directly
measured, not divided by the porosity of support.

| | Salt rejection | Water permeance |
|---|---|---|
| Membrane | (%) | (L m⁻² h⁻¹ bar⁻¹) |
| PCTE + Gr + IP | 97.2 | 0.13 |
| PCTE + Gr + UO5 min + IP | 96.0 | 0.17 |
| PCTE + Gr + UO10 min + IP | 94.6 | 0.23 |
| PCTE + Gr + UO15 min + IP | 94.0 | 0.30 |
| PCTE + Gr + UO20 min + IP | 93.5 | 0.33 |
| PCTE + Gr + UO25 min + IP | 97.2 | 0.32 |
| PCTE + Gr + UO30 min + IP | 95.2 | 0.24 |
| Commercial cellulose | 99.0 | 0.03 |
| triacetate | | |

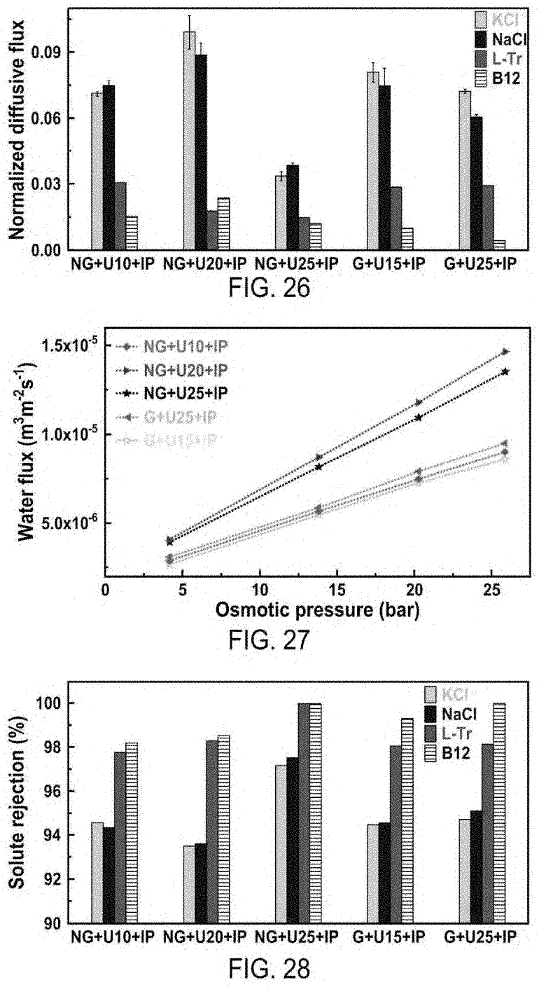

Finally, nanoporous atomically thin membranes were also fabricated with high quality graphene synthesized at 1050° C. (D peak ˜1350 cm⁻¹ is not seen in the Raman spectrum, FIG. 25). However, the nanopore density of ˜2.7×10¹² cm⁻² (FIG. 24 and FIG. 37-FIG. 38) obtained via UV/ozone etching of high quality graphene for 25 min is significantly lower than with the as-synthesized ˜900° C. nanoporous graphene of ˜6.3×10¹² cm⁻² (FIG. 14) resulting in lower performance (FIG. 26-FIG. 28). These observations indicate the effectiveness of the combination of nanoporous graphene via low temperature CVD growth (˜900° C.) and UV/ozone etching in creating a high density of sub-nanometer pores in the graphene lattice for nanoporous atomically thin membranes.

Conclusion. In summary, a facile and scalable approach to synthesize fully functional large-area graphene nanoporous atomically thin membranes for ionic and molecular separations was developed. The combination of low-temperature CVD growth of nanoporous graphene, subsequent UV/ozone etching, and size-selective interfacial polymerization allows for facile synthesis of nanoporous atomically thin membranes with high-density sub-nanometer pores. This is the first demonstration of size-selective defect sealing for nanoporous atomically thin membranes and the obtained water permeance is ˜23× higher than commercially available water treatment/desalination membranes, along with salt rejection >97% and small molecule rejection ˜100%. Further improvements in water permeance are expected with lower resistance hierarchically porous supports (Kidambi P R et al. Adv. Mater. 2018, 30(49), 1804977). This work provides a facile and scalable route to overcome fundamental limitations in the development of nanoporous atomically thin membranes for ionic/molecular separations. These advances coupled with prior work on roll-to-roll graphene synthesis (Kidambi P R et al. ACS Appl. Mater. Interfaces 2018, 10(12), 10369-10378) and facile polymer support casting (Kidambi P R et al. Adv. Mater. 2018, 30(49), 1804977; Kidambi P R et al. ACS Appl. Mater. Interfaces 2018, 10(12), 10369-10378) could enable nanoporous atomically thin membranes to progress toward practical applications and enable transformative advances in sub-nanometer scale ionic and molecular separations relevant to chemical processing, biochemical/biological research, medical/therapeutic research, pharmaceuticals purification, and other industrial applications.

Supporting Information Note 1. Assessment of Raman Spectra of Graphene Lattice after US/Ozone Etch. The as-synthesized nanoporous graphene (NG) shows the characteristic 2D (˜2700 cm⁻¹, full width at half maximum (FWHM) ˜29 cm⁻¹), G (˜1600 cm⁻¹) and D (˜1350 cm⁻¹) peaks with I_{D}/I_{G}˜0.6 (Kidambi P R et al. Adv. Mater. 2017, 29 (33), 1700277; Ferrari A C et al. Nat. Nanotechnol. 2013, 8 (4), 235-246), indicating the presence of defects in the graphene lattice (FIG. 7) and is fully consistent with prior work on nanoporous atomically thin membranes (Kidambi P R et al. Adv. Mater. 2018, 30 (49), 1804977) and graphene growth (Kidambi P R et al. Nanoscale 2017, 9 (24), 8496-8507; Kidambi P R et al. ACS Appl. Mater. Interfaces 2018, 10 (12), 10369-10378; Kidambi P R et al. Nano Lett. 2013, 13 (10), 4769-4778; Kidambi P R et al. J. Phys. Chem. C 2012, 116 (42), 22492-22501). With increasing UV/ozone etching, the intensity of the 2D and G peaks decrease, while the intensity of the D peak (associated with defects in graphene) (Kidambi P R et al. Adv. Mater. 2017, 29 (33), 1700277; Ferrari A C et al. Nat. Nanotechnol. 2013, 8 (4), 235-246) increases from 0 to 15 min and then decreases with further etch times. The D′ peak (˜1625 cm⁻¹, associated with strain in the graphene lattice) also emerges as a shoulder to the right of G peak (Kidambi P R et al. Adv. Mater. 2017, 29 (33), 1700277; Ferrari A C et al. Nat. Nanotechnol. 2013, 8 (4), 235-246).

To evaluate the density of defects/nanopores, the average inter-defect distance (L_{D}) was computed from the I_{D}/I_{G} ratio (FIG. 9 and see equation below) (Cangado L G et al. Nano Lett. 2011, 11 (8), 3190-3196; Lucchese M M et al. Carbon 2010, 48 (5), 1592-1597). As the I_{D}/I_{G} ratio increases the L_{D} decreases from −13 nm to ˜8.2 nm in the low-defect-density-regime (corresponding to 0-10 min of UV/ozone etching) and reaches a maximum at L_{D}˜3 nm, before gradually decreasing to ˜1.7 nm in the high-defect-density-regime (corresponding to 15-30 min of UV/ozone etching) (Cangado L G et al. Nano Lett. 2011, 11 (8), 3190-3196; Lucchese M M et al. Carbon 2010, 48 (5), 1592-1597). These observations indicate the formation of high-density of defects for UV/ozone etching times >15 min. Furthermore, the full width at half maximum (FWHM) of the 2D peak was found to gradually increase with increasing UV/ozone etching time (FIG. 10) indicating the formation of defects in graphene (Kidambi P R et al. Adv. Mater. 2017, 29 (33), 1700277; Zhao J et al. Sci. Adv. 2019, 5 (1), eaav1851). Finally, Raman spectra for graphene exposed to >30 min of UV/ozone etching showed almost no detectable peaks (FIG. 7) (Kidambi P R et al. Adv. Mater. 2017, 29 (33), 1700277).

The equation used to describe the relationship between I_{D}/I_{G} ratio and the average inter-defect distance (L_{D}) in both low-defect-density-regime and high-defect-density-regime is as follows (Cangado L G et al. Nano Lett. 2011, 11 (8), 3190-3196; Lucchese M M et al. Carbon 2010, 48 (5), 1592-1597):

$$\frac{{I}_{D}}{{I}_{G}} = {C}_{A} \frac{{r}_{A}^{2} - {r}_{S}^{2}}{{r}_{A}^{2} - 2 {r}_{S}^{2}} [ {e}^{( \frac{π {r}_{S}^{2}}{- {L}_{D}^{2}} )} - {e}^{( \frac{π ( {r}_{A}^{2} - {r}_{S}^{2} )}{- {L}_{D}^{2}} )} ] + {C}_{s} [ 1 - {e}^{( \frac{π {r}_{S}^{2}}{- {L}_{D}^{2}} )} ]$$

in which r_{A} is the radius of area surrounding the defect, r_{S} is the radius of structural disorder, C_{A} is the parameter describing the strength of activated area, and C_{S} is the parameter describing the strength of structurally defective area (Cangado L G et al. Nano Lett. 2011, 11 (8), 3190-3196; Lucchese M M et al. Carbon 2010, 48 (5), 1592-1597); r_{A} and r_{S} are 3.3 nm and 1 nm, respectively, while C_{A} and C_{S} are 4.56 and 0.86, respectively, in this fitting.

Supporting Information Note 2.

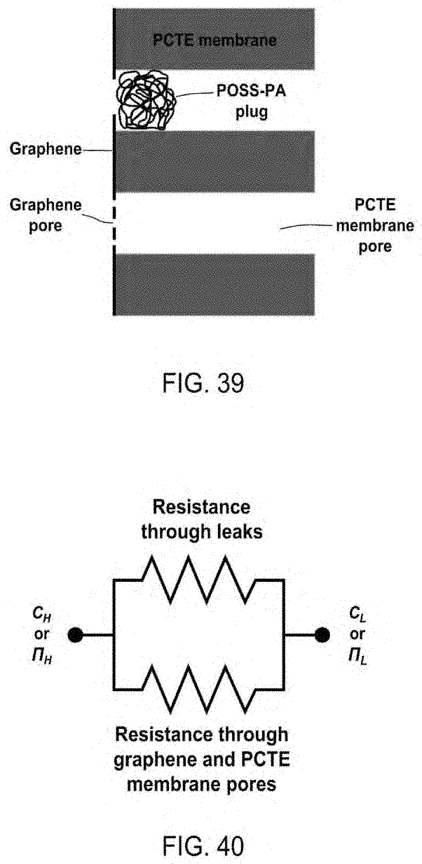

Transport model. Water and solute molecule transport is modeled as occurring through either of two paths: (1) the molecules first cross the pores created in the graphene and then pass through the large pores in the supporting polycarbonate track etched membrane, or (2) they leak through the interfacial polymer seal which has finite diffusivity (FIG. 39-FIG. 40). The total transport rate is the sum of these two contributions. Here, the contribution to transport passing through the graphene pores is modeled and the measured leakage flow is subsequently added. Any defects inherently present in the graphene will either be sealed with interfacial polymer or are included as a contribution to the leakage flow.

Throughout the model development, salts are approximated as molecules with a single size and diffusivity, neglecting the differences in values between their constituent ions. In previous studies, this approximation has provided reasonable results for graphene membranes of similar structure (Jang D et al. ACS Nano 2017, 11 (10), 10042-10052; Suk M E et al. RSC Adv. 2013, 3 (24), 9365-9372).

In this study, three different types of transport through graphene membranes was measured: (1) diffusion of four different solutes, (2) osmotic flow of water, and (3) osmotically driven transport of four different solutes. The measurements were performed on membranes exposed to UV-ozone for different lengths of time, resulting in different pore size distributions and densities. At each etch time, all three types of transport are measured and the results correspond to the same pore size distribution and density. Therefore, the model is formulated to use the same pore size distribution to account for all three types of transport. The fitting parameters for the model are the mean and standard deviation of the pore size distribution and the pore density.

Pore size distribution. The pores created in the graphene are modeled as following a log-normal distribution, which has provided a reasonable model for measured pore size distributions in prior studies on graphene membranes (O'Hern S C et al. Nano Lett. 2014, 14 (3), 1234-1241; Jang D et al. ACS Nano 2017, 11 (10), 10042-10052; Boutilier M S H et al. ACS Nano 2017, 11 (6), 5726-5736) and appears to be a good model for the pore size distribution measured here (FIG. 14). The probability density, P(D) [m⁻¹], is given by (Limpert E et al. Bioscience 2001, 51 (5), 341-352):

$$P ( D ) = \frac{1}{D χ \sqrt{2 π}} exp [ - \frac{( ln χ - ϕ )}{2 {χ}^{2}} ] \qquad S - 1$$

$$where$$

$$χ = \sqrt{ln ( \frac{{σ}^{2}}{{μ}^{2}} + 1 )} \qquad S - 2$$

$$and$$

$$ϕ = ln ( \frac{μ}{\sqrt{{σ}^{2} / {μ}^{2} + 1}} ) \qquad S - 3$$

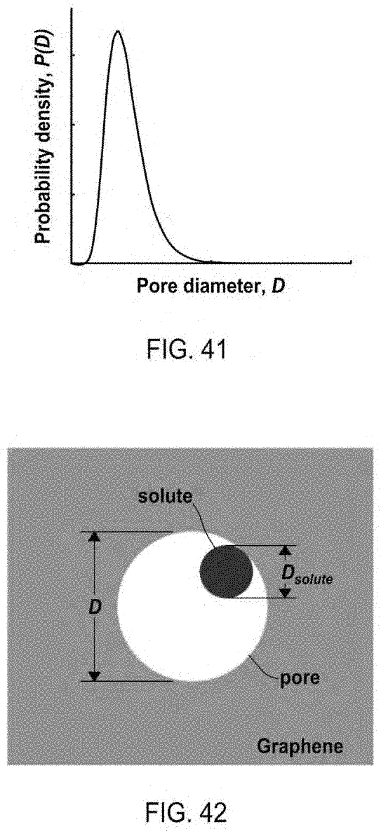

and μ [m] is the mean pore size and σ [m] is the standard deviation of pore size. The shape of this distribution is illustrated in FIG. 41.

Solute diffusion. Solute diffusion across the graphene membrane from the high concentration side to the low concentration side without osmotic flow (FIG. 12) was modeled as diffusion through a circular orifice in an infinitesimally thin plate (Carslaw H S et al. Conduction of Heat in Solids., 2nd ed.; Oxford: New York, 1986). However, the orifice diameter was replaced with the difference in pore diameter and solute hydrated diameter to approximate the effects of the finite size of the solute molecule on transport through pores of similar size (O'Hern S C et al. ACS Nano 2012, 6 (11), 10130-10138) (FIG. 42). The rate of diffusion through a single pore, \dot{n}_{diff} [mol/s] is then:

$${\dot{n}}_{diff} ( D ) = \{ \begin{matrix}0 & for D < {D}_{solute} \\ 𝒟 ( D - {D}_{solute} ) ( {c}_{H} - {c}_{L} ) & for D \geq {D}_{solute}\end{matrix} \qquad S - 4$$

where D [m] is the pore diameter, [symbol] [m²/s] is the solute diffusivity in water (Table 5), c_{H} [mol/m³] is the solute concentration on the feed side of the membrane, c_{L} [mol/m³] is the solute concentration of the permeate side of the membrane, and Dₛₒₗᵤₜₑ [m] is the hydrated solute diameter (Table 5).

TABLE 5
Solute diffusivities and diameters used in model.

| | | Dₛₒₗᵤₜₑ | |
|---|---|---|---|
| Solute | [symbol] [m²/s] | [nm] | Reference |
| KCl | 2.00 × 10⁻⁹ | 0.663 | Harned HS et al. J. |
| | | | Am. Chem. Soc. 1949, |
| | | | 71(4), 1460-1463 |
| NaCl | 1.62 × 10⁻⁹ | 0.690 | Suk ME et al. RSC |
| | | | Adv. 2013, 3(24), |
| | | | 9365-9372 |
| L- | 6.31 × 10⁻¹⁰ | 0.800 | Ye F et al. J. Pharm. |
| Tryptophan | | | Biomed. Anal. 2012, |
| | | | 61, 176-183 |
| Vitamin | 3.79 × 10⁻¹⁰ | 1.25 | Amsden B. |
| B12 | | | Macromolecules 1998, |
| | | | 31(23), 8382-8395 |

Neglecting the effects of transport through one pore on that of the surrounding pores, the total solute diffusion through the graphene is estimated by summing the contributions from every pore. The average rate of diffusion through the graphene [symbol] \dot{n}_{diff} [symbol] [mol/s], is thus approximated as:

$$〈 {\dot{n}}_{diff} 〉 = {ρ}_{pore} A {\int }_{0}^{∞} {\dot{n}}_{diff} ( D ) P ( D ) dD \qquad S - 5$$

where ρₚₒᵣₑ [pores/m²] is the aerial density of pores in graphene, and A [m²] is the total area of suspended graphene.

Substituting Equations S-4 into Equation S-5 results in the expression:

$$〈 {\dot{n}}_{diff} 〉 = 𝒟 {ρ}_{pore} A ( {c}_{H} - {c}_{L} ) {\int }_{{D}_{solute}}^{∞} ( D - {D}_{solute} ) P ( D ) dD \qquad S - 6$$

The total diffusive flow rate includes both the contributions from flow through the graphene pores and the leakage flow. The diffusive leakage flow rate measured on a graphene membrane sealed by interfacial polymerization without UV-ozone exposure (P+NG+IP in FIG. 12) was added to the modeled diffusive flow rate through graphene to obtain the total modeled diffusive flow rate presented in FIG. 12.

In FIG. 12, the diffusive flow rate through the graphene membrane was normalized to that through a polycarbonate track etched membrane without graphene. The diffusive flux calculated from the model was normalized by the diffusive flow rate through the polycarbonate track etched membrane, \dot{n}_{PCTEM} [mol/s], approximated from a one-dimensional Fick's law expression:

$${\dot{n}}_{PCTEM} = 𝒟 A \frac{( {c}_{H} - {c}_{L} )}{{L}_{PC}} \qquad S - 7$$

where L_{PC} [m] is the length of the 200 nm diameter pores in the polycarbonate track etched membrane (approximated as the membrane thickness, L_{PC}=10 m).

Osmoticflow. The osmotic pressure driven flow of water across graphene pores (FIG. 16) was modeled using a correlation developed by Suk & Aluru for water flow through graphene pores based on molecular dynamics simulation results (Suk M E et al. RSC Adv. 2013, 3 (24), 9365-9372). The correlation is:

$${\dot{V}}_{w} ( D ) = \frac{π [ {( \frac{D}{2} )}^{4} + 4 {( \frac{D}{2} )}^{3} δ ]}{8 η} \frac{{Π}_{H} - {Π}_{L}}{{L}_{h}} \qquad S - 8$$

where \dot{V}_{w} [m³/s] is the volume flow rate of water, D [m] is the pore diameter, Π_{H} and Π_{L} [Pa] are the osmotic pressures on the high and low osmotic pressure sides, respectively, η [Pa s] is the viscosity, δ [m] is the slip length, and Lₕ [m] is the hydrodynamic membrane length. The values of η, δ, and Lₕ in Equation S-8 vary with pore diameter as:

$${L}_{h} ( D ) = 0.27 ( \frac{D}{2} ) + 0.95 \times {10}^{- 9} m \qquad S - 9$$

$$δ ( D ) = \frac{1.517 \times {10}^{- 19} {m}^{2}}{D / 2} + 0.205 \times {10}^{- 9} m \qquad S - 10$$

$$η ( D ) = \frac{8.47 \times {10}^{- 13} Pa s m}{D / 2} + 0.00085 Pa s \qquad S - 11$$

Neglecting the effects of flow through a pore on that through surrounding pores, the total flow rate of water through graphene pores is found by summing the contributions to flow through each pore. The average volume flow rate through a graphene pore, [symbol] V [symbol] [m³/m²s], is thus calculated as:

$$〈 {\dot{V}}_{w} 〉 = {ρ}_{pore} A {\int }_{{D}_{w}}^{∞} {\dot{V}}_{w} ( D ) P ( D ) dD \qquad S - 12$$

where D_{w} is the van der Waals diameter of a water molecule (0.28 nm). In Equation S-12, pores smaller than the diameter of a water molecule are excluded, approximating them as being impermeable. Note also that in the integral above, \dot{V}_{w} depends on η, δ, and Lₕ, which all depend on pore diameter.

Both flow through pores in graphene and leakage around the graphene contribute to the total water flow rates presented in FIG. 16. The measured leakage (P+NG+IP in FIG. 16) is added to the modeled water flow rate through graphene to calculate the total water flow rate model curves presented in FIG. 16.

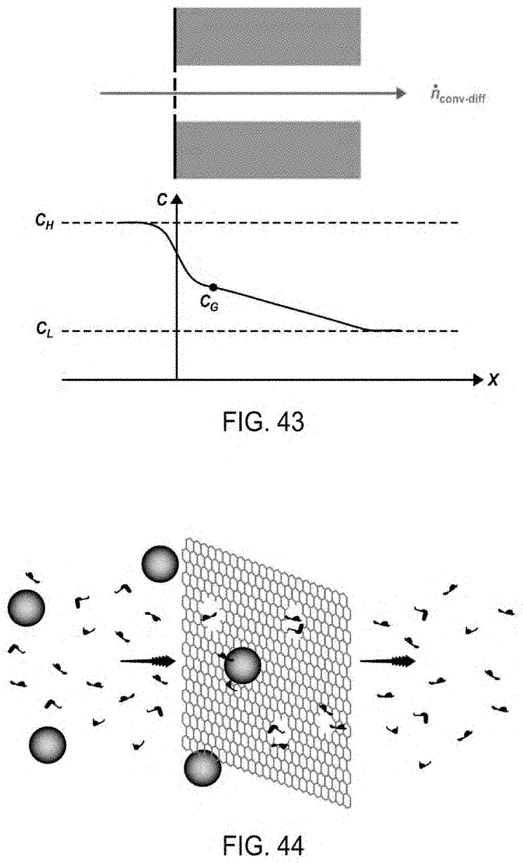

Solute convection-diffusion. When an osmotic pressure difference is used to draw water across the graphene membrane from a side with higher solute concentration to a side with lower solute concentration, the solute has both diffusive and convective contributions to transport across the graphene pores. The concentration profile across the membrane (FIG. 43) depends on the relative contributions of convection and diffusion and generally results in a lower concentration gradient being applied across the graphene pores than in purely diffusive flow (c_{H}-c_{G} instead of c_{H}-c_{L}, where c_{G} [mol/m³] is the solute concentration just downstream of the graphene within the polycarbonate track etched membrane pore, as indicated in FIG. 43).

Solute transport is modeled in a similar way to that of prior studies on graphene membranes with similar structure (Jang D et al. ACS Nano 2017, 11 (10), 10042-10052; Suk M E et al. RSC Adv. 2013, 3 (24), 9365-9372). Solute transport through the polycarbonate track etched membrane pores is modeled by the one-dimensional convection-diffusion equation:

$$\frac{{d}^{2} c}{{dx}^{2}} - \frac{U}{𝒟} \frac{d c}{cx} = 0 \qquad S - 13$$

where c [mol/m³] is the solute concentration at a location x [m] from the graphene, within the polycarbonate track etched membrane pore (as shown in FIG. 43), and U [m/s] is the water flow speed in the polycarbonate track etched membrane pore. The boundary conditions are the solute concentration just downstream of the graphene, c(x=0)=c_{G}, and the concentration on the downstream side of the membrane, c(x=L_{PC})=c_{L}. The water flow speed is calculated from Equation S-12 as:

$$U = \frac{〈 {\dot{V}}_{w} 〉}{A} \qquad S - 14$$

Solving Equation S-13 gives an expression for the rate of solute transport, \dot{n}_{conv-diff} [mol/s], within the polycarbonate track etched membrane pore behind the graphene as (Suk M E et al. RSC Adv. 2013, 3 (24), 9365-9372):

$${n}_{conv - diff} = {UAc}_{G} ( 1 - \frac{1}{1 - {e}^{{UL}_{PC} / 𝒟}} ) \qquad S - 15$$

Notice that the flow rate is in terms of the unknown solute concentration just downstream of the graphene, c_{G}. To determine \dot{n}_{conv-diff} and c_{G}, the flow rate through the polycarbonate track etched membrane pores (Equation S-15) is equated to that through the graphene placed in series before the pores. The total solute flow rate through the graphene pores is approximated as being the sum of the convective and diffusive flux through the graphene pores, neglecting their interaction, as done elsewhere (Jang D et al. ACS Nano 2017, 11 (10), 10042-10052; Suk M E et al. RSC Adv. 2013, 3 (24), 9365-9372):

\dot{n}_{conv-diff}= [symbol] \dot{n}_{diff} [symbol] + [symbol] \dot{n}_{conv} [symbol] S-16

where [symbol] \dot{n}_{conv} [symbol] [mol/s] is the average rate of solute transport through graphene pores by convection. The diffusive contribution, [symbol] \dot{n}_{diff} [symbol] , is given by Equation S-6, with the solute concentration on the downstream side (c_{L}) of the membrane replaced with that just downstream of the graphene (c_{G}), since they are no longer the same due to convection within the polycarbonate track etched membrane pore:

$$〈 {\dot{n}}_{diff} 〉 = 𝒟 {ρ}_{pore} A ( {c}_{H} - {c}_{G} ) {\int }_{{D}_{solute}}^{∞} ( D - {D}_{solute} ) P ( D ) dD \qquad S - 17$$

Convective solute transport is approximated using Equation S-12 for the water flow rate through graphene pores. This expression averages the volume flow rate of water through pores of all sizes. As water flows through the pores, it carries the dissolved solute, so the rate of solute convection is approximated as the flow rate of water multiplied by the concentration of solute in the feed solution that it carries. However, solute molecules larger than the pore are assumed to be completely rejected without blocking water flow through those pores, giving:

$$〈 {\dot{n}}_{conv} 〉 = {c}_{H} {ρ}_{pore} A {\int }_{{D}_{solute}}^{∞} {\dot{V}}_{w} ( D ) P ( D ) dD \qquad S - 18$$

where \dot{V}_{w}(D) is still defined by Equation S-8 to Equation S-11, and the lower limit of integration is now Dₛₒₗᵤₜₑ rather than D_{w} as in Equation S-12.

Substituting Equation S-17 and Equation S-18 into Equation S-16 then gives a second expression for the flow rate in terms c_{G}. Equation S-15 and Equation S-16 can be solved numerically for \dot{n}_{conv-diff} and c_{G}. The total solute transport rate, \dot{n}^{solute} [mol/s], is then calculated by adding the measured leakage (P+NG+IP in FIG. 17) to the calculated flow rate from Equation S-16 and Equation S-18. Solute rejection, presented in FIG. 17, is then calculated as:

$$Rejection = 1 - \frac{{\dot{n}}_{solute}}{{c}_{H} AU} \qquad S - 19$$

The main differences between the model used here and that of previous studies (Jang D et al. ACS Nano 2017, 11 (10), 10042-10052; Suk M E et al. RSC Adv. 2013, 3 (24), 9365-9372) are that here (1) a general log-normal pore size distribution is used for averaging diffusive and convective flow rates through graphene, and (2) the solute size is accounted for in calculating [symbol] \dot{n}_{conv} [symbol] by changing the limit of integration in the equation for water flux (Equation S-18), not by changing the effective pore size within the integral.

Fitting to experimental measurements. In the above model, the leakage rates are measured directly in the experiments and published values are used for the solute sizes and diffusivities (Table 5). The input to the model is the pore size distribution parameters, μ and σ, and the pore density, ρₚₒᵣₑ. These parameters depend on the etch time but remain the same for diffusive transport, osmotic flow, and osmotically driven solute transport. For each etch time, diffusion of four solute molecules, water flow rates by osmosis, and the osmotically driven transport of four solute molecules were measured. A numerical least squares optimization was used to select μ, σ, and ρₚₒᵣₑ to match the model equations to these nine measurements.

Only those pores with size greater than D_{w} affect the results. The areal density of pores larger than this size (ρₚₒᵣₑ,D>D_{w}) obtained from the model fit are given in Table 1. The value at an etch time of 25 min of 8.1×10¹² cm⁻² is in reasonable agreement with the value measured by STEM of 6.3×10² cm⁻² for that etch time.

The model fit is compared to measurements of diffusive solute flux in FIG. 12, osmotic water flow in FIG. 16, and solute advection-diffusion in FIG. 17 and FIG. 19. The magnitudes and trends of flow rates by all three transport modes are reasonably well explained by the model. The model is based on the membrane structure and expected transport pathways inferred from the membrane characterization and has only the pore size distribution and density as inputs. Hence, this simple transport model corroborates the proposed membrane structure and proposed transport mechanisms. It shows that the three different modes of transport measured can all be explained by a single pore size distribution. The comparison to measurements further validates the model, which could serve as a tool for predicting the sensitivity of membrane performance to different parameters to direct future development efforts.

### Example 2—Nanoporous Atomically Thin Graphene Membranes for Desalination and Water Purification Applications

This research proposal aims to develop nanoporous atomically thin graphene membranes for desalination and water purification applications. Graphene, a single atom thick material, represents the thinnest possible barrier and is impermeable to the smallest molecule (He gas). The introduction of nanoscale vacancy defects in the atomically thin graphene lattice can enable the creation of a new kind of nanoporous atomically thin membrane (NATM), which allows for size-selective transport. Such graphene based nanoporous atomically thin membranes can potentially offer extremely high selectivity and minimal resistance to flow thereby, significantly reducing costs and increasing energy efficiency of desalination and water purification processes.

The proposed research addresses the main challenges in the synthesis of graphene nanoporous atomically thin membranes, i.e. the creation of a narrow size distribution of nanoscale vacancy defects in the atomically thin graphene lattice using scalable processes and selective sealing of large defects. Specifically, the development of scalable nanopore creation techniques such as 1) ultraviolet (UV) oxidative etching, 2) pulsed oxygen plasma etching in conjunction with 3) size-selective interfacial polymerization processes as platform technologies will be explored to demonstrate centimeter scale graphene nanoporous atomically thin membranes for desalination and water purification applications. The performance of the synthesized nanoporous atomically thin membranes will be evaluated for water, ion, and molecular transport using diffusion driven flow, pressure driven flow, and osmotic pressure driven flow experiments. The synthesized nanopores will be characterized using atomic resolution scanning transmission electron microscopy (STEM).

The proposed research develops approaches to desalinate or purify water in a way that reduces primary energy use, thereby lowering the cost of desalination and/or water purification. The research also advances membrane technology for desalination and water purification.

Current state of desalination technologies. In the past few decades, water scarcity has emerged as a severe global problem impacting the lives of ˜1.2 billion people (˜⅕th of the world's population) (Elimelech M et al. Science 2011, 333, 712-717). Population growth coupled with i) industrialization and concentration of populations in urban areas/cities, ii) over-utilization of ground water, iii) contamination of fresh water reserves, and iv) climate change induced variations in precipitation patterns has greatly exacerbated the situation (Elimelech M et al. Science 2011, 333, 712-717). A Water Resources Institute analysis recently found that ˜2.3 billion people (41% of the world's population) currently live in water-stressed regions (Service RF. Science 2006, 313, 1088-1090) and this figure is expected to reach ˜3.5 billion by 2025 as the use of fresh water increases at approximately twice the rate of population growth (Elimelech M et al. Science 2011, 333, 712-717).

Even though water covers ˜71% of the earth's surface, the majority of the earth's water (˜96%) is in the form of salt water held in oceans and fresh water found in glaciers, groundwater; lakes and rivers account for only ˜2.5%. These fresh water resources are un-evenly distributed across the world, resulting in arid regions experiencing a chronic shortfall of fresh water. Additionally, the ground water in many regions of the world is brackish or contaminated, rendering it somewhat less useable. For example, in the U.S., fracking and drilling chemicals have contaminated ground water in several sites in Pennsylvania, Ohio, West Virginia and Texas (Elimelech M et al. Science 2011, 333, 712-717; Service RF. Science 2006, 313, 1088-1090). In this context, desalination and water purification has generated tremendous interest to help alleviate water scarcity by increasing the amount of water available without affecting the natural ecosystem and hydrological cycle (Elimelech M et al. Science 2011, 333, 712-717).

Interest in large-scale desalination and water purification originated in oil-rich, water-stressed middle-eastern countries such as Saudi Arabia (Elimelech M et al. Science 2011, 333, 712-717; Service RF. Science 2006, 313, 1088-1090). Early desalination technologies used energy from burning oil for thermal desalination of seawater, i.e. evaporation of water to leave behind salt and condensation of water vapor yielded fresh-water (Elimelech M et al. Science 2011, 333, 712-717; Service RF. Science 2006, 313, 1088-1090). However, the energy intensity of thermal desalination makes it less attractive for countries without abundant and cheap energy reserves (Elimelech M et al. Science 2011, 333, 712-717; Service RF. Science 2006, 313, 1088-1090). Membrane based processes such as reverse osmosis (RO) have been found to be more effective for large-scale water purification, and particularly desalination, with an energy consumption ˜10 times lower than thermal desalination (Elimelech M et al. Science 2011, 333, 712-717; Service RF. Science 2006, 313, 1088-1090). In reverse osmosis, water is pushed across a semipermeable membrane while dissolved salt or chemical contaminants are blocked, yielding fresh water (Elimelech M et al. Science 2011, 333, 712-717; Service RF. Science 2006, 313, 1088-1090). Although reverse osmosis still requires water to be pumped to high pressures, technological advances over the last decades have resulted in reverse osmosis emerging as the dominant method of water desalination and purification, with the energy requirement to produce 1 m³ of fresh water approaching ˜1.8-2.5 kWh of electricity (Elimelech M et al. Science 2011, 333, 712-717; Service RF. Science 2006, 313, 1088-1090). In 2016, total installed reverse osmosis based desalination capacity was projected to produce ˜38 billion m³/yr of clean water, reinforcing reverse osmosis as the most efficient and preferred technology for desalination and water purification (Elimelech M et al. Science 2011, 333, 712-717; Service RF. Science 2006, 313, 1088-1090).

The minimum theoretical energy required to separate salt from sea water is equal to the free energy of mixing (assuming a reversible thermodynamic process) (Elimelech M et al. Science 2011, 333, 712-717; Service RF. Science 2006, 313, 1088-1090), which is related to osmotic pressure by:

−d(ΔG_{mixing})=dn_{w}V_{w}πₛ

where ΔG_{mixing} is the free energy of mixing, n_{w} is the number of moles of water, V_{w} is the molar volume of water and πₛ is the osmotic pressure of seawater (Elimelech M et al. Science 2011, 333, 712-717; Service RF. Science 2006, 313, 1088-1090). This relationship implies a pressure equal to the osmotic pressure is needed to drive a differential volume of water across the reverse osmosis membrane in a thermodynamically reversible process (Elimelech M et al. Science 2011, 333, 712-717; Service RF. Science 2006, 313, 1088-1090). In practice, the energy consumption in reverse osmosis is typically much higher (˜3-4 times higher) than the theoretical minimum energy required since a) desalination plants are not operated at thermodynamic equilibrium, b) the membranes used are of a finite size (to limit capital costs), and c) over-pressures beyond the osmotic pressure are applied to obtained reasonable flux (process throughput) from the finite size membrane (Elimelech M et al. Science 2011, 333, 712-717; Service RF. Science 2006, 313, 1088-1090).

Hence, the permeability of the membrane used in reverse osmosis will determine the amount of over-pressure needed (additional to the osmotic pressure) to obtain adequate water flux (Elimelech M et al. Science 2011, 333, 712-717; Service RF. Science 2006, 313, 1088-1090). Membranes with higher permeability will also aid in reducing membrane area and capital cost, but operating pressure (over the osmotic pressure) will primarily determine the energy required to pump seawater in reverse osmosis processes (Elimelech M et al. Science 2011, 333, 712-717; Service RF. Science 2006, 313, 1088-1090). Additionally, effective water pretreatment before reverse osmosis will also help reduce the overall desalination/water purification process cost (Elimelech M et al. Science 2011, 333, 712-717; Service RF. Science 2006, 313, 1088-1090).

The present state-of-the-art reverse osmosis membranes have ˜100 nm thin polyamide selective layers as part of a composite thin film membrane (Elimelech M et al. Science 2011, 333, 712-717; Service RF. Science 2006, 313, 1088-1090). The mechanism of transport in these reverse osmosis membranes is solution diffusion where separation occurs in the ˜100 nm thin selective layer and diffusion further down a concentration gradient (Elimelech M et al. Science 2011, 333, 712-717; Service RF. Science 2006, 313, 1088-1090). The main drawback with present reverse osmosis membranes is that permeability increase is typically accompanied with a decrease in selectivity and the membrane design is largely empirical, i.e. trial and error optimization (Elimelech M et al. Science 2011, 333, 712-717; Service RF. Science 2006, 313, 1088-1090). Further, treatment with chloride/other oxidants to prevent biological fouling from marine organisms is challenging since polyamide is susceptible to attack at the amide linkages (Elimelech M et al. Science 2011, 333, 712-717; Service RF. Science 2006, 313, 1088-1090). Several research efforts have focused on making ultra-high permeability membranes which can reduce the pressure for operation and capital costs with more compact modules (Elimelech M et al. Science 2011, 333, 712-717; Service RF. Science 2006, 313, 1088-1090) by two main approaches: i) developing materials such as polymers (Sanders D F et al. Polymer (Guildf). 2013, 54, 4729-4761), nanomaterials (Kim W et al. Chem. Eng. Sci. 2013, 104, 908-924), carbon nanotubes (CNTs) (Brady-Estévez A S et al. Small 2008, 4, 481-484), zeolites (Varoon K et al. Science (80-.). 2011, 334, 72-75), metal organic frameworks (MOFs) (Li B et al. Adv. Mater. 2017, U.S. Pat. Nos. 1,704,210, 1,704,210; Qiu S et al. Chem. Soc. Rev. 2014, 43, 6116-6140), ceramics (Goh P S et al. Desalination 2018, 434, 60-80), or ii) designing tailored structures including ultra-thin (Xu W L et al. Nano Lett. 2017, 17, 2928-2933; Karan S et al. Science (80-.). 2015, 348, 1347-1351) or highly-ordered (Feng X et al. ACS Nano 2016, 10, 150-158; Feng X et al. ACS Nano 2014, 8, 11977-11986; Warkiani M E et al. ACS Nano 2013, 7, 1882-1904) selective layers (Wang L et al. Nat. Nanotechnol. 2017, 12, 509-522; Prozorovska L et al. Adv. Mater. 2018, 1801179).

Nanoporous atomically thin membranes (NATMs). Atomically thin two-dimensional (2D) materials such as graphene (a single layer of graphite), hexagonal boron nitride (h-BN) and others, represent the absolute minimum material thickness (Geim A K et al. Nat. Mater. 2007, 6, 183-191) and in their pristine form have been shown to be impermeable barriers to even the smallest molecule (He gas) but allow for proton transport (Wang L et al. Nat. Nanotechnol. 2017, 12, 509-522; Prozorovska L et al. Adv. Mater. 2018, 1801179; Bunch J S et al. Nano Lett. 2008, 8, 2458-2462; Hu S et al. Nature 2014, 516, 227-230). The introduction of precise nanoscale vacancy defects in the 2D material lattice can enable the realization of nanoporous atomically thin membranes (NATMs) (Meyer J C et al. Nano Lett. 2008, 8, 3582-3586; Meyer J C et al. Nano Lett. 2009, 9, 2683-2689; Liu K et al. Nano Lett. 2017, 17, 4223-4230; Surwade S P et al. Nat. Nanotechnol. 2015, 10, 459-464; Gilbert S M et al. Sci. Rep. 2017, 1, 4-8), where the defect size could, in principle, be tuned to address a diverse range of separation processes (FIG. 44) (Wang L et al. Nat. Nanotechnol. 2017, 12, 509-522; Prozorovska L et al. Adv. Mater. 2018, 1801179). Separation in nanoporous atomically thin membranes primarily occurs via molecular sieving (Wang L et al. Nat. Nanotechnol. 2017, 12, 509-522; Prozorovska L et al. Adv. Mater. 2018, 1801179). Such nanoporous atomically thin membranes with atomic thickness, high mechanical strength (Booth T J et al. Nano Lett. 2008, 8, 2442-2446; Wang L et al. Nano Lett. 2017, 17, 3081-3088) and chemical resistance, potentially offer the possibility of realizing membranes that simultaneously offer i) high permeance, ii) high selectivity, and iii) excellent robustness to chloride based chemical cleaning agents to prevent biological fouling (Wang L et al. Nat. Nanotechnol. 2017, 12, 509-522; Prozorovska L et al. Adv. Mater. 2018, 1801179)

This research aims to develop graphene based nanoporous atomically thin membranes with high selectivity and permeability for desalination and water purification applications thereby, allowing for a reduction in cost and energy for these processes.

Background literature on nanoporous atomically thin membranes. Many theoretical and computational works have investigated gas, ionic, molecular and water transport across nanopores in atomically thin 2D materials for membrane applications, and experimental studies are rapidly emerging (Wang L et al. Nat. Nanotechnol. 2017, 12, 509-522; Prozorovska L et al. Adv. Mater. 2018, 1801179).

For example, Bunch et al. demonstrated the impermeability of micron sized pristine graphene membranes to the smallest molecule He (Bunch J S et al. Nano Lett. 2008, 8, 2458-2462; Wang L et al. Nat. Nanotechnol. 2017, 12, 509-522; Prozorovska L et al. Adv. Mater. 2018, 1801179). Subsequently, Koenig et al. demonstrated molecular sieving of gases (H₂, CO₂, Ar, N₂, CH₄, and SF₆) through sub-nanometer pores introduced via UV based oxidative etching of ˜5 μm diameter mono- and bilayer graphene membranes (Wang L et al. Nat. Nanotechnol. 2017, 12, 509-522; Prozorovska L et al. Adv. Mater. 2018, 1801179; Koenig S P et al. Nat. Nanotechnol. 2012, 7, 728-732). The size of the etched nanopores in these studies was estimated from the kinetic diameter of the smallest molecule that did not permeate though, e.g. ˜3.4 Å pore size was estimated for pores that allowed transport of H₂ and CO₂ but not Ar or N₂, and ˜4.9 Å pore size was estimated for pores that allowed transport of H₂, CO₂, Ar, N₂ and CH₄ but not SF₆ (Wang L et al. Nat. Nanotechnol. 2017, 12, 509-522; Prozorovska L et al. Adv. Mater. 2018, 1801179; Koenig S P et al. Nat. Nanotechnol. 2012, 7, 728-732). Additionally, gas transport across sub-nanometer pores introduced into monolayer graphene membranes via UV-induced oxidative etching showed a decrease in permeance with increasing kinetic diameter of gas molecules (He, Ne, H₂, and Ar), indicating molecular sieving as the mechanism of transport (Wang L et al. Nat. Nanotechnol. 2017, 12, 509-522; Prozorovska L et al. Adv. Mater. 2018, 1801179; Koenig S P et al. Nat. Nanotechnol. 2012, 7, 728-732). These experimental studies hence demonstrated the successful creation of nanopores on the length scale of the kinetic diameter of the gas molecules (˜3-5 Å) in the graphene lattice using UV-induced oxidative etching methods (Wang L et al. Nat. Nanotechnol. 2017, 12, 509-522; Prozorovska L et al. Adv. Mater. 2018, 1801179; Koenig S P et al. Nat. Nanotechnol. 2012, 7, 728-732).

Celebi et al. demonstrated ultra-high gas and water vapor permeability through 4 m sized bilayer graphene membranes (Prozorovska L et al. Adv. Mater. 2018, 1801179; Celebi K et al. Science (80-.). 2014, 344, 289-292). Using a focused ion beam they drilled ˜7.6-50 nm sized nanopores in bilayer graphene membranes and reported permeance values ˜10⁻² mol m⁻² s⁻¹ Pa⁻¹, which is almost three orders of magnitude higher than the value for polymeric gas separation membranes with similar selectivity (Prozorovska L et al. Adv. Mater. 2018, 1801179; Celebi K et al. Science (80-.). 2014, 344, 289-292). Specifically, membranes with ˜50 nm pores and 4.7% porosity exhibited water permeance of ˜3·10 m³ m⁻² s⁻¹ Pa⁻¹, almost 3 times higher than current polysulfone ultrafiltration membranes (Prozorovska L et al. Adv. Mater. 2018, 1801179; Celebi K et al. Science (80-.). 2014, 344, 289-292), while membranes with ˜400 nm pores and porosities ˜3.6-11.5% showed very high water vapor permeances indicating their potential as ultrathin breathable waterproof membranes (Prozorovska L et al. Adv. Mater. 2018, 1801179; Celebi K et al. Science (80-.). 2014, 344, 289-292). The researchers however noted that water transport was blocked in the presence of air on the other side of the graphene membrane (Prozorovska L et al. Adv. Mater. 2018, 1801179; Celebi K et al. Science (80-.). 2014, 344, 289-292).

Surwade et al. investigated water transport through nanoporous graphene for desalination applications (Prozorovska L et al. Adv. Mater. 2018, 1801179; Surwade S P et al. Nat. Nanotechnol. 2015, 10, 459-464). Here, the researchers used oxygen plasma to create nanopores with ˜10¹² cm⁻² density and observed salt rejection during pervaporation of water across ˜5 μm diameter monolayer graphene membranes (Prozorovska L et al. Adv. Mater. 2018, 1801179; Surwade S P et al. Nat. Nanotechnol. 2015, 10, 459-464). Specifically, with only one side of graphene membrane wetted, the researchers observed water permeation with fluxes ˜1×10⁶ gm⁻² s⁻¹ and ˜100% rejection of salt ions (K⁺, Na⁺, Li⁺, Cl⁻) at 40° C. (Prozorovska L et al. Adv. Mater. 2018, 1801179; Surwade S P et al. Nat. Nanotechnol. 2015, 10, 459-464). These experiments demonstrated the suitability of oxygen plasma based etching techniques to form nanopores in the graphene lattice for desalination applications albeit over micron scale membrane areas (Prozorovska L et al. Adv. Mater. 2018, 1801179; Surwade S P et al. Nat. Nanotechnol. 2015, 10, 459-464).

Membranes using flakes of graphene oxide (GO) and graphene have been synthesized (Joshi R K et al. Science (80-.). 2014, 343, 752-754; Kim H W et al. Science (80-.). 2013, 342, 91-95; Lin L C et al. Nat. Commun. 2015, 6, 8335; Zhang Y et al. Environ. Sci. Technol. 2015, 49, 10235-10242) for desalination and water purification applications (Wang L et al. Nat. Nanotechnol. 2017, 12, 509-522; Prozorovska L et al. Adv. Mater. 2018, 1801179; Abraham J et al. Nat. Nanotechnol. 2017, 12, 546-550; Seo D H et al. Nat. Commun. 2018, 9, 683; Cohen-Tanugi D et al. Nano Lett. 2016, 16, 1027-1033; Cohen-Tanugi D et al. Nano Lett. 2014, 14, 6171-6178; Cohen-Tanugi D et al. Nano Lett. 2012, 12, 3602-3608). However, transport in such randomly stacked flakes based multi-layer membranes occurs between multiple layers and also via defects in the randomly stacked flakes (Wang L et al. Nat. Nanotechnol. 2017, 12, 509-522; Prozorovska L et al. Adv. Mater. 2018, 1801179). Thus, transport in membranes assembled from flakes of graphene/graphene oxide is inherently linked to the assembly of the flakes, and achieving uniformity/reproducibility in stacking of flakes while producing large-area membranes is non-trivial (Wang L et al. Nat. Nanotechnol. 2017, 12, 509-522; Prozorovska L et al. Adv. Mater. 2018, 1801179). In this context, nanoporous atomically thin membranes offer superior control over transport via nanopores in a single, continuous atomically thin layer thereby enabling high permeability and selectivity (Wang L et al. Nat. Nanotechnol. 2017, 12, 509-522; Prozorovska L et al. Adv. Mater. 2018, 1801179). However, the fabrication of nanoporous atomically thin membranes is somewhat more challenging than composite membranes made from randomly stacked graphene/graphene oxide flakes (Wang L et al. Nat. Nanotechnol. 2017, 12, 509-522; Prozorovska L et al. Adv. Mater. 2018, 1801179).

Graphene synthesis and development of nanoporous atomically thin membranes. Experimental work on atomically thin membranes with 2D material has primarily focused on micron scale areas (Wang L et al. Nat. Nanotechnol. 2017, 12, 509-522; Surwade S P et al. Nat. Nanotechnol. 2015, 10, 459-464; Koenig S P et al. Nat. Nanotechnol. 2012, 7, 728-732; Jain T et al. Nat. Nanotechnol. 2015, 10, 1053-1057). However, advances have been made in fabricating centimeter-scale graphene membranes for dialysis applications (Kidambi P R et al. Adv. Mater. 2017, 29, 1700277), atomically thin gas barriers (Kidambi P R et al. Nanoscale 2017, 9, 8496-8507), single crystalline graphene membranes (Kidambi P R et al. Adv. Mater. 2017, 29, 1605896), molecular sieving of gases (Boutilier M S H et al. ACS Nano 2017, 11, 5726-5736), pressure testing of nanoporous graphene up to 100 bar (Wang L et al. Nano Lett. 2017, 17, 3081-3088), approaches for nanoporous atomically thin membrane manufacturing with roll-to-roll graphene synthesis via chemical vapor deposition (CVD) combined with polymer support casting (Kidambi P R et al. ACS Appl. Mater. Interfaces 2018, 10, 10369-10378), and bottom-up nanopore creation techniques during CVD (Kidambi P R et al. Adv. Mater. 2018, U.S. Pat. Nos. 1,804,977, 1,804,977).

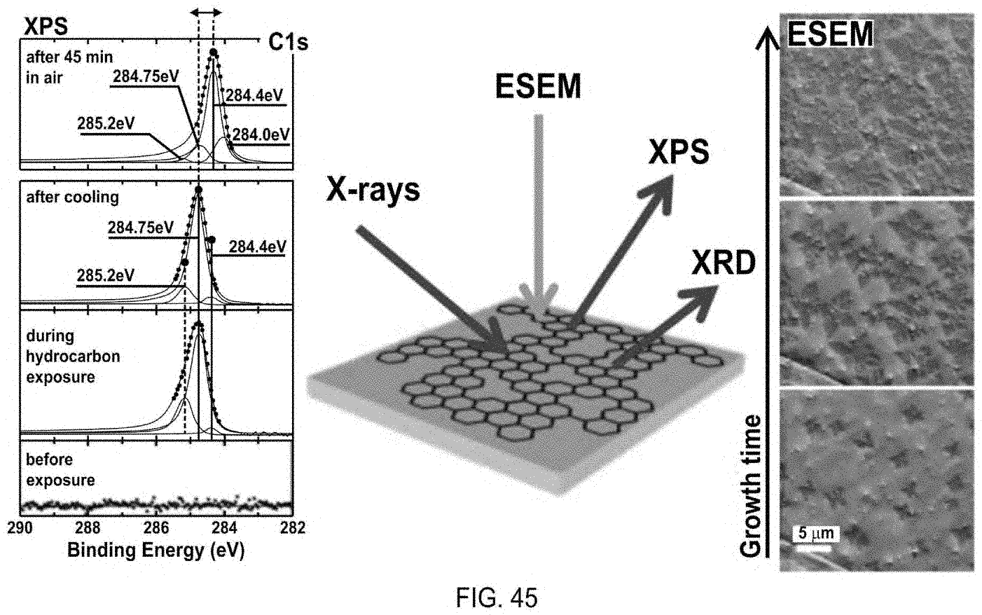

Complementary in-situ X-ray photoelectron spectroscopy (XPS), in-situ X-ray diffraction (XRD), and in-situ environmental scanning electron microscopy (ESEM) to study of graphene and h-BN synthesis via CVD at ˜1000° C. on sacrificial polycrystalline Cu foils (FIG. 45) has been reported (Kidambi P R et al. Chem. Mater. 2014, 26, 6380-6392; Kidambi P R et al. Nano Lett. 2013, 13, 4769-4778). These time and process resolved in-situ experiments were the first of their kind in the field (post growth ex-situ characterization has been the norm) and offered insights into growth mechanisms by allowing for continuous monitoring of the catalyst surface morphology, surface chemistry, bulk crystallography, and gaseous species during the entire CVD process (Kidambi P R et al. Chem. Mater. 2014, 26, 6380-6392; Kidambi P R et al. Nano Lett. 2013, 13, 4769-4778). These observations helped resolve several conflicting literature reports on growth mechanisms, graphene interaction with the substrate (n-doping) during growth, oxygen intercalation after growth. and elucidated the role of oxygen during graphene growth, i.e. its effect on epitaxy, weak mis-match epitaxy, aligned vs. random domains within Cu grains (Kidambi P R et al. Nano Lett. 2013, 13, 4769-4778; Blume R et al. Phys. Chem. Chem. Phys. 2014, 16, 25989-26003).

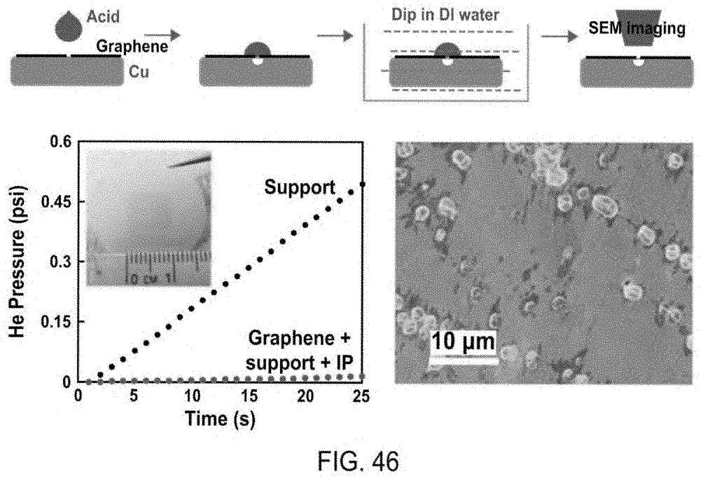

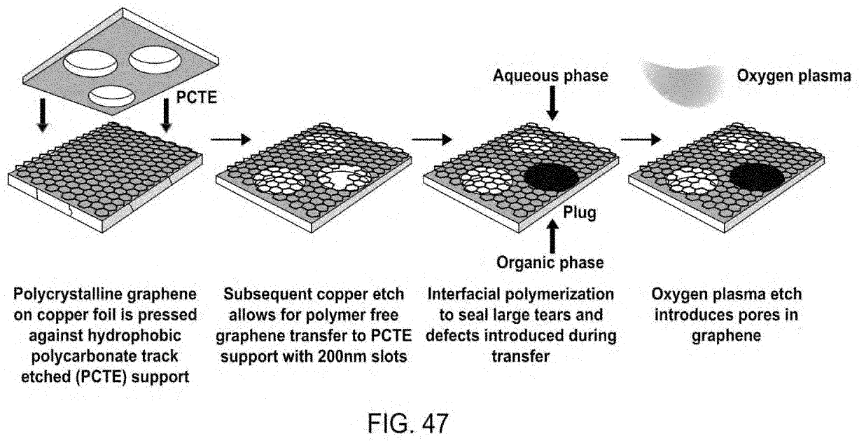

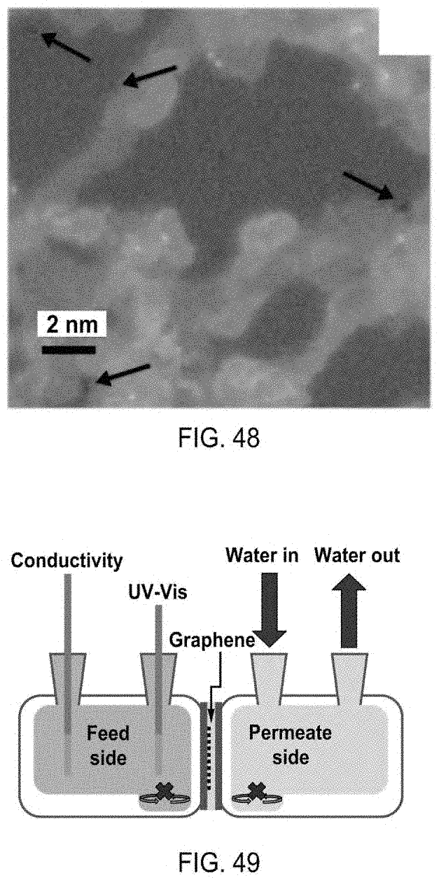

Using insights from complementary in-situ study, a simple, cost effective, high throughput method was developed to characterize the quality of as-grown CVD graphene on Cu for membrane and atomically thin barrier applications (Kidambi P R et al. Nanoscale 2017, 9, 8496-8507). A drop of acid placed on as-grown CVD graphene on Cu is used to form etch pits only in areas where the graphene is defective (FIG. 46). These pits can be imaged and analyzed to quantify defect density and spacing. A time dependent model is used to predict/calculate the original defect size in graphene from etch pit size and shows excellent agreement with diffusion-driven transport measurements across the graphene membrane (Kidambi P R et al. Nanoscale 2017, 9, 8496-8507). The validation of the etch test method allowed for an effective feedback loop to navigate the large parameter space for CVD and helped to arrive at benchmark standards for the quality of atomically thin materials for barrier and membrane applications which are significantly different than electronics (Kidambi P R et al. Nanoscale 2017, 9, 8496-8507). Large-area (cm²) atomically thin membranes, fabricated by transferring the optimized CVD graphene on Cu to polycarbonate track etched (PCTE) supports, showed the complete absence of nanometer-scale defects but sub-50 nm defects associated primarily with wrinkles in graphene were observed (Kidambi P R et al. Nanoscale 2017, 9, 8496-8507). By selectively sealing (FIG. 47-FIG. 50) these large tears/damages via interfacial polymerization (O'Hern S C et al. Nano Lett. 2015, 15, 3254-3260) (monomer precursors introduced on opposite sides of a membrane meet and react only at sites of defects forming polymer seals/plugs), centimeter-scale atomically thin gas barriers which show <2% mass transport for He (FIG. 46) and ˜1 nm Allura Red dye compared to the polycarbonate track etched support were demonstrated (Kidambi P R et al. Nanoscale 2017, 9, 8496-8507).

Having established quality metrics for membrane applications, facile and scalable processes were developed for the fabrication of large area graphene based nanoporous atomically thin membranes for dialysis, de-salting, and small molecule separation applications (FIG. 47-FIG. 50) (Kidambi P R et al. Adv. Mater. 2017, 29, 1700277). Here, CVD graphene grown on Cu foil was transferred to polycarbonate track etched supports with ˜200 nm vertically aligned pores (Kidambi P R et al. Adv. Mater. 2017, 29, 1700277). After sealing large tears/damages which were introduced during transfer/handling by interfacial polymerization (nylon 6,6 plugs) (O'Hern S C et al. Nano Lett. 2015, 15, 3254-3260), a facile oxygen plasma etch is used to create size selective nanopores in CVD graphene. These nanoporous atomically thin membranes showed size selective transport of KCl (˜0.66 nm)>L-Tryptophan (˜0.7-0.9 nm)>Allura Red dye (˜1 nm)>Vitamin B12 (˜1-1.5 nm) while completely blocking Lysozyme (˜3.8-4 nm) (Kidambi P R et al. Adv. Mater. 2017, 29, 1700277). Interestingly, the nanoporous atomically thin membranes offered ˜1-2 orders of magnitude increase in permeance compared to state-of-the-art dialysis membranes (Kidambi P R et al. Adv. Mater. 2017, 29, 1700277). Rapid diffusion along with good selectivity in nanoporous atomically thin membranes offers transformative opportunities in drug purification, removal of residual reactants, biochemical analytics, medical diagnostics, therapeutics, and bio-nano separations (Kidambi P R et al. Adv. Mater. 2017, 29, 1700277). This work was the first demonstration of fully functional centimeter scale nanoporous atomically thin membrane from graphene—separating salts from small molecules in 7 ml volume, which is already applicable for small scale laboratory separations (Kidambi P R et al. Adv. Mater. 2017, 29, 1700277).

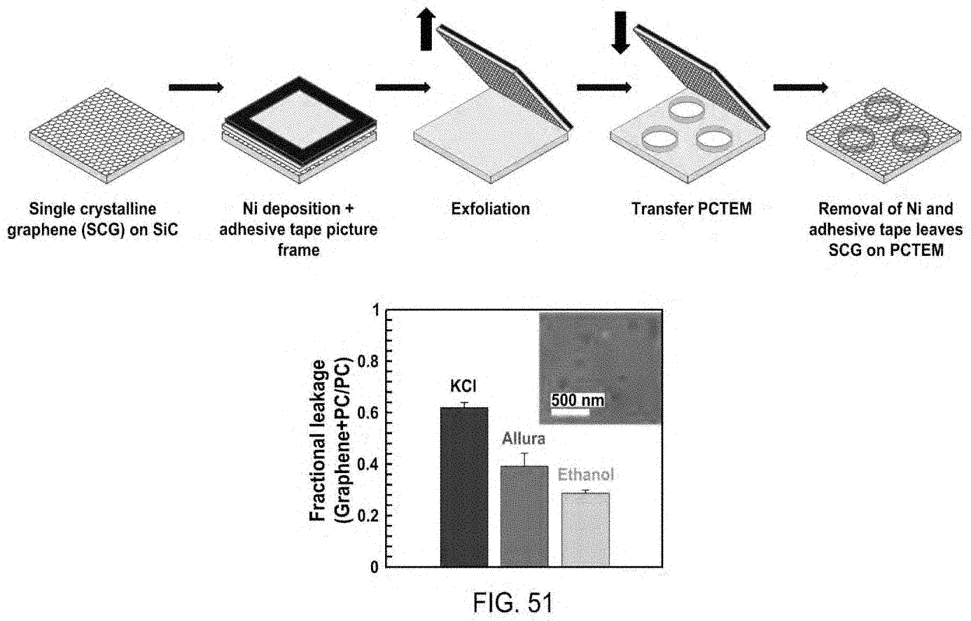

A method to probe nanoscale mass transport across large-area (cm²) single crystalline graphene membranes was also developed (Kidambi P R et al. Adv. Mater. 2017, 29, 1605896). A polymer-free picture frame assisted technique, coupled with a stress-inducing nickel (Ni) layer, was used to transfer single crystalline graphene grown on silicon carbide (SiC) substrates to flexible polycarbonate track etched membrane supports with well-defined cylindrical ˜200 nm pores (FIG. 51) (Kidambi P R et al. Adv. Mater. 2017, 29, 1605896). Diffusion-driven flow showed selective transport of ˜0.66 nm hydrated K⁺ and Cl⁻ ions over ˜1 nm Allura red dye, indicating the presence of selective sub-nanometer to nanometer sized defects. This provided a framework to test the intrinsic quality of atomically thin materials at the sub-nanometer to nanometer scale over technologically relevant large-areas, and suggests the potential use of intrinsic vacancy defects in atomically thin materials for molecular separations (Kidambi P R et al. Adv. Mater. 2017, 29, 1605896).

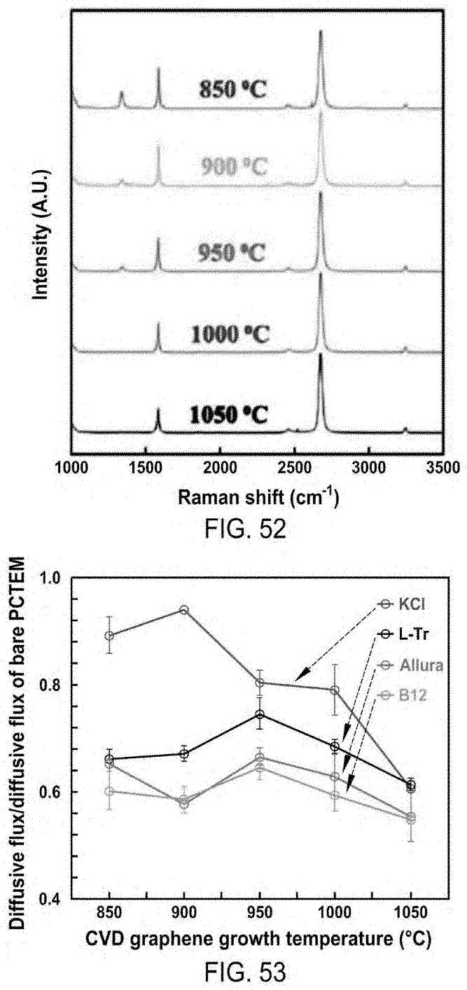

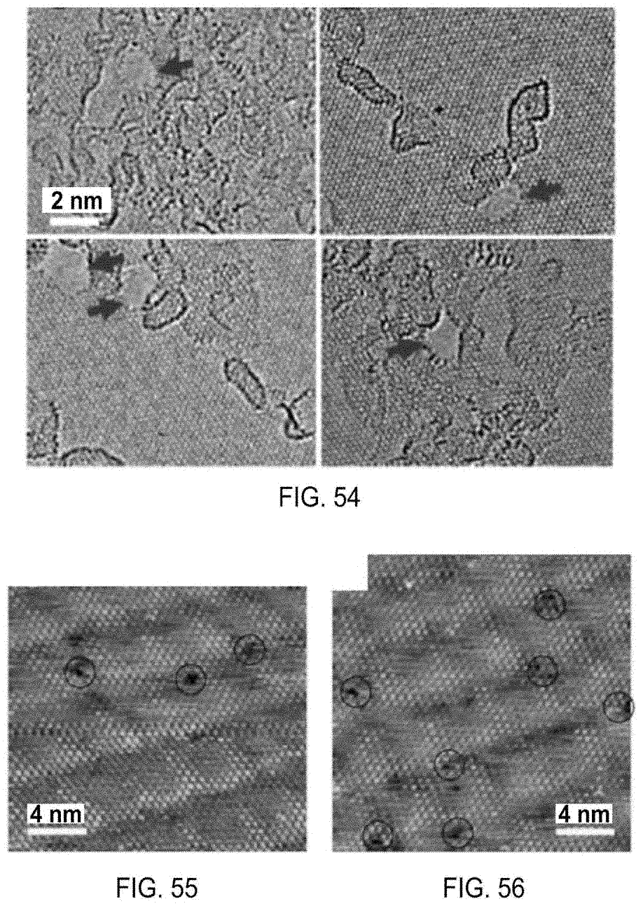

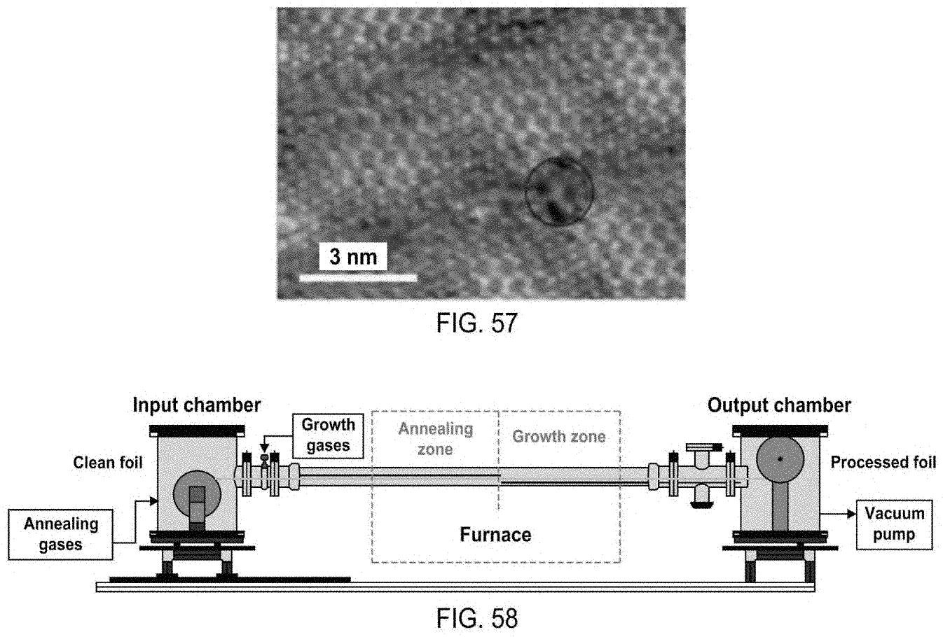

Molecular sieving of gases (He and SF₆) across centimeter scale graphene membranes was also demonstrated by transferring graphene on to anodized alumina supports (Boutilier M S H et al. ACS Nano 2017, 11, 5726-5736). The 20 nm pores of the anodic alumina supports offered adequate resistance to non-selective flow from leakage across large tears in the graphene (Boutilier M S H et al. ACS Nano 2017, 11, 5726-5736). Further, it was shown that nanoporous graphene membranes, when adequately supported, e.g. on polycarbonate track etched membranes with ˜200 nm pores, can withstand up to 100 bar of pressure, indicating their potential for the most pressure driven separation applications (Wang L et al. Nano Lett. 2017, 17, 3081-3088). More recently, bottom-up techniques were developed to directly synthesize nanopores <2-3 nm in monolayer graphene during CVD growth (FIG. 52-FIG. 57) for membrane applications (Kidambi P R et al. Adv. Mater. 2018, U.S. Pat. Nos. 1,804,977, 1,804,977). In this approach, a simple reduction in CVD process temperature allows for facile fabrication of nanoporous atomically thin membranes (FIG. 53) for dialysis applications (Kidambi P R et al. Adv. Mater. 2018, U.S. Pat. Nos. 1,804,977, 1,804,977).

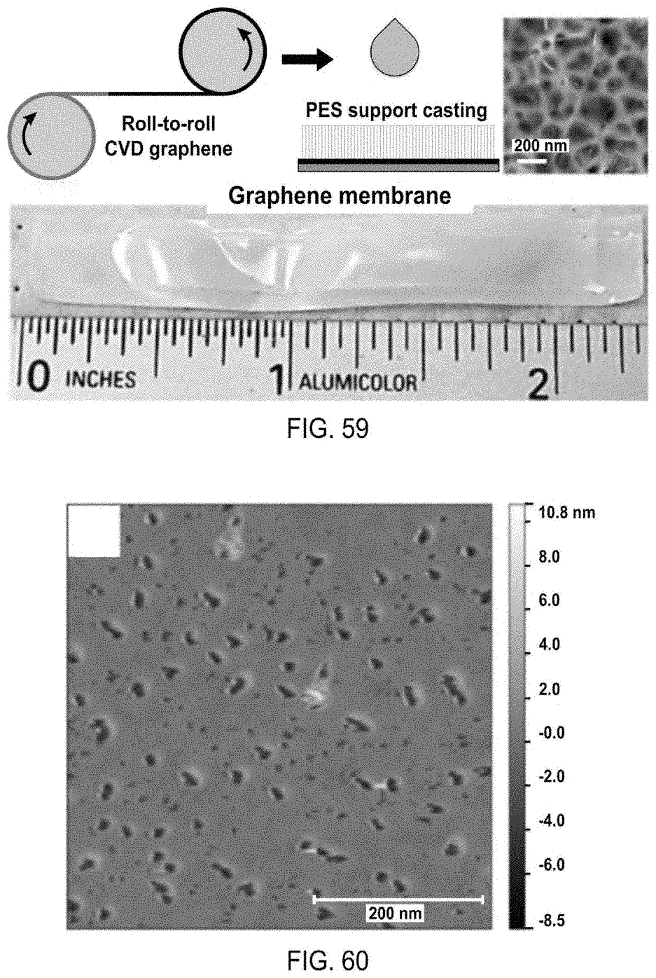

Finally, a scalable manufacturing route was developed for the synthesis of graphene based nanoporous atomically thin membranes by combining roll-to-roll synthesis of graphene via CVD with a hierarchical polymer support casting approach (Kidambi P R et al. ACS Appl. Mater. Interfaces 2018, 10, 10369-10378). Specifically, a customized two zone CVD furnace (FIG. 58) was designed and built to synthesize high quality graphene on Cu foil at speeds up to 5 cm/min in a roll-to-roll process (Kidambi P R et al. ACS Appl. Mater. Interfaces 2018, 10, 10369-10378). Next, a poly-ether sulfone support was cast directly on the synthesized high quality roll-to-roll graphene (Kidambi P R et al. ACS Appl. Mater. Interfaces 2018, 10, 10369-10378). Phase inversion of the poly-ether sulfone in water yielded a hierarchically porous support (˜200-500 nm pores near graphene that branched out to micron sized pores away from graphene) directly on CVD graphene after which the Cu foil was etched away to yield a graphene nanoporous atomically thin membrane (FIG. 59) (Kidambi P R et al. ACS Appl. Mater. Interfaces 2018, 10, 10369-10378). This approach hence demonstrated the feasibility of scalable synthesis of graphene based nanoporous atomically thin membranes (Kidambi P R et al. ACS Appl. Mater. Interfaces 2018, 10, 10369-10378).

To summarize, centimeter-scale graphene based nanoporous atomically thin membranes with sub-nanometer pores were demonstrated for: dialysis applications (Kidambi P R et al. Adv. Mater. 2017, 29, 1700277), atomically thin gas barriers (Kidambi P R et al. Nanoscale 2017, 9, 8496-8507), single crystalline graphene membranes (Kidambi P R et al. Adv. Mater. 2017, 29, 1605896), molecular sieving of gases across centimeter scale graphene membranes (Boutilier M S H et al. ACS Nano 2017, 11, 5726-5736), pressure tolerance of nanoporous graphene membranes up to 100 bar pressure (Wang L et al. Nano Lett. 2017, 17, 3081-3088), bottom-up nanopore formation during CVD (Kidambi P R et al. Adv. Mater. 2018, U.S. Pat. Nos. 1,804,977, 1,804,977), and scalable manufacturing routes for nanoporous atomically thin membranes using roll-to-roll graphene synthesis via chemical vapor deposition (CVD) in combination with polymer support casting (Kidambi P R et al. ACS Appl. Mater. Interfaces 2018, 10, 10369-10378).

Challenges in realizing nanoporous atomically thin membranes for desalination and water purification. The synthesis of nanoporous atomically thin membranes for desalination and water purification requires i) large area membrane quality graphene synthesis, ii) clean transfer of the synthesized graphene (minimal contamination from transfer residue) to suitable porous supports, iii) the introduction of a narrow size distribution of nanopores (defects in the graphene lattice) using scalable, cost-effective processes, and iv) leakage sealing approaches that minimize non-selective transport through damage/tears etc. introduced in graphene during membrane fabrication whilst not sealing the nanopores etched into graphene.

Some of these challenges have indeed been addressed individually for diverse applications, e.g. large-area monolayer graphene synthesis has been demonstrated (Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kobayashi T et al. Appl. Phys. Lett. 2013, 102, 023112). Leakage-sealing methods such as interfacial polymerization (O'Hern S C et al. Nano Lett. 2015, 15, 3254-3260) are scalable since they utilize variants of conventional membrane manufacturing processes (Kidambi P R et al. Adv. Mater. 2018, U.S. Pat. Nos. 1,804,977, 1,804,977). Transfer at large scale including roll-to-roll approaches has been shown (Kidambi P R et al. Adv. Mater. 2018, U.S. Pat. Nos. 1,804,977, 1,804,977; Bae S et al. Nat. Nanotechnol. 2010, 5, 574-578) (albeit with some challenges associated with cleanliness from polymer residue remain) (Kidambi P R et al. Adv. Mater. 2018, U.S. Pat. Nos. 1,804,977, 1,804,977; Rollings R C et al. Nat. Commun. 2016, 7, 11408; Walker M I et al. Appl. Phys. Lett. 2015, 106, 023119), but limited progress on the formation of nanoscale pores over large areas has been achieved with techniques such as lithography (Celebi K et al. Science (80-.). 2014, 344, 289-292), combinations of ion bombardment and acid etch (Boutilier M S H et al. ACS Nano 2017, 11, 5726-5736; O'Hern S C et al. Nano Lett. 2015, 15, 3254-3260; Qin Y et al. ACS Appl. Mater. Interfaces 2017, 9, 9239-9244; O'Hern S C et al. ACS Nano 2012, 6, 10130-10138), oxygen plasma etching (Surwade S P et al. Nat. Nanotechnol. 2015, 10, 459-464; Kidambi P R et al. Adv. Mater. 2017, 29, 1700277; Boutilier M S H et al. ACS Nano 2017, 11, 5726-5736; Zandiatashbar A et al. Nat. Commun. 2014, 5, 3186), and oxide nanoparticle induced etching (Wei G et al. ACS Nano 2017, 11, 1920-1926), among others (Kidambi P R et al. Adv. Mater. 2018, U.S. Pat. Nos. 1,804,977, 1,804,977; Shvets V. Polymer Masks for Nano-structuring of Graphene, Thesis, TU Denmark, 2017; Wang Z et al. ACS Applied Materials and Interfaces, 2016, 8, 8329-8334; Buchheim J et al. Nanoscale 2016, 8, 8345-8354; Park S et al. Nanotechnology 2014, 25, 014008).

Herein, an aim is to address the above mentioned challenges using a combination of scalable nanopore creation methods and size-selective interfacial polymerization processes. If successful, the proposed advances along with the progress already made in synthesizing nanoporous atomically thin membranes can position this technology for partnership with an industry and enable a path towards commercialization.

Priorities being addressed in this proposal. The proposed research develops approaches to desalinate and/or purify water in a way that reduces primary energy use, thereby lowering the cost of desalination and/or water purification. The research also advances membrane technology for desalination and water purification.

The proposal specifically contributes towards addressing the following points: reduce energy consumption and lower the cost of desalination; improve existing membrane technology; develop and promote innovative desalination technologies; improve pretreatment for membrane desalination; and develop approaches or processes to desalinate water in a way that reduces primary energy use.

Technical approach and project activities. A goal of the proposed research is to develop graphene nanoporous atomically thin membranes for desalination and water purification applications. For desalination, the nanoporous atomically thin membranes should have nanopores that allow for transport of water (water molecule mean Van der Waals diameter ˜0.28 nm) while effectively blocking transport of Cl⁻˜0.66 nm (hydrated ion diameter) and Na⁺˜0.7 nm (hydrated ion diameter) or other un-desired contaminants (Wang L et al. Nat. Nanotechnol. 2017, 12, 509-522). This sharp cut-off requirement represents an extreme challenge in nanotechnology, i.e. nanopore formation with sub-nanometer precision in an atomically thin material. In addition to narrow distribution of nanopores, a high density of nanopores can allow for high permeance (Wang L et al. Nat. Nanotechnol. 2017, 12, 509-522; Prozorovska L et al. Adv. Mater. 2018, 1801179). However, any tears or nanopores larger than 0.66 nm should be effectively sealed, since non-selective leakage across a single large tear can completely compromise membrane selectivity (Wang L et al. Nat. Nanotechnol. 2017, 12, 509-522; Prozorovska L et al. Adv. Mater. 2018, 1801179).

To address these challenges, a well-tested and proven method with high quality CVD graphene transferred on to polycarbonate track etched supports with ˜200 nm pores will be used (FIG. 47) (Kidambi P R et al. Adv. Mater. 2017, 29, 1700277; Kidambi P R et al. Nanoscale 2017, 9, 8496-8507). The well-defined cylindrical geometry of the polycarbonate track etched supports allows for precise transport measurements and the high density of ˜200 nm pores in polycarbonate track etched supports enables thorough characterization of graphene nanoporous atomically thin membranes over centimeter scale (O'Hern S C et al. ACS Nano 2012, 6, 10130-10138; Kidambi P R et al. Adv. Mater. 2017, 29). Next, nanopores will be formed in the graphene lattice by UV induced oxidative etching or pulsed oxygen plasma etching followed by size selective defect sealing (>0.5 nm) via interfacial polymerization to synthesize high performance nanoporous atomically thin membranes.

The performance of the synthesized nanoporous atomically thin membranes will be evaluated for water and ion transport using diffusion-driven flow and using osmotic pressure-driven flow experiments (O'Hern S C et al. Nano Lett. 2015, 15, 3254-3260; O'Hern S C et al. ACS Nano 2012, 6, 10130-10138). Based on the transport measurements, the most promising samples will be characterized using scanning transmission electron microscopy (STEM) to obtain the nanopore size, size distributions and density.

Nanopore creation in graphene membranes by UV induced oxidative etching and/or pulsed oxygen plasma etching. Nanopore (0.3-0.6 nm size range) formation in graphene transferred onto polycarbonate track etched supports (FIG. 46) will be explored by subjecting it to ultraviolet light in the presence of ozone. A) the duration of exposure (from a few seconds to a few hours), b) partial pressure of ozone (from low dilutions ˜1% ozone in Ar to pure ozone), and c) flux of UV-light (by controlling the number of lamps illuminating) will be systematically varied to elucidate the effect on the nanopore size, size-distribution, and density of nanopores.

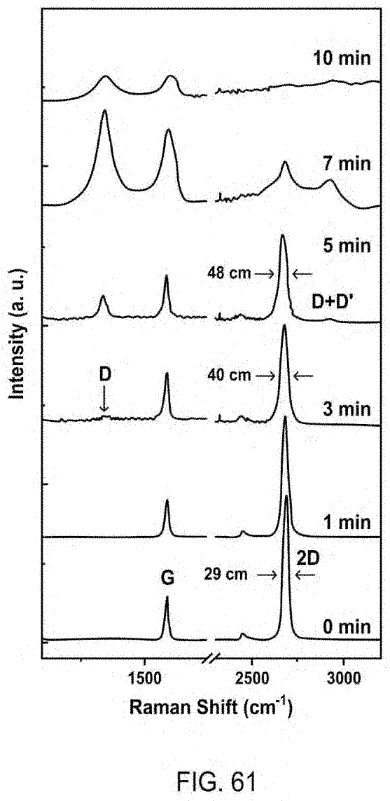

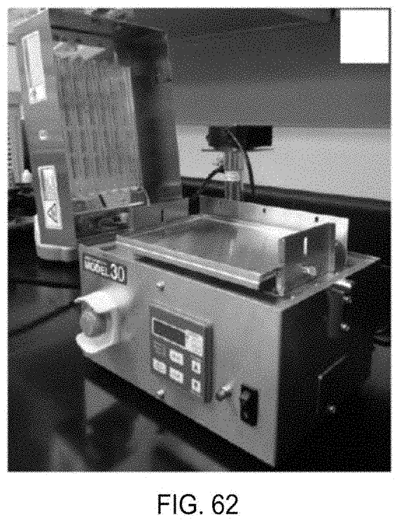

Koenig et al. demonstrated the formation of 0.3-0.5 nm defects in the graphene lattice using UV-induced oxidative etching for gas transport (Koenig S P et al. Nat. Nanotechnol. 2012, 7, 728-732). These experiments indicate the potential of UV-induced oxidative etching for the creation of nanopores (˜0.3-0.6 nm in size) in the graphene lattice that can allow for water transport but block salt transport (Koenig S P et al. Nat. Nanotechnol. 2012, 7, 728-732). However, longer exposures resulted in larger nanopores via the formation of more defects in the graphene lattice (AFM and Raman spectra in FIG. 60 and FIG. 61, respectively) that can potentially adversely affect nanoporous atomically thin membrane performance for desalination (Koenig S P et al. Nat. Nanotechnol. 2012, 7, 728-732; Huh S et al. ACS Nano 2011, 5, 9799-9806). Hence, shorter exposure times, lower ozone partial pressure, and lower UV light fluxes will be used to emulate conditions similar to Koenig et al. (Koenig S P et al. Nat. Nanotechnol. 2012, 7, 728-732) to form nanopores in the 0.3-0.5 nm size range. An UV-ozone setup (FIG. 62) will be used for these experiments.

Additionally, pulsed oxygen plasma etching will be explored to form nanopores in tear/damage sealed graphene membranes (Kidambi P R et al. Adv. Mater. 2017, 29, 1700277). Pulsed oxygen plasma was previously utilized to etch nanopores <1 nm in graphene nanoporous atomically thin membranes that allowed for transport of K⁺ and Cl⁻ ions but effectively blocked transport of vitamin B12 (˜1-1.5 nm), as shown in FIG. 47-FIG. 50 (Kidambi P R et al. Adv. Mater. 2017, 29, 1700277). It is emphasized that nanoporous atomically thin membranes with <1 nm pores are already suitable for water purification applications, specifically for water contaminated with fracking/drilling chemicals which contain molecules that are typically larger than 1 nm in size.

Different conditions of oxygen plasma will be to explore to achieve nanopores in the 0.3-0.6 nm range for desalination applications. A dedicated Harrick oxygen plasma system will be used to perform clean and precise graphene nanopores formation experiments. Specifically, a) the input power, b) plasma pulse duration, and c) the oxygen gas pressure will be varied. Surwade et al. demonstrated the use of oxygen plasma to form nanopores in micron size graphene membranes for desalination applications (Surwade S P et al. Nat. Nanotechnol. 2015, 10, 459-464). Zandiatashbar et al. also studied the mechanical strength of graphene upon defects formation using oxygen plasma (Zandiatashbar A et al. Nat. Commun. 2014, 5, 3186). Taken together with other prior experiments (FIG. 47-FIG. 50), these observations strongly indicate the feasibility of pulsed oxygen plasma processes as a scalable route for the introduction of nanopores in the graphene lattice for realizing nanoporous atomically thin membranes for desalination and water purification applications.

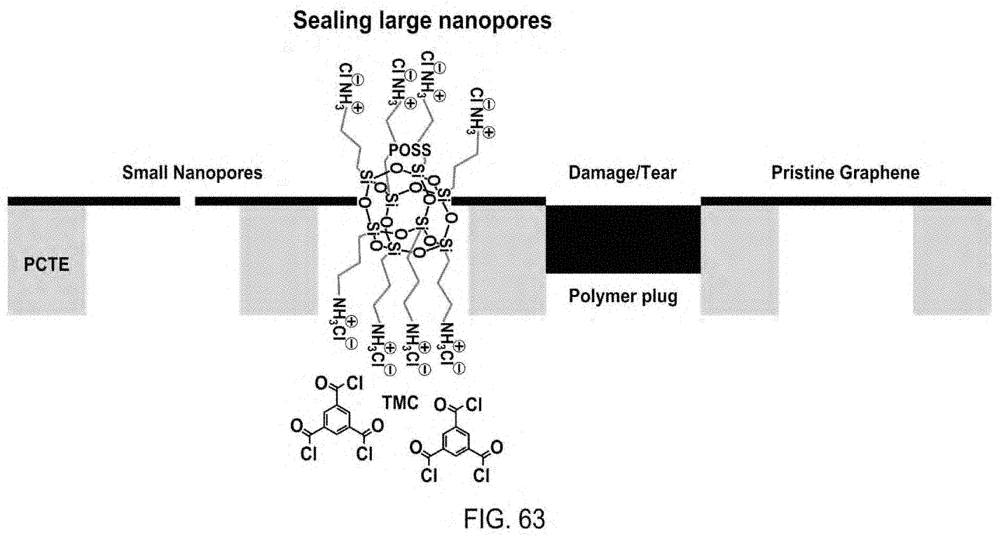

If required, the graphene on polycarbonate track etched supports can also be subjected to interfacial polymerization using hexamethylenediamine (HMDA) in water and adipoyl chloride (APC) in hexane to form nylon 6,6 plugs to seal large tears and damaged regions in the graphene membranes (O'Hern S C et al. Nano Lett. 2015, 15, 3254-3260) before nanopore formation via UV induced oxidative etching or pulsed oxygen plasma (FIG. 47 and FIG. 63) (Kidambi P R et al. Adv. Mater. 2017, 29, 1700277). This can be performed as a back-up, specifically if the non-selective leakage across large tears and damaged regions in graphene is larger than the selective flow from nanopores etched into graphene.

Size-selective sealing of large nanopores via interfacial polymerization. The UV induced oxidative etch and oxygen plasma etch described above can affect intrinsic defects and defects on grain boundaries in CVD graphene more than pristine areas (Zandiatashbar A et al. Nat. Commun. 2014, 5, 3186). These intrinsic defects and defects on grain boundaries could etch at a faster rate compared to nucleation of new 0.3-0.6 nm defects in pristine regions (Zandiatashbar A et al. Nat. Commun. 2014, 5, 3186) resulting in large nanopores that compromise membrane selectivity by allowing for a rate of leakage larger than selective flow.

Size-selective sealing of such large defects/nanopores (>0.5 nm) via interfacial polymerization is proposed. Specifically, an aqueous solution of octa-ammonium polyhedral oligomeric silsesquioxane (POSS) on one side and trimesoyl chloride in the organic phase on another side of the graphene nanoporous atomically thin membrane (FIG. 63) will be used (Dalwani M et al. J. Mater. Chem. 2012, 22, 14835; Zhang Y et al. Lab Chip 2015, 15, 575-580). Only nanopores large enough to allow for transport of polyhedral oligomeric silsesquioxane molecules (>0.5 nm, the width of the polyhedral oligomeric silsesquioxane molecule across its shortest dimension) will be sealed by the reaction of polyhedral oligomeric silsesquioxane with trimesoyl chloride to form an ultra-thin polymer layer (FIG. 63) (Dalwani M et al. J. Mater. Chem. 2012, 22, 14835; Zhang Y et al. Lab Chip 2015, 15, 575-580). Diffusion of trimesoyl chloride molecules into the aqueous phase is greatly hindered by the lack of solubility and hence the region for interfacial polymerization is pinned inside the ˜200 nm polycarbonate track etched support pore. The concentration of the polyhedral oligomeric silsesquioxane and trimesoyl chloride in the respective solutions and the time duration for the interfacial polymerization reaction will be varied to optimize the best conditions for sealing nanopores >0.5 nm, specifically for desalination and water purification applications.

This method offers a direct route to seal only large nanopores >0.5 nm in graphene nanoporous atomically thin membranes and allows for an increase in selectivity and nanoporous atomically thin membrane performance. Further, the method is versatile and offers the ability to target sealing of specific nanopore sizes by selecting different molecular species for interfacial polymerization.

Probing water, ion, and molecular transport across graphene nanoporous atomically thin membranes. Evaluating mass transport properties of the synthesized nanoporous atomically thin membranes is essential to tune and optimize porosity. A goal of this project is to tune ˜0.3-0.6 nm pore sizes in graphene nanoporous atomically thin membranes for desalination and water purification applications.

A well-tested and proven method will be used to characterize mass transport across the synthesized nanoporous atomically thin membranes for each set of pore creation conditions (Kidambi P R et al. Adv. Mater. 2017, 29, 1700277; Kidambi P R et al. Nanoscale 2017, 9, 8496-8507; Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kidambi P R et al. Adv. Mater. 2017, 29). Bare polycarbonate track etched support membranes will be used for control experiments.

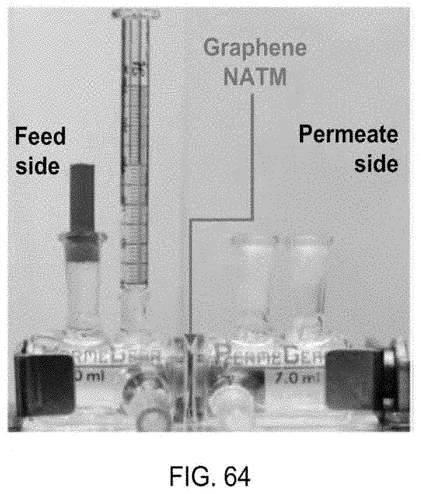

Initially, the nanoporous atomically thin membranes will be rinsed in ethanol followed by 5 rinses in water, and mounted in a side-by-side diffusion cell (Permegear, Inc., FIG. 64) with magnetic stirrers (to prevent concentration polarization) (Kidambi P R et al. Adv. Mater. 2017, 29, 1700277; Kidambi P R et al. Nanoscale 2017, 9, 8496-8507; Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kidambi P R et al. Adv. Mater. 2017, 29). In-situ conductivity measurements (Mettler Toledo S230) and in-situ UV-vis absorption spectroscopy with a fiber-optic probe (Agilent Cary 60) will be used to monitor transport of salts (KCl, NaCl and MgSO₄) and small molecules (L-Tryptophan, Allura Red Dye, and Vitamin B12), respectively, (FIG. 47-FIG. 50) (Kidambi P R et al. Adv. Mater. 2017, 29, 1700277; Kidambi P R et al. Nanoscale 2017, 9, 8496-8507; Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kidambi P R et al. Adv. Mater. 2017, 29).

In diffusion driven transport experiments, a known concentration of salts and/or molecules will be introduced in the feed side and concentration increase in the permeate side filled with deionized water will be observed using the in-situ conductivity and in-situ UV Vis probes (Kidambi P R et al. Adv. Mater. 2017, 29, 1700277; Kidambi P R et al. Nanoscale 2017, 9, 8496-8507; Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kidambi P R et al. Adv. Mater. 2017, 29). The coverage of graphene on polycarbonate track etched will be measured by monitoring water flow upon introducing a hydrostatic head between the two sides of the diffusion cell, i.e. monitoring the drop in water level for the graduated column in the feed side (FIG. 64) as a function of time (Kidambi P R et al. Adv. Mater. 2017, 29, 1700277; Kidambi P R et al. Nanoscale 2017, 9, 8496-8507; Kidambi P R et al. ACS Appl. Mater. Interfaces 2018, 10, 10369-10378; Kidambi P R et al. Adv. Mater. 2018, U.S. Pat. Nos. 1,804,977, 1,804,977; Kidambi P R et al. Adv. Mater. 2017, 29).

For nanoporous atomically thin membranes subjected to interfacial polymerization, water permeability will be measured via forward osmosis (O'Hern S C et al. Nano Lett. 2015, 15, 3254-3260). Different concentrations of glycerol ethoxylate solution will be used as the draw solution (on the feed side) to create osmotic pressure differences across the nanoporous atomically thin membrane and the volume of liquid that flows from one side to the other side will be quantified using the graduated column (O'Hern S C et al. Nano Lett. 2015, 15, 3254-3260).

Further, the rejection of solutes under osmotic pressure-driven flow will also be measured (O'Hern S C et al. Nano Lett. 2015, 15, 3254-3260). Here, the permeate side will be filled with glycerol ethoxylate solution, and the feed side will be filled with the solute solution, i.e. KCl, NaCl, or MgSO₄ (O'Hern S C et al. Nano Lett. 2015, 15, 3254-3260). The increase in conductivity on the permeate side will be used to measure solute transport and the change in volume of water (observed via the graduated column on the feed side) as function of time will be used to measure water flux (O'Hern S C et al. Nano Lett. 2015, 15, 3254-3260). Finally, transport models developed previously will be used to obtain permeabilities of each of the different species under concentration or an osmotic pressure gradients across the nanoporous atomically thin membrane (O'Hern S C et al. Nano Lett. 2015, 15, 3254-3260).

Atomic resolution scanning transmission electron microscopy (STEM) of nanopores in graphene. A goal is to develop a fundamental understanding by relating the obtained nanopore size, size distribution, and density in the nanoporous atomically thin membranes to the etching conditions and the transport characteristics. A N-ion Ultra scanning transmission electron microscope (STEM) will be used to obtain atomic resolution images of nanopores in graphene. Specifically, low acceleration voltage (˜60 kV) to minimize knock-on damage to graphene and medium annular dark-field conditions optimized during prior imaging studies will be used (Kidambi P R et al. Adv. Mater. 2017, 29, 1700277; Kidambi P R et al. Adv. Mater. 2018, U.S. Pat. Nos. 1,804,977, 1,804,977).

Samples for STEM studies will be prepared by transferring the synthesized nanoporous graphene to TEM grids (Au grids, Ted Pella) along with subsequent cleaning using a well-developed procedure to ensure atomically clean interfaces (Kidambi P R et al. Adv. Mater. 2017, 29, 1700277; Kidambi P R et al. Chem. Mater. 2014, 26, 6380-6392).

The mass transport characteristics described above can be used to effectively down select the samples for STEM imaging if needed, since the mass-transport characteristics are average values over centimeter scale measurements. A primary objective will be to image nanopores in the graphene lattice to extract information on pore size, pore size distribution, and density. Additionally, information of pore functionalization and other changes to the lattice or grain boundaries would also be of interest.

The analysis of the STEM images using ImageJ software will allow for the robust statistics on pore size, pore size distribution, and density for each samples. These statistical insights will be related to the mass transport characteristics, nanopore creation parameters, and will add to the development of a detailed quantitative understanding of the fundamental transport mechanisms across nanopores in nanoporous atomically thin membranes for desalination and water purification applications. This understanding coupled with the scalable nature of the processes described here can enable scale-up of nanoporous atomically thin membranes by leveraging polymer support casting techniques developed previously (FIG. 53).

Work plan. i. Demonstration of the feasibility of nanoporous graphene (0.3-0.6 nm pores) synthesis by UV induced oxidative etching and pulsed oxygen plasma etching. ii. Size selective nanopore sealing with polyhedral oligomeric silsesquioxane and trimesoyl chloride (TMC) interfacial polymerization. iii. Characterizing mass transport across the synthesized graphene nanoporous atomically thin membranes using diffusion driven flow and osmotic pressure driven flow. iv. STEM imaging of nanopores in graphene to obtain nanopore size, size distribution and density.

### Example 3

Increasing survivability and readiness of the Warfighter in diverse operational settings is of central importance. The advent of chemical and biological agents has necessitated development of counter measures and/or management strategies to enable protection from attacks that typically proceed via the skin (percutaneously) and/or mucous membranes. Protection from chemical and biological agents is typically achieved via personnel protective equipment (PPE), such as masks and respiratory systems, special over-garments, gloves, boots, etc. However, conventional PPEs, specifically over-garments that act as a second-skin, typically sacrifice breathability in order to maximize protection from exposure to harmful chemical and/or biological agents.

Increased breathability (sweat based evaporative cooling) is highly desired to minimize physiological burden and the risk of heat stress to the Warfighter operating across the entire range of extremely challenging battlefield/combat situations. This trade-off in breathability (permeability to water vapor) vs. protection (selectivity to blocking harmful agents while allowing water vapor transport) represents the classical unresolved problem in materials and membrane technology for decades, wherein an increase in permeability invariably comes at the expense of selectivity.

In this context, atomically thin two-dimensional (2D) materials, such as graphene, represent the absolute minimum material thickness ˜0.34 nm and offer fundamentally new opportunities to control mass-transport at the nanoscale. The pristine lattice of monolayer graphene is impermeable to even small gas molecules, e.g. Helium. The introduction of precise nanoscale vacancy defects in the graphene lattice manifest as nanopores in an atomically thin membranes (FIG. 44) (Wang E N et al. Nat. Nanotechnol. 2012, 7, 552-554). Such nanoporous atomically thin membranes (NATMs) can allow for high permeance (due to the material thinness ˜0.34 nm) and high selectivity (due to precise nanoscale pores that block larger molecules); thereby offering a new paradigm for achieving effective protection and ultra-high breathability within a single material.

The overall objective of the proposed research is to develop experimental approaches for scalable synthesis of graphene nanoporous atomically thin membranes for ultra-breathable and protective over-garment applications, specifically, a) nanopores <1 nm for protection from chemical and biological agents and b) nanopores <5 nm for protection from biological agents. The research will address the main challenge in scalable synthesis of graphene nanoporous atomically thin membranes, i.e. i) the creation of a narrow size distribution of nanoscale vacancy defects in the atomically thin graphene lattice using scalable processes and ii) effectively supporting the atomically thin graphene layer on high porosity supports for scalable membrane manufacturing. Specifically, 1) ex-situ atomic scale etching processes for scalable nanopore formation, 2) in-situ oxide nanoparticle template processes for facile nanopore formation, and 3) high porosity supports with interfacial polymerization processes as platform technologies will be explored to realize centimeter scale graphene nanoporous atomically thin membranes for ultrabreathable protective over-garment materials. The nanopores in atomically thin graphene can allow for facile and rapid transport of water vapor (Van der Waals diameter ˜0.28 nm) while effectively blocking chemical agents >1 nm and pathogens >5 nm (smallest viruses are ˜20 nm and bacteria are much bigger).

The proposed research can mitigate chemical and biological exposure, and develop countermeasures, and management strategies, via the creation of graphene based nanoporous atomically thin membranes for wearable protective materials with multiple capabilities that can address environmental exposures. The proposed research pursues military-relevant advanced technology research related to forward deployable solutions that can promptly address life-threatening injuries, and medical threats for Warfighters in current and future battlefield settings.

Current state of PPEs for protection from chemical and biological agents: The advent of chemical and biological agents for battlefield use has necessitated the development of effective Warfighter protection and counter measures and/or management strategies. Initially, respiratory and mucous membrane threats, resulted in the development of masks and filters. However, development of chemical agents that attacked via the skin (percutaneously) as well as the respiratory system, necessitated the development of robust PPEs (mask, special over-garments, gloves and boots, etc.) and other physical barriers. Herein, the research is specifically focused on over-garment applications that act as a second-skin, protecting the Warfighter.

Ideally, the over-garment PPE used in battlefield/combat situations should cause minimal encumbrance to the Warfighter. However, despite decades of research and development, state-of-the art overgarment PPE remains cumbersome to use and in most cases, creates severe thermal stress due to poor breathability, i.e. the over-garment PPE material does not allow for rapid water vapor transport while effectively blocking chemical and biological agents. Several approaches to design breathable PPEs have focused on making porous polymers with high thickness where chemical agents and biological pathogens are removed by depth filtration. However, these approaches do not guarantee protection, since longer exposure will inevitably lead to a break-through for the chemical and biological agents and water vapor transport rates for such thick polymer layers are typically very low.

On the other hand, efficient evaporative cooling of the human body through perspiration, requires the over-garment/second skin PPE to provide moisture vapor transport rates (MVTR)>1500-2000 g m⁻² d⁻¹. Thermal stresses from inefficient evaporative cooling can significantly interfere and diminish the ability of the Warfighter to effectively perform tasks on the battlefield, jeopardizing safety and security. Severe thermal stresses have also resulted in adverse psychological reactions to PPE use. While enhanced doctrine, training, and equipment can enable improvements, increased breathability (sweat based evaporative cooling) in PPEs is highly desired to minimize physiological burden and the risk of heat stress to the Warfighter operating in combat situations.

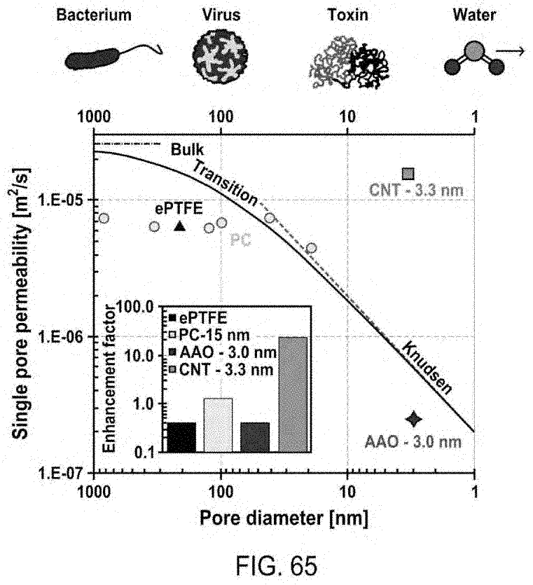

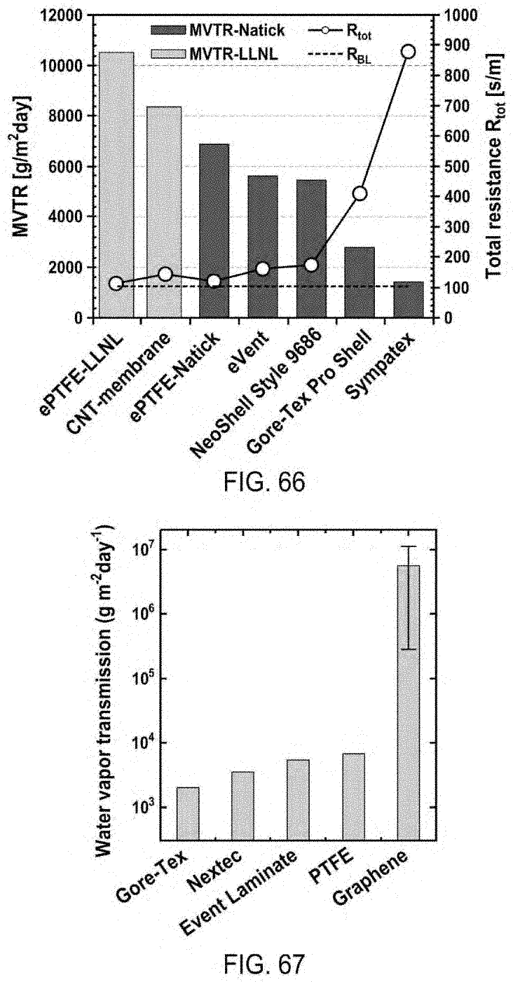

Progress has indeed been made in achieving increased MVTR for conventional polymeric materials, e.g. by introducing porosity in butyl rubber-based materials, and developing reactive organic/inorganic composite film materials that actively degrade chemical agents on contact, including non-woven fabrics materials. However, each of these approaches is tailored specifically to one particular chemical agent, and the protective capability is greatly diminished for other agents. Hence, a more generic approach that allows for high MVTR with the ability to block a very wide range of chemicals and biological agents is required for practical over-garment application in the battlefield and/or combat situations. In this context, membranes made via the incorporation of nanomaterials such as vertically aligned carbon nanotubes (CNTs, FIG. 65, FIG. 66) with ˜3.3 nm diameter tubes have shown high MVTR>8000 g m⁻² d⁻¹ along with the ability to block most biological pathogens, e.g. dengue virus ˜40 nm. However, blocking chemical agents using CNTs with ˜3.3 nm diameter remains challenging.

To summarize, achieving effective protection against chemical and biological agents and ultra-high breathability within a single material has been an un-solved challenge for several decades. Herein, the aim is to develop graphene based nanoporous atomically thin membranes to offer transformative advances for protective over-garments.

Nanoporous atomically thin membranes (NATMs). Atomically thin two-dimensional (2D) materials such as graphene (a single layer of graphite), hexagonal boron nitride (h-BN), and others, represent the absolute minimum material thickness and in their pristine form have been shown to be impermeable barriers to even the small gas atoms (Helium). The introduction of precise nanoscale vacancy defects in the 2D material lattice can enable the realization of nanoporous atomically thin membranes (NATMs). Separation in such nanoporous atomically thin membranes primarily occurs via molecular sieving, wherein molecules smaller than the nanopore permeate through and larger molecules are retained. Such a facile size exclusion based process represents a generic and widely applicable technology platform opportunity that can be effectively leveraged to develop the next-generation of protective over-garments. Further, the defect size could, in principle, be tuned to address a diverse range of separation processes (FIG. 44).

Hence, nanoporous atomically thin membranes with atomic thickness, high mechanical strength, and chemical resistance, potentially offer the possibility of realizing protective over-garments that simultaneously offer i) high water vapor transport (breathability, FIG. 67), ii) high selectivity (protection), and iii) excellent robustness to a wide range of chemicals. The overall objective of the proposed research is to develop experimental approaches for scalable synthesis of graphene nanoporous atomically thin membranes for ultra-breathable and protective over-garment applications, specifically, a) nanopores <1 nm for protection from chemical and biological agents and b) nanopores <5 nm for protection from biological agents.

Many theoretical and computational works have investigated gas, ionic, molecular, and water transport across nanopores in atomically thin 2D materials for membrane applications, and experimental studies are rapidly emerging.

Bunch et al. (Nano Lett. 2008, 8, 2458-2462) first demonstrated the impermeability of micron sized pristine graphene membranes to the smallest molecule He. Subsequently, Koenig et al. (Nanotechnol. 2012, 7, 728-732) demonstrated molecular sieving of gases (H₂, CO₂, Ar, N₂, CH₄, and SF₆) through sub-nanometer pores introduced via UV based oxidative etching of ˜5 m diameter mono- and bilayer graphene membranes. The size of the etched nanopores in these studies was estimated from the kinetic diameter of the smallest molecule that did not permeate though, e.g. ˜3.4 Å pore size was estimated for pores that allowed transport of H₂ and CO₂ but not Ar, N₂, and ˜4.9 Å pore size was estimated for pores that allowed transport of H₂, CO₂, Ar, N₂ and CH₄ but not SF₆. Additionally, gas transport across sub-nanometer pores introduced into monolayer graphene membranes via UV-induced oxidative etching showed a decrease in permeance with increasing kinetic diameter of gas molecules (He, Ne, H₂, and Ar), indicating molecular sieving as the mechanism of transport. These experimental studies hence demonstrated the successful creation of nanopores on the length scale of the kinetic diameter of the gas molecules (˜0.3-0.5 nm) in the graphene lattice using UV-induced oxidative etching methods.

Celebi et al. (Science (80-.). 2014, 344, 289-292) successfully demonstrated ultra-high gas and water vapor permeability through 4 μm sized bilayer graphene membranes. Using a focused ion beam they drilled ˜7.6-50 nm sized nanopores in bilayer graphene membranes and reported permeance values ˜10⁻² mol m⁻² s⁻¹ Pa⁻¹, which is almost three orders of magnitude higher than the value for polymeric gas separation membranes with similar selectivity (FIG. 67). Specifically, membranes with ˜50 nm pores and 4.7% porosity exhibited water permeance of ˜3·10 m³ m⁻² s⁻¹ Pa⁻¹, almost 3 times higher than current polysulfone ultrafiltration membranes for water purification, while membranes with ˜400 nm pores and porosities ˜3.6-11.5% showed very high water vapor permeances indicating their potential as ultrathin breathable waterproof membranes.

Surwade et al. (Nat. Nanotechnol. 2015, 10, 459-464) investigated water transport through nanoporous graphene for desalination applications. Here, the researchers used oxygen plasma to create nanopores with ˜10¹² cm⁻² density and observed salt rejection during pervaporation of water across ˜5 μm diameter monolayer graphene membranes. Specifically, with only one side of graphene membrane wetted, the researchers observed water permeation with fluxes ˜1×10⁶ gm⁻² s⁻¹ and ˜100% rejection of salt ions (K⁺, Na⁺, Li⁺, Cl⁻) at 40° C. These experiments demonstrated the suitability of oxygen plasma based etching techniques to form nanopores in the graphene lattice for desalination applications albeit over micron scale membrane areas.

Graphene synthesis and development of nanoporous atomically thin membranes. Experimental work on atomically thin membranes has mostly focused on micron scale areas.

Complementary in-situ X-ray photoelectron spectroscopy (XPS), in-situ X-ray diffraction (XRD) and in-situ environmental scanning electron microscopy (ESEM) study of graphene and h-BN synthesis via chemical vapor deposition (CVD) at ˜1000° C. on sacrificial polycrystalline Cu foils has been reported (FIG. 45) (Kidambi et al. Chem. Mater. 2014, 26, 6380-6392; Kidambi et al. Nano Lett. 2013, 13, 4769-4778). These time and process resolved in-situ experiments were the first of their kind in the field (post growth ex-situ characterization has been the norm) and offered unprecedented fundamental insights into growth mechanisms by allowing for continuous monitoring of the catalyst surface morphology, surface chemistry, bulk crystallography, and gaseous species during the entire CVD process. These observations helped resolve several conflicting literature reports on growth mechanisms, graphene interaction with the substrate (n-doping) during growth, oxygen intercalation after growth and elucidated the role of oxygen during graphene growth.

Using fundamental insights from the complementary in-situ study, a simple, cost effective, high throughput method to characterize the quality of as-grown CVD graphene on Cu for membrane and atomically thin barrier applications was developed (Kidambi et al. Nanoscale 2017, 9, 8496-8507). A drop of acid placed on as-grown CVD graphene on Cu is used to form etch pits only in areas where the graphene is defective (FIG. 46). These pits can be imaged and analyzed to quantify defect density and spacing. A time dependent model is used to predict/calculate the original defect size in graphene from etch pit size and shows excellent agreement with diffusion-driven transport measurements across the graphene membrane. The validation of the etch test method allowed for an effective feedback loop to navigate the large parameter space for CVD and helped to arrive at benchmark standards for the quality of atomically thin materials for barrier and membrane applications which are significantly different than electronics. Large area (cm²) atomically thin membranes, fabricated by transferring the optimized CVD graphene on Cu to polycarbonate track etched (PCTE) supports, showed the complete absence of nanometer-scale defects but sub-50 nm defects associated primarily with wrinkles in graphene were observed (FIG. 46). By selectively sealing (FIG. 47-FIG. 50) these large tears/damages via interfacial polymerization (O'Hern et al. Nano Lett. 2015, 15, 3254-3260) (monomer precursors on opposite sides of a membrane meet and react only at sites of defects forming polymer seals/plugs), centimeter-scale atomically thin gas barriers which show <2% mass transport for He (FIG. 45) and ˜1 nm Allura Red dye compared to the polycarbonate track etched support were demonstrated (Kidambi et al. Nanoscale 2017, 9, 8496-8507).

Having established graphene quality metrics for membrane applications (Kidambi et al. Nanoscale 2017, 9, 8496-8507), a facile and scalable processes for the fabrication of large area graphene based nanoporous atomically thin membranes for dialysis, de-salting, and small molecule separation applications was developed (FIG. 47-FIG. 50) (Kidambi et al. Adv. Mater. 2017, 29, 1700277). CVD graphene grown on Cu foil was transferred to polycarbonate track etched supports with ˜200 nm vertically aligned pores. After sealing large tears/damages which were introduced during transfer/handling by interfacial polymerization (nylon 6,6 plugs), a facile oxygen plasma etch is used to create size selective nanopores in CVD graphene (FIG. 47-FIG. 50). The nanoporous atomically thin membranes showed size selective transport of KCl (˜0.66 nm)>L-Tryptophan (˜0.7-0.9 nm)>Allura Red dye (˜1 nm)>Vitamin B12 (˜1-1.5 nm) while completely blocking Lysozyme (˜3.8-4 nm) (Kidambi et al. Adv. Mater. 2017, 29, 1700277). Interestingly, the nanoporous atomically thin membranes offered ˜1-2 orders of magnitude increase in permeance compared to state-of-the-art dialysis membranes (Kidambi et al. Adv. Mater. 2017, 29, 1700277). Rapid diffusion along with good selectivity in nanoporous atomically thin membranes offers transformative opportunities in drug purification, removal of residual reactants, biochemical analytics, medical diagnostics, therapeutics, and bio-nano separations. This work demonstrated fully functional centimeter scale nanoporous atomically thin membrane from graphene—separating salts from small molecules in 7 ml volume, which is already applicable for small scale laboratory separations (Kidambi et al. Adv. Mater. 2017, 29, 1700277).

A method to probe nanoscale mass transport across large-area (cm²) single crystalline graphene membranes was developed (Kidambi et al. Adv. Mater. 2017, 29, 1605896) and demonstrated molecular sieving of gases (He and SF₆) across centimeter scale graphene membranes by transferring graphene on to anodized alumina supports (Boutilier et al. ACS Nano 2017, 11, 5726-5736). The ˜20 nm pores of the anodic alumina supports offered adequate resistance to non-selective flow from leakage across large tears in the graphene (Boutilier et al. ACS Nano 2017, 11, 5726-5736). Further, it was shown that nanoporous graphene membranes, when adequately supported, e.g. on polycarbonate track etched membranes with ˜200 nm pores, can withstand up to 100 bar of pressure, indicating their potential for most pressure driven separation applications (Wang et al. Nano Lett. 2017, 17, 3081-3088). More recently, bottom-up techniques to directly synthesize nanopores <2-3 nm in monolayer graphene during CVD growth (FIG. 52-FIG. 57) for dialysis applications was developed (Kidambi et al. Adv. Mater. 2018, U.S. Pat. Nos. 1,804,977, 1,804,977). In this approach, a simple reduction in CVD process temperature allowed for facile fabrication of nanoporous atomically thin membranes (FIG. 53) for dialysis applications (Kidambi et al. Adv. Mater. 2018, U.S. Pat. Nos. 1,804,977, 1,804,977).

Finally, a scalable manufacturing route for the synthesis of graphene based nanoporous atomically thin membranes was developed by combining roll-to-roll synthesis of graphene via CVD with a hierarchical polymer support casting approach (Kidambi et al. ACS Appl. Mater. Interfaces 2018, 10, 10369-10378). Specifically, a customized two zone CVD reactor (FIG. 58) designed and built to synthesize high quality graphene on Cu foil at speeds up to 5 cm/min in a roll-to-roll process (Kidambi et al. ACS Appl. Mater. Interfaces 2018, 10, 10369-10378). Next a poly-ether sulfone (PES) support was cast directly on the synthesized high quality roll-to-roll graphene (Kidambi et al. ACS Appl. Mater. Interfaces 2018, 10, 10369-10378). Phase inversion of the poly-ether sulfone in water yielded a hierarchically porous support (˜200-500 nm pores near graphene that branched out to micron-sized pores away from graphene) directly on CVD graphene after which the Cu foil was etched away to yield a graphene nanoporous atomically thin membrane (FIG. 59) (Kidambi et al. ACS Appl. Mater. Interfaces 2018, 10, 10369-10378). This approach demonstrated the feasibility of scalable synthesis of graphene nanoporous atomically thin membranes (Kidambi et al. ACS Appl. Mater. Interfaces 2018, 10, 10369-10378).

To summarize, centimeter-scale graphene nanoporous atomically thin membranes with sub-nanometer pores have been demonstrated for: dialysis applications, atomically thin gas barriers, single crystalline graphene membranes, molecular sieving of gases across centimeter scale graphene membranes, pressure tolerance of nanoporous graphene membranes up to 100 bar, bottom-up nanopore formation during CVD, and scalable manufacturing routes for nanoporous atomically thin membranes using roll-to-roll graphene synthesis via chemical vapor deposition (CVD) in combination with polymer support casting.

The overall objective of the proposed research is to develop experimental approaches for scalable synthesis of graphene nanoporous atomically thin membranes for ultra-breathable protective over-garment applications. Specifically, the aim is to synthesize graphene nanoporous atomically thin membranes with a) nanopores <1 nm for protection from chemical and biological agents and b) nanopores <5 nm for protection from biological agents.

The central hypothesis for the proposed research program is robustly anchored on experimental insights and effectively builds on prior advances in the demonstrating the feasibility of graphene nanoporous atomically thin membranes. The introduction of precise nanoscale vacancy defects (˜0.28 nm, Van der Waals diameter for water molecule) in the atomically thin graphene lattice can enable the formation of nanoporous atomically thin membranes with extremely high water permeance and extremely high selectivity (rejecting larger molecules—chemical agents in aqueous and gas phase) and offer a new paradigm for advancing ultra-breathable, protective over-garment applications.

The proposed research can further the mission to mitigate chemical and biological exposure, and develop countermeasures, and management strategies. The proposed research pursues military-relevant advanced technology research related to forward deployable solutions that can promptly address life-threatening injuries, and medical threats for Warfighters in current and future battlefield settings.

The specific aims of the proposed research project are to demonstrate graphene nanoporous atomically thin membranes with MVTR>2000 g m⁻² d⁻¹ and the following characteristics: nanoporous atomically thin membranes with nanopores <1 nm for protection from chemical and biological agents; explore the use of high porosity supports and interfacial polymerization processes to enable manufacturability of nanoporous atomically thin membranes with nanopores <1 nm; and nanoporous atomically thin membranes with nanopores <5 nm for protection from biological agents.

Oxidative etching and size selective interfacial polymerization for scalable synthesis of nanoporous atomically thin membranes with nanopores <1 nm (protection against chemical and biological agents): Here, nanopore (0.3-0.6 nm size range) formation in atomically thin graphene transferred onto polycarbonate track etched supports (FIG. 47) will be explored by subjecting it to ultraviolet light in the presence of ozone. A) the duration of exposure (from a few seconds to a few hours), b) partial pressure of ozone (from low dilutions ˜1% ozone in Ar to pure ozone), and c) flux of UV-light (by controlling the number of lamps illuminating) will be systematically varied to elucidate the effect on the nanopore size, size-distribution, and density of nanopores in the nanoporous atomically thin membranes.

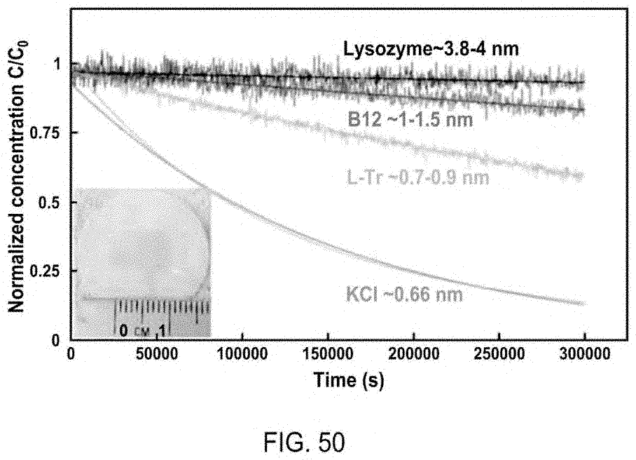

Koenig et al. (Nat. Nanotechnol. 2012, 7, 728-732) demonstrated the formation of 0.3-0.5 nm nanopores in the graphene lattice using UV-induced oxidative etching for gas transport. These experiments indicated the potential of UV-induced oxidative etching for the creation of a high density of nanopores (˜0.3-0.6 nm in size) in the graphene lattice that can allow for water transport ˜0.28 nm but block transport of larger molecules (chemical and biological agents). However, longer exposures resulted in larger nanopores via the formation and coalescence of more defects in the graphene lattice (Huh et al. ACS Nano 2011, 5, 9799-9806) (AFM and Raman spectra in FIG. 60 and FIG. 61, respectively). The high density (FIG. 60) of nanopores possible via UV ozone etching is of particular interest. Hence, shorter exposure times, lower ozone partial pressure, and lower UV light fluxes will be used to emulate conditions similar to Koenig et al. (Nat. Nanotechnol. 2012, 7, 728-732) to form nanopores in the 0.3-0.6 nm size range. An UV-ozone setup (FIG. 62) will be used for these experiments. Additionally, pulsed oxygen plasma etching will also be explored to form nanopores in tear/damage sealed graphene membranes (Kidambi et al. Adv. Mater. 2017, 29, 1700277). Pulsed oxygen plasma was previously utilized to etch nanopores <1 nm in graphene nanoporous atomically thin membranes that allowed for transport of K⁺ and Cl⁻ ions (˜0.66 nm) but effectively blocked transport of vitamin B12 (˜1-1.5 nm) as shown in FIG. 50 (Kidambi et al. Adv. Mater. 2017, 29, 1700277). Herein, different conditions of oxygen plasma will be explored to achieve nanopores in the 0.3-0.6 nm range. A dedicated Harrick oxygen plasma system will be used to perform clean and precise graphene nanopores formation experiments. Specifically, the effect of varying a) the input power, b) plasma pulse duration, and c) the oxygen gas pressure will be explored. Surwade et al. (Nat. Nanotechnol. 2015, 10, 459-464) successfully demonstrated the use of oxygen plasma to form nanopores in micron size graphene membranes for desalination applications. Zandiatashbar et al. (Nat. Commun. 2014, 5, 3186) also studied the mechanical strength of graphene upon nanoscale defects formation using oxygen plasma. Taken together with other prior experiments (FIG. 47-FIG. 50), these observations strongly indicate the feasibility of pulsed oxygen plasma processes as a scalable route for the introduction of nanopores (0.3-0.6 nm) in the graphene lattice for realizing nanoporous atomically thin membranes for over-garment protective applications capable of blocking chemical and biological agents.

The UV induced oxidative etch and oxygen plasma etch described above can affect intrinsic defects and/or defects on grain boundaries in CVD graphene more than pristine areas (Zandiatashbar et al. Nat. Commun. 2014, 5, 3186). These intrinsic defects and defects on grain boundaries could etch at a faster rate compared to nucleation of new 0.3-0.6 nm defects in pristine regions (Zandiatashbar et al. Nat. Commun. 2014, 5, 3186) resulting in large nanopores that compromise protective capability/selectivity—by allowing for transport of the larger molecular species and/or un-desired chemical agents.

Hence, size-selective sealing of such large defects/nanopores (>0.5 nm) via interfacial polymerization is proposed. Specifically, an aqueous solution of octa-ammonium polyhedral oligomeric silsesquioxane (POSS) on one side and trimesoyl chloride in the organic phase on another side of the graphene nanoporous atomically thin membrane will be used (FIG. 63) (Dalwani et al. J. Mater. Chem. 2012, 22, 14835; Zhang et al. Lab Chip 2015, 15, 575-580). It is hypothesized that only nanopores large enough to allow for transport of polyhedral oligomeric silsesquioxane molecules (>0.5 nm, ˜0.5 nm is the width of the polyhedral oligomeric silsesquioxane molecule across along its shortest dimension) will be sealed by the reaction of polyhedral oligomeric silsesquioxane with trimesoyl chloride (TMC) to form an ultra-thin polymer layer (FIG. 63). Diffusion of trimesoyl chloride molecules into the aqueous phase is greatly hindered by the lack of solubility and hence the region for interfacial polymerization is pinned inside the ˜200 nm polycarbonate track etched support pore. A) the concentration of the polyhedral oligomeric silsesquioxane and trimesoyl chloride (TMC) in the respective solutions and b) the time duration for the interfacial polymerization reaction will be systematically varied to optimize the best conditions for sealing nanopores >0.5 nm, specifically for protective overgarment applications.

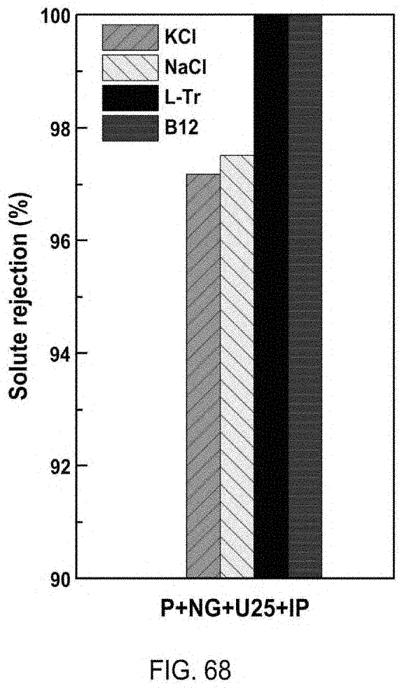

Preliminary results (FIG. 68) indeed indicate that this method offers a potentially facile route to seal only large nanopores >0.5 nm in graphene nanoporous atomically thin membranes, thereby increasing selectivity (protection) while still maintaining high breathability. Further, the method is also versatile and offers the ability to target sealing of specific nanopore sizes simply by selecting different molecular species for interfacial polymerization.

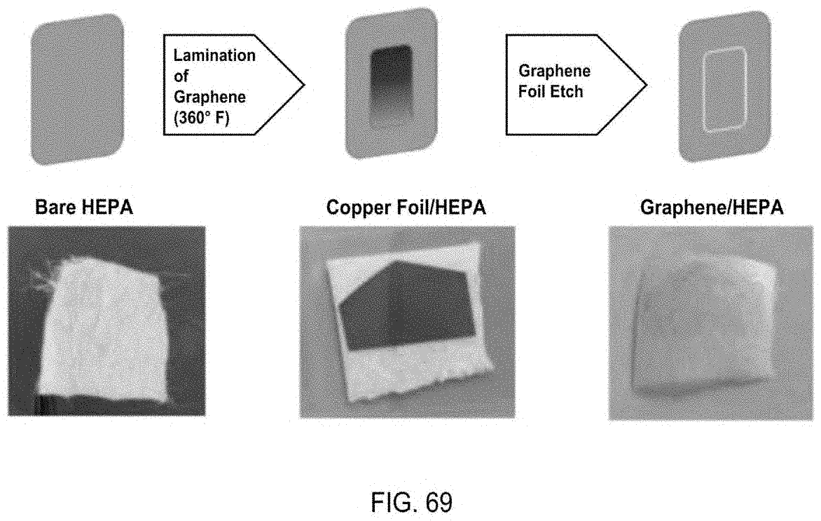

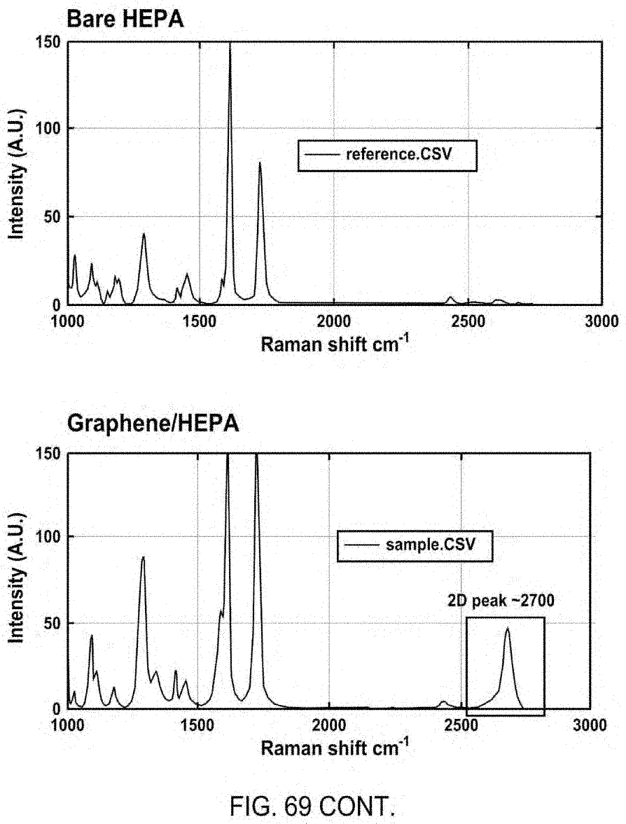

High porosity supports and interfacial polymerization processes for scalable manufacturing. The approaches described above are promising for over-garment protective applications. However, preliminary data indicates that increased support porosity will enable additional advances. Here, inexpensive non-woven supports, such as commercially available air purification filters (HEPA filters), will be explored using facile lamination processes to transfer graphene on to porous supports (Raman spectra in FIG. 69) followed by interfacial polymerization processes similar to those described above but run at much higher concentration (10× higher) as well at other reactive chemistries to allow for rapid sealing reaction kinetics. It is hypothesized that increasing reaction kinetics will minimize lateral spread of the polymer plugs into the highly porous support and allow for site and size specific interfacial polymerization.

Probing water vapor, water, ion, and molecular transport across graphene nanoporous atomically thin membranes. A goal of this proposal is to tune ˜0.3-0.6 nm pore sizes in graphene nanoporous atomically thin membranes for protective over-garment applications. Chemical and biological agents can transport in the liquid as well as the gas phase. Hence, well-tested and proven methods will be used to thoroughly characterize mass transport across the synthesized nanoporous atomically thin membranes for each set of nanopore creation conditions. Bare polycarbonate track etched support membranes will be used for control experiments.

Water vapor transport will be measured using a high-precision temperature controlled weighing balance (Mettler Toledo). Here, the graphene nanoporous atomically thin membranes will be used to seal a vial with a pre-determined amount of de-ionized water. The loss in weight of the vial as a function of time will be measured and used to compute the water vapor permeation rate for the nanoporous atomically thin membranes as function of temperature.

Next, the nanoporous atomically thin membranes will be mounted in a side-by-side diffusion cell (Permegear, Inc., FIG. 64) with magnetic stirrers (to prevent concentration polarization) and rinsed in ethanol followed by 5 rinses in deionized water. In-situ conductivity measurements (Mettler Toledo S230) and in situ UV-vis absorption spectroscopy with a fiber-optic probe (Agilent Cary 60) will be used to monitor transport of salts (KCl, NaCl, and MgSO₄) and small molecules (L-Tryptophan, Allura Red Dye, and Vitamin B12), respectively, in the aqueous phase (FIG. 47-FIG. 50).

For diffusion-driven transport experiments, a concentration difference across the nanoporous atomically thin membrane will be created by adding a known concentration of salts and/or molecules in the feed side and the permeate side filled with deionized water will be monitored using the in-situ conductivity and in-situ UV-vis probes. For osmotic pressure-driven flow experiments, different concentrations of glycerol ethoxylate solution will be used as the draw solutions (on the feed side) to create osmotic pressure differences across the nanoporous atomically thin membrane (O'Hern et al. Nano Lett. 2015, 15, 3254-3260). Water transport under osmotic pressure gradient across the nanoporous atomically thin membrane will be quantified by monitoring the change in the level of the graduated column on the feed side (O'Hern et al. Nano Lett. 2015, 15, 3254-3260).

To measure transport of solutes and ions under osmotic pressure-driven flow, the permeate side will be filled with glycerol ethoxylate solution, and the feed side will be filled with the solute solution, e.g. KCl, NaCl, MgSO₄, L-Tryptophan, Allura Red Dye, Vitamin B12, etc, to represent the range of the smallest of molecular sizes for chemical agents (O'Hern et al. Nano Lett. 2015, 15, 3254-3260). The increase in concentration (conductivity or absorbance) on the permeate side will be used to quantify solute transport. The change in volume of water (observed via the graduated column on the feed side) as function of time will be used to measure water flux during the same experiment. The experimentally measured water and solute transport data will be used to evaluate the performance of the synthesized nanoporous atomically thin membranes and tune pore creation and defect sealing processes.

The nanopores in the synthesized graphene nanoporous atomically thin membranes will be characterized using scanning transmission electron microscopy (STEM) to develop a detailed understanding of the nanopore size, size distributions, and density obtained for each of the etching process conditions and allow for technology scale-up. Samples for STEM will be prepared by transferring the synthesized nanoporous graphene to TEM grids (Au grids, Ted Pella) along with subsequent cleaning using a well-developed procedure to ensure atomically clean interfaces (Kidambi et al. Adv. Mater. 2017, 29, 1700277; Kidambi et al. Chem. Mater. 2014, 26, 6380-6392).

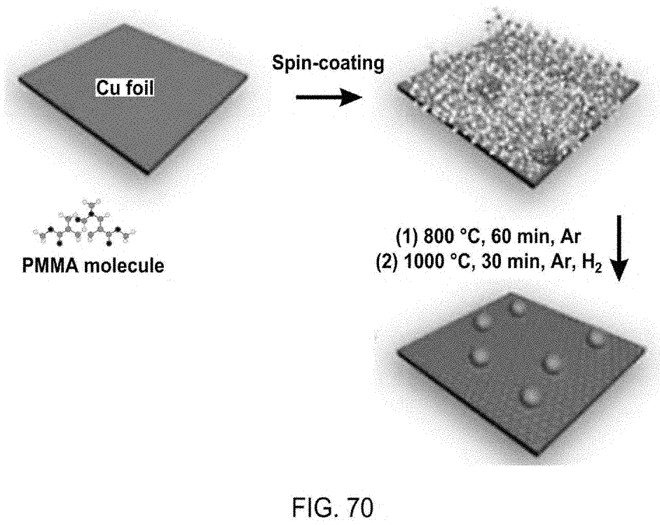

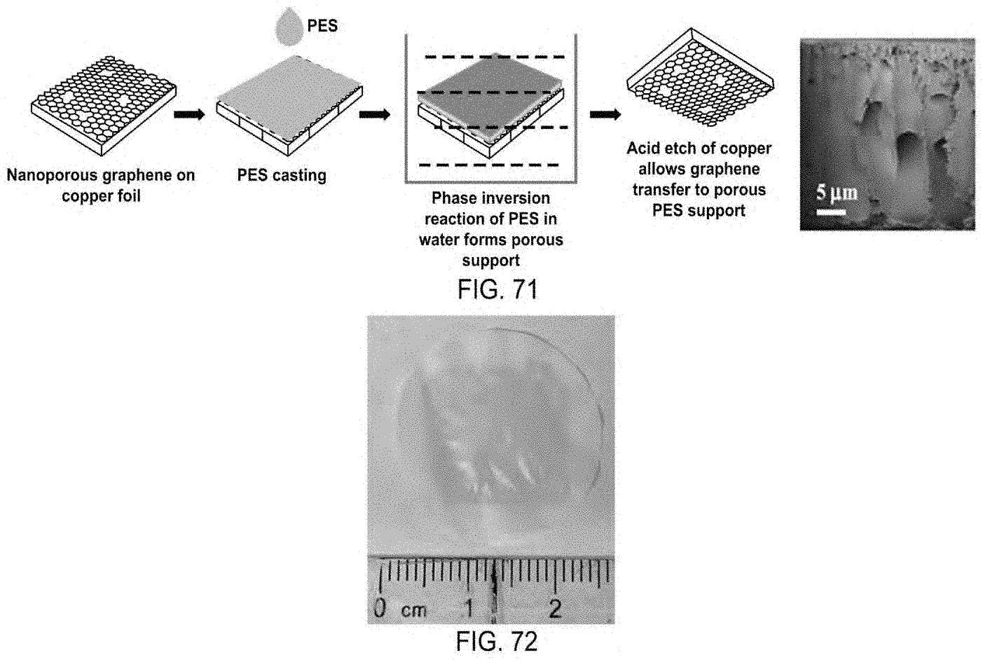

Oxide nanoparticle mediated etching and polymer casting for scalable synthesis of nanoporous atomically thin membranes with nanopores <5 nm (protection against biological agents): Since most biological agents are typically much larger than 10 nm, it is worthwhile developing approaches to specifically allow for protective over-garments for biological agents with much higher breathability than those discussed above for protection against chemical agents. Here, oxide nanoparticle mediated etching of nanopores in atomically thin graphene directly during growth followed by facile polymer casting will be explored to realize nanoporous atomically thin membranes with well-defined <5 nm pores (FIG. 70-FIG. 71). Specifically, ˜5 nm diameter SiO₂ nanoparticles will be mixed with 8% poly-methyl methacrylate (PMMA) solution in anisole solvent and spin coated on Cu foil used for graphene growth (FIG. 70). It is hypothesized that the inert nature of the SiO₂ nanoparticles will prevent graphene formation in its immediate vicinity, while monolayer graphene formation occurs on the other regions on the Cu foil. Post spin coating, annealing the Cu foil in Ar at 800° C. for 60 min followed by H₂ and Ar at 1000° C. for 30 min allows for direct formation of nanopores <5 nm in monolayer graphene (FIG. 70). Next, scalable approaches in traditional membrane casting will be leveraged to directly synthesize hierarchically porous supports on the optimized nanoporous CVD graphene on Cu (FIG. 71). Drop casting a solution of polyether sulfone (PES) resin in N-Methyl-2-pyrrolidone and isopropanol (IPA) onto nanoporous graphene and subsequent immersion in a water bath is proposed to induce phase inversion of the PES. A simple etch of the copper foil allows for nanoporous graphene transfer to porous PES supports, with PES pores immediately below graphene to be ˜200-500 nm (so that they adequately support graphene) that rapidly branch out to much larger pores (offering low flow resistance). The synthesized nanoporous atomically thin membranes will be tested and thoroughly characterized as described above. This general procedure can be adapted to use nanoparticles of other sizes (e.g., average particle size 1-20 nm) to fabricate nanoporous atomically thin membranes with well-defined pores, wherein the pore size depends on the nanoparticle size.

This integrated research plan can enable transformative advances and further the mission to mitigate chemical and biological exposure, and develop countermeasures, and management strategies.

### Example 4

Described herein are nanoporous membranes and methods of making and use thereof. The methods of making the nanoporous membranes comprise, for example, sealing a selected portion of a plurality of pores present in a 2D material, e.g. size-selective sealing to only seal large pores or pores above a certain size. In some examples, the methods of making the nanoporous membranes comprise, for example, forming pores in a 2D material and then sealing a selected portion of the pores, e.g. size-selective sealing to only seal large pores or pores above a certain size. Such nanoporous membranes can be used, for example, for separating a target substance from a non-target substance in a fluid medium. Accordingly, which pores are selectively sealed can be selected in view of the size of the non-target substance.

While 2D membranes offer high permeance and selectivity, a single large defect can destroy the application via non selective leakage. The methods and nanoporous membranes described herein are therefore more powerful and versatile than other approaches that seal the membrane and then make pores. In particular, control over making pores is hard to achieve over meter scales areas at high density, meaning that the unintentional introduction of large pores and/or defects is likely. By making the pores first, followed by size selective sealing, all pores and defects larger than the selected size will be sealed, and thus the resulting nanoporous membranes will exhibit improved selectivity. The nanoporous membranes disclosed herein, e.g., made by the methods disclosed herein, are useful for a variety of applications, such as desalination, protective applications, and proton transport.

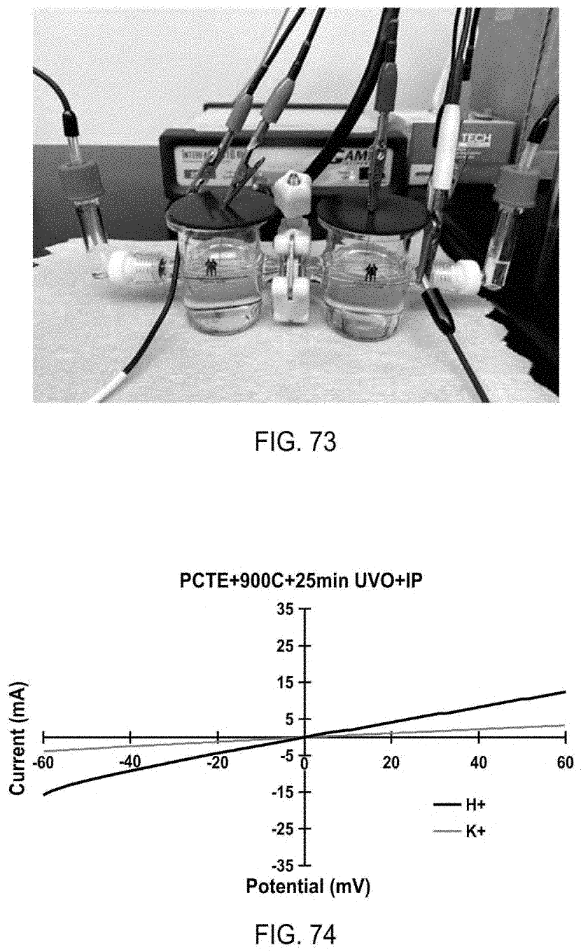

For example, the nanoporous membranes disclosed herein can be used as proton transport membranes. A centimeter scale single layer graphene membrane supported on PCTE support was fabricated (FIG. 72). The methods described herein were used to selectively seal pores and defects having an average diameter of 0.66 nm or more. The nanoporous membrane was placed in a DS cell with luggin capillaries to test the proton transport properties (FIG. 73). The nanoporous membrane showed enhanced H⁺ electrically driven transport, while significantly blocking K⁺ transport in the liquid phase (FIG. 74). Such membranes are useful for proton selective membranes in redox flow batteries and other battery separators, as K⁺ has the smallest hydrated ion diameter at ˜0.66 nm; all other ions used for aqueous batteries (including Li, V, Mg, Ca, Na, and Rb) have larger hydrated diameters.

For example, the nanoporous membranes disclosed herein can be used as personal protective equipment, such as a filter, a gas mask, respirator, protective garment, etc. For such applications, the methods described herein can be used to make the nanoporous membranes by selectively sealing pores and defects having an average diameter of 0.66 nm or more. Such nanoporous membranes allow for water transport and significantly block anything larger than 0.66 nm. This means they can be used for ultra-breathable fabrics and gas masks that prevent transport of any species larger than 0.66 nm. Since this is molecular size based separation, it offers protection from harmful gaseous, solid, and liquid agents used in conflicts.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A nanoporous membrane for separating a target substance from a non-target substance in a fluid medium, the nanoporous membrane comprising:
a two-dimensional (2D) material permeated by a plurality of pores;
wherein the plurality of pores comprises a first population of pores having an average pore diameter and a second population of pores having an average pore diameter;
wherein the average pore diameter of the first population of pores is greater than or equal to the van der Waals diameter of water and less than the average size of the non-target substance in the fluid medium;
wherein the average pore diameter of the second population of pores is greater than or equal to the average size of the non-target substance in the fluid medium; and
wherein substantially all of the second population of pores are substantially blocked by a polymer derived from a first monomer and a second monomer via size-selective interfacial polymerization;
wherein the first monomer has an average size that is greater than the average pore diameter of the second population of pores; and
wherein the second monomer has an average size that is greater than the average pore diameter of the first population of pores and less than or equal to the average pore diameter of the second population of pores;
such that the first monomer and the second monomer are size-excluded from the first population of pores during the size-selective interfacial polymerization;
such that the nanoporous membrane allows for transport of the target substance through the nanoporous membrane via the first population of pores.

2. (canceled)

3. The nanoporous membrane of claim 1, wherein the two-dimensional material comprises graphene, hexagonal boron nitride (h-BN), a transition metal dichalcogenide, a covalent organic framework, a metal organic framework, or a combination thereof.

4-7. (canceled)

8. The nanoporous membrane of claim 1, wherein the two-dimensional material has an average thickness of from 0.3 nm to 1 nm.

9. (canceled)

10. The nanoporous membrane of claim 1, wherein the average pore diameter of the first population of pores is from 0.3 nm to 5 nm.

11. (canceled)

12. The nanoporous membrane of claim 1, wherein the polymer comprises polyhedral oligomeric silsesquioxane-polyamide (POSS-PA); nylon 6,6; or a combination thereof.

13. (canceled)

14. The nanoporous membrane of claim 1, wherein the first monomer comprises trimesoyl chloride (TMC) and the second monomer comprises a polyhedral oligomeric silsesquioxane (POSS): or wherein the first monomer and the second monomer are selected from the group consisting of hexamethylenediamine (HMDA) and adipoyl chloride (APC).

15-20. (canceled)

21. The nanoporous membrane of claim 1, wherein the target substance comprises water and the non-target substance comprises a salt, an organic molecule, a biological agent, or a combination thereof.

22. (canceled)

23. The nanoporous membrane of claim 1, wherein the non-target substance comprises a chemical or biological warfare agent.

24-26. (canceled)

27. The nanoporous membrane of claim 1, wherein the nanoporous membrane exhibits:
a diffusive flux across the nanoporous membrane of from 3% to 10%;
a water flux across the nanoporous membrane of 0.5×10⁻⁵ m³ m⁻² s⁻¹ or more at an osmotic pressure of 14 bar or more;
a moisture vapor transport rate (MVTR) of 10 g m⁻² d⁻¹ or more;
a rejection of 95% or more for the non-target substance;
a water permeance of 3×10⁻⁷ m³ m⁻² s⁻¹ bar⁻¹ or more;
or a combination thereof.

28-31. (canceled)

32. A method of making a nanoporous membrane for separating a target substance from a non-target substance in a fluid medium, the method comprising:
etching a two-dimensional material such that the two-dimensional material is permeated by a plurality of pores,
wherein the plurality of pores comprises a first population of pores having an average pore diameter and a second population of pores having an average pore diameter,
wherein the average pore diameter of the first population of pores is greater than or equal to the van der Waals diameter of water and less than the average size of the non-target substance in the fluid medium;
wherein the average pore diameter of the second population of pores is greater than or equal to the average size of the non-target substance in the fluid medium;
wherein the two-dimensional material has a top surface and a bottom surface with an average thickness therebetween;
wherein the plurality of pores traverse the average thickness of the two-dimensional material from the top surface to the bottom surface; and
contacting the top surface of the two-dimensional with a first monomer and the bottom surface of the two-dimensional material with a second monomer;
wherein the first monomer has an average size that is greater than the average pore diameter of the second population of pores;
wherein the second monomer has an average size that is greater than the average pore diameter of the first population of pores and less than or equal to the average pore diameter of the second population of pores;
such that interfacial polymerization occurs between the first monomer and the second monomer within the second population of pores;
thereby substantially blocking substantially all of the second population of pores with a polymer derived from the first monomer and the second monomer via interfacial polymerization;
such that the nanoporous membrane allows for transport of the target substance through the nanoporous membrane via the first population of pores.

33. (canceled)

34. The method of claim 32, wherein the two-dimensional material comprises graphene, hexagonal boron nitride (h-BN), a transition metal dichalcogenide, a covalent organic framework, a metal organic framework, or a combination thereof.

35-46. (canceled)

47. The method of claim 32, wherein etching the two-dimensional material comprises UV-ozone induced etching; plasma bombardment; ion beam bombardment; etching via energetic ions; etching via nanoparticles; or a combination thereof.

48-50. (canceled)

51. The method of claim 32, wherein the average thickness of the two-dimensional material is from 0.3 nm to 1 nm.

52. (canceled)

53. The method of claim 32, wherein the average pore diameter of the first population of pores is from 0.3 nm to 5 nm.

54. (canceled)

55. The method of claim 32, wherein the polymer comprises polyhedral oligomeric silsesquioxane-polyamide (POSS-PA); nylon 6,6; or a combination thereof.

56. (canceled)

57. The method of claim 32, wherein the first monomer comprises trimesoyl chloride (TMC) and the second monomer comprises a polyhedral oligomeric silsesquioxane (POSS): or wherein the first monomer and the second monomer are selected from the group consisting of hexamethylenediamine (HMDA) and adipoyl chloride (APC).

58-63. (canceled)

64. The method of claim 32, wherein the target substance comprises water and the non-target substance comprises a salt, an organic molecule, a biological agent, or a combination thereof.

65. (canceled)

66. The method of claim 32, wherein the non-target substance comprises a chemical or biological warfare agent.

67-75. (canceled)

76. A method of use of the nanoporous membrane of claim 1, the method comprising using the nanoporous membrane in a separation to separate the target substance from the non-target substance in the fluid medium.

77. The method of claim 76, wherein the separation comprises a pressure driven separation performed at a pressure of from 1 bar to 100 bar.

78-89. (canceled)
